(19) United States
(12) Patent Application Publication
(10) Pub. No.: US 2026/0253258 A1
(43) Pub. Date: Aug. 27, 2026

(54) ENCODING METHOD, DECODING METHOD, ENCODING DEVICE, AND DECODING DEVICE

(71) Applicant: Panasonic Intellectual Property Corporation of America, Torrance, CA (US)

(72) Inventors: Toshiyasu SUGIO, Osaka (JP); Noritaka IGUCHI, Osaka (JP); Takahiro NISHI, Nara (JP); Atsushi ITO, Osaka (JP); Chong Soon LIM, Singapore (SG); Zheng WU, Singapore (SG); Han Boon TEO, Singapore (SG); Keng Liang LOI, Singapore (SG); Chung Dean HAN, Johor Bahru (MY); Farman DUMANOV, Singapore (SG); Kian Soon CHENG, Johor Bahru (MY)

(21) Appl. No.: 19/644,318

(22) Filed: Apr. 10, 2026

Related U.S. Application Data
(63) Continuation of application No. PCT/JP2024/036331, filed on Oct. 10, 2024.
(60) Provisional application No. 63/544,273, filed on Oct. 16, 2023.

(51) Int. Cl. G06T 9/00; H04N 19/169; H04N 19/17; H04N 19/70

(52) U.S. Cl. CPC G06T 9/001; H04N 19/17; H04N 19/188; H04N 19/70

(57) ABSTRACT

An encoding method according to one aspect of the present disclosure includes: obtaining a first identifier indicating a displacement vector and a second identifier indicating a second three-dimensional mesh that is a three-dimensional mesh obtained by displacing a vertex of a first three-dimensional mesh according to the displacement vector; and encoding the first identifier and the second identifier into a bitstream.

### CROSS REFERENCE TO RELATED APPLICATIONS

This is a continuation application of PCT International Application No. PCT/JP2024/036331 filed on October 10, 2024, designating the United States of America, which is based on and claims priority of U.S. Provisional Patent Application No. 63/544273 filed on October 16, 2023. The entire disclosures of the above-identified applications, including the specifications, drawings and claims are incorporated herein by reference in their entirety.

### FIELD

The present disclosure relates to, for example, an encoding method.

### BACKGROUND

PTL 1 proposes a method and a device for encoding and decoding three-dimensional mesh data.

### Citation List

### Patent Literature

PTL 1: Japanese Unexamined Patent Application Publication No. 2006-187015

### SUMMARY

### Technical Problem

There are demands for further improvement in processing of encoding or decoding three-dimensional data. The present disclosure improves processing of encoding or decoding three-dimensional data.

### Solution to Problem

An encoding method according to one aspect of the present disclosure includes: obtaining a first identifier indicating a displacement vector and a second identifier indicating a second three-dimensional mesh that is a three-dimensional mesh obtained by displacing a vertex of a first three-dimensional mesh according to the displacement vector; and encoding the first identifier and the second identifier into a bitstream.

Noted that these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Advantageous Effects

The present disclosure can contribute toward improving processing of encoding three-dimensional data and the like.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a conceptual diagram illustrating a three-dimensional mesh according to an embodiment.

FIG. 2 is a conceptual diagram illustrating basic elements of the three-dimensional mesh according to the embodiment.

FIG. 3 is a conceptual diagram illustrating mapping according to the embodiment.

FIG. 4 is a block diagram illustrating a configuration example of an encoding/decoding system according to the embodiment.

FIG. 5 is a block diagram illustrating a configuration example of an encoding device according to the embodiment.

FIG. 6 is a block diagram illustrating another configuration example of the encoding device according to the embodiment.

FIG. 7 is a block diagram illustrating a configuration example of a decoding device according to the embodiment.

FIG. 8 is a block diagram illustrating another configuration example of the decoding device according to the embodiment.

FIG. 9 is a conceptual diagram illustrating a configuration example of a bitstream according to the embodiment.

FIG. 10 is a conceptual diagram illustrating another configuration example of the bitstream according to the embodiment.

FIG. 11 is a conceptual diagram illustrating yet another configuration example of the bitstream according to the embodiment.

FIG. 12 is a block diagram illustrating a specific example of the encoding/decoding system according to the embodiment.

FIG. 13 is a conceptual diagram illustrating a configuration example of point cloud data according to the embodiment.

FIG. 14 is a conceptual diagram illustrating a data file example of the point cloud data according to the embodiment.

FIG. 15 is a conceptual diagram illustrating a configuration example of mesh data according to the embodiment.

FIG. 16 is a conceptual diagram illustrating a data file example of the mesh data according to the embodiment.

FIG. 17 is a conceptual diagram illustrating a type of three-dimensional data according to the embodiment.

FIG. 18 is a block diagram illustrating a configuration example of a three-dimensional data encoder according to the embodiment.

FIG. 19 is a block diagram illustrating a configuration example of a three-dimensional data decoder according to the embodiment.

FIG. 20 is a block diagram illustrating another configuration example of the three-dimensional data encoder according to the embodiment.

FIG. 21 is a block diagram illustrating another configuration example of the three-dimensional data decoder according to the embodiment.

FIG. 22 is a conceptual diagram illustrating a specific example of encoding processing according to the embodiment.

FIG. 23 is a conceptual diagram illustrating a specific example of decoding processing according to the embodiment.

FIG. 24 is a block diagram illustrating an implementation example of the encoding device according to the embodiment.

FIG. 25 is a block diagram illustrating an implementation example of the decoding device according to the embodiment.

FIG. 26 is a block diagram illustrating another configuration example of the encoding/decoding system according to the embodiment.

FIG. 27 is a block diagram illustrating another configuration example of the encoding device according to the embodiment.

FIG. 28 is a block diagram illustrating another configuration example of the decoding device according to the embodiment.

FIG. 29 is a block diagram illustrating a detailed configuration example of the encoding device according to the embodiment.

FIG. 30 is a block diagram illustrating a detailed configuration variation of the encoding device according to the embodiment.

FIG. 31 is a flowchart illustrating a process by the encoding device according to the embodiment.

FIG. 32 is an explanatory diagram schematically illustrating the encoding of a mesh frame according to the embodiment.

FIG. 33 is a block diagram illustrating a detailed configuration example of the decoding device according to the embodiment.

FIG. 34 is a block diagram illustrating a detailed configuration variation of the decoding device according to the embodiment.

FIG. 35 is a flowchart illustrating a process by the decoding device according to the embodiment.

FIG. 36 is an explanatory diagram schematically illustrating the decoding of a mesh frame according to the embodiment.

FIG. 37 is an explanatory diagram illustrating an example of a subdivision according to the embodiment.

FIG. 38 is an explanatory diagram illustrating an example of the displacement of vertices in which the vertices are subdivided and then displaced, according to the embodiment.

FIG. 39 is an explanatory diagram illustrating an example of the vertices of an original mesh according to the embodiment.

FIG. 40 is an explanatory diagram illustrating an example of a mesh according to the embodiment.

FIG. 41 is an explanatory diagram illustrating an example of the division of a mesh into submeshes according to the embodiment.

FIG. 42 is a first explanatory diagram illustrating an example of the packing of displacement information into an image frame according to the embodiment.

FIG. 43 is a second explanatory diagram illustrating an example of the packing of displacement information into an image frame according to the embodiment.

FIG. 44 is a third explanatory diagram illustrating an example of the packing of displacement information into an image frame according to the embodiment.

FIG. 45 is a block diagram illustrating a detailed configuration example of the decoding device according to the embodiment.

FIG. 46 is a diagram for describing coordinates of vertices in a three-dimensional mesh according to the embodiment.

FIG. 47 is a diagram for describing prediction information according to the embodiment.

FIG. 48 is a flowchart of a process of re-initializing a CABAC encoding/decoding engine in response to a CABAC initialization flag in encoding or decoding according to the embodiment.

FIG. 49 is a block diagram illustrating a configuration of first encoder included in a three-dimensional data encoding device according to the embodiment.

FIG. 50 is a block diagram illustrating a configuration of a divider according to the embodiment.

FIG. 51 is a block diagram illustrating a configuration of a geometry information encoder and an attribute information encoder according to the embodiment.

FIG. 52 is a block diagram illustrating a configuration of a first decoder according to the embodiment.

FIG. 53 is a block diagram illustrating a configuration of a geometry information decoder and an attribute information decoder according to the embodiment.

FIG. 54 is a flowchart illustrating an example of a process associated with the initialization of CABAC in the encoding of geometry information or the encoding of attribute information according to the embodiment.

FIG. 55 is a diagram illustrating an example of timings of CABAC initialization for point cloud data in the form of a bitstream according to the embodiment.

FIG. 56 is a diagram illustrating a configuration of encoded data and a method of storing the encoded data into a NAL unit according to the embodiment.

FIG. 57 is a flowchart illustrating an example of a process associated with the initialization of CABAC in the decoding of geometry information or the decoding of attribute information according to the embodiment.

FIG. 58 is a flowchart of a process of encoding point cloud data according to the embodiment.

FIG. 59 is a flowchart illustrating an example of a process of updating additional information according to the embodiment.

FIG. 60 is a flowchart illustrating an example of a process of initializing CABAC according to the embodiment.

FIG. 61 is a flowchart illustrating a process of decoding point cloud data according to the embodiment.

FIG. 62 is a flowchart illustrating an example of a process of initializing a CABAC decoder according to the embodiment.

FIG. 63 is a diagram illustrating an example of tiles and slices according to the embodiment.

FIG. 64 is a flowchart illustrating an example of a method of determining whether to initialize CABAC and determining a context initial value according to the embodiment.

FIG. 65 is a diagram illustrating an example of a case where a map, which is a top view of point cloud data obtained by LiDAR, is divided into tiles according to the embodiment.

FIG. 66 is a flowchart illustrating another example of the method of determining whether to initialize CABAC and determining a context initial value according to the embodiment.

FIG. 67 is a diagram illustrating an example of a data structure of a geometry information item included in each data unit after division according to the embodiment, and a syntax of a header of the geometry information item.

FIG. 68 is a flowchart illustrating an example of a three-dimensional data encoding method according to the embodiment.

FIG. 69 is a flowchart illustrating an example of a three-dimensional data decoding method according to the embodiment.

FIG. 70 is a diagram for describing initialization of a context in a case where an encoding scheme according to the embodiment is switched.

FIG. 71 is a flowchart of processing by a three-dimensional data encoding device according to the embodiment.

FIG. 72 is a flowchart of processing by a three-dimensional data decoding device according to the embodiment.

FIG. 73 is a diagram illustrating an exemplary syntax of an SPS according to the embodiment.

FIG. 74 is a diagram illustrating an exemplary syntax of the header (DevidedGeometryHeader) of divided geometry information according to the embodiment.

FIG. 75 is a diagram illustrating an exemplary syntax of the header (DevidedAttributeHeader) of divided attribute information according to the embodiment.

FIG. 76 is a diagram illustrating another exemplary syntax of the header (DevidedAttributeHeader) of the divided attribute information according to the embodiment.

FIG. 77 is a diagram illustrating another exemplary syntax of the header (DevidedGeometryHeader) of the divided geometry information according to the embodiment.

FIG. 78 is a flowchart illustrating an example of first determination for determining whether to initialize entropy encoding in the three-dimensional data encoding device according to the embodiment.

FIG. 79 is a flowchart illustrating an exemplary process of determining whether a flag of entropy encoding satisfies a conformance condition (conforms to specifications) in the three-dimensional data decoding device according to the embodiment.

FIG. 80 is a flowchart of a process in the three-dimensional data encoding device according to the embodiment.

FIG. 81 is a flowchart of a process in the three-dimensional data decoding device according to the embodiment.

FIG. 82 is a diagram illustrating an example syntax of an SPS according to the embodiment.

FIG. 83 is a diagram illustrating an example syntax of an APS according to the embodiment.

FIG. 84 is a diagram illustrating an example syntax of a header of divided geometry information (DevidedGeometryHeader) according to the embodiment.

FIG. 85 is a diagram illustrating an example syntax of a header of divided attribute information (DevidedAttributeHeader) according to the embodiment.

FIG. 86 is a flowchart illustrating an example of a process of determining whether to continue context used for entropy encoding in a three-dimensional data encoding device according to the embodiment.

FIG. 87 is a diagram for describing how to update a table according to the embodiment.

FIG. 88 is a flowchart of encoding an occupancy map by the three-dimensional data encoding device according to the embodiment.

FIG. 89 is a flowchart of decoding an occupancy map by a three-dimensional data decoding device according to the embodiment.

FIG. 90 is a flowchart of a process of switching between entropy encoding schemes in the three-dimensional data encoding device according to the embodiment.

FIG. 91 is a flowchart of the continuing method for bytewise entropy encoding in the three-dimensional data encoding device according to the embodiment.

FIG. 92 is a flowchart of a process of switching between entropy decoding schemes in the three-dimensional data decoding device according to the embodiment.

FIG. 93 is a flowchart of the continuing method for bytewise entropy decoding in the three-dimensional data decoding device according to the embodiment.

FIG. 94 is a flowchart of processing by a three-dimensional data encoding device according to the embodiment.

FIG. 95 is a flowchart of processing by a three-dimensional data decoding device according to the embodiment.

FIG. 96 is a diagram illustrating an example of a three-dimensional point cloud in a case where encoding is performed with the three-dimensional point cloud divided into slices for groups according to the embodiment.

FIG. 97 is a diagram illustrating various configuration examples of a bitstream according to the embodiment.

FIG. 98 illustrates an example in which whether to initialize slice-based CABAC is indicated by a slice flag, and whether to initialize tree-based CABAC in a slice is indicated by a tree flag according to the embodiment.

FIG. 99 is a diagram for describing a method of decoding prediction trees by parallel processing according to the embodiment.

FIG. 100 is a diagram illustrating an example of a three-dimensional data encoding method according to the embodiment.

FIG. 101 is a diagram illustrating an example of a three-dimensional data decoding method according to the embodiment.

FIG. 102 is a diagram illustrating an example of parallel decoding in a three-dimensional data decoding method according to the embodiment.

FIG. 103 is a diagram illustrating an example of a syntax of a data unit of a geometry information item according to the embodiment in a case where an initialization flag is stored in a data item of the geometry information item.

FIG. 104 is a diagram illustrating an example of a syntax of a header of a geometry information item according to the embodiment in a case where an initialization flag and an offset information item are stored in the header.

FIG. 105 is a diagram illustrating an example of a syntax of a header of a geometry information item according to the embodiment in a case where an initialization flag and an offset information item are stored in the header on a random access basis.

FIG. 106 is a diagram for illustrating a relationship between an original mesh and a submesh according to the embodiment.

FIG. 107 is a block diagram illustrating another configuration example of the encoding device according to the embodiment.

FIG. 108 is a block diagram illustrating another configuration example of the decoding device according to the embodiment.

FIG. 109 is a flowchart illustrating an initialization process of context information according to the embodiment.

FIG. 110 is a diagram illustrating another exemplary syntax of an SPS according to the embodiment.

FIG. 111 is a diagram illustrating an exemplary syntax of a header (DividedBasemeshHeader) of a divided base mesh according to the embodiment.

FIG. 112 is a diagram illustrating an exemplary syntax of a header (DividedDisplacementVectorHeader) of a divided displacement vector according to the embodiment.

FIG. 113 is a diagram illustrating another exemplary syntax of a header (DividedDisplacementVectorHeader) of a divided displacement vector according to the embodiment.

FIG. 114 is a diagram for illustrating low latency encoding according to the embodiment.

FIG. 115 is a diagram for illustrating continuation of context information according to the embodiment.

FIG. 116 is a flowchart illustrating an example of a basic encoding process according to the embodiment.

FIG. 117 is a flowchart illustrating an example of a basic decoding process according to the embodiment.

### DESCRIPTION OF EMBODIMENTS

### Introduction

Three-dimensional (3D) meshes are used in, for example, a computer graphics video. For example, the computer graphics video may include a plurality of frames different in time from one another, and each of the frames may be represented in the form of three-dimensional meshes.

The three-dimensional meshes each include vertex information indicating the positions of a plurality of vertices in a three-dimensional space, connection information indicating the connections between the plurality of vertices, and attribute information indicating attributes of the vertices or faces. The faces are each built in accordance with the connectivity relation among the plurality of vertices. Such three-dimensional meshes can represent various computer graphics videos.

For the transmission and storage of three-dimensional meshes, an efficient encoding and decoding of three-dimensional meshes is expected. For the efficient encoding and decoding of three-dimensional meshes, arithmetic encoding and arithmetic decoding may be used.

There is a demand for further improvement in an encoding or decoding process related to three-dimensional data. The present disclosure improves the encoding or decoding process related to three-dimensional data.

Hereinafter, aspects of the invention derived from the content of the disclosure of the present description will be described by way of example, and the effects and the like derived from the aspect of the invention will be described.

An encoding method according to Example 1 includes: obtaining a first identifier indicating a displacement vector and a second identifier indicating a second three-dimensional mesh that is a three-dimensional mesh obtained by displacing a vertex of a first three-dimensional mesh according to the displacement vector; and encoding the first identifier and the second identifier into a bitstream.

With this, the decoding device that has obtained the bitstream can identify the displacement vector and the second three-dimensional mesh by only checking the identifiers. Accordingly, it is possible to reduce the processing amount.

An encoding method according to Example 2 may be the encoding method according to Example 1, in which the bitstream includes the first identifier and the second identifier in a first header.

With this, the decoding device that has obtained the bitstream can identify the displacement vector and the second three-dimensional mesh related to information included in a payload corresponding to the first header, by only checking the identifiers included in the first header. Accordingly, it is possible to reduce the processing amount.

An encoding method according to Example 3 may be the encoding method according to Example 2, in which the bitstream additionally includes the second identifier in a second header different from the first header.

With this, the decoding device that has obtained the bitstream can identify the second three-dimensional mesh related to each of information included in a payload corresponding to the first header and information included in a payload corresponding to the second header, by only checking the identifier included in the first header and the second header. Accordingly, it is possible to reduce the processing amount.

An encoding method according to Example 4 may be the encoding method according to Example 3, in which the first three-dimensional mesh is a three-dimensional mesh obtained by subdividing a base mesh to add a vertex to the base mesh, and the second header is a header of the base mesh.

With this, the decoding device that has obtained the bitstream can identify the second three-dimensional mesh related to the base mesh by only checking the identifier included in the header of the base mesh. Accordingly, it is possible to reduce the processing amount.

An encoding method according to Example 5 may be the encoding method according to Example 4, in which the bitstream further includes, in the second header, a third identifier indicating the base mesh.

With this, the decoding device that has obtained the bitstream can identify the base mesh by only checking the identifier included in the header of the base mesh. Accordingly, it is possible to reduce the processing amount.

A decoding method according to Example 6 includes: obtaining a bitstream into which a first identifier indicating a displacement vector and a second identifier indicating a second three-dimensional mesh that is a three-dimensional mesh obtained by displacing a vertex of a first three-dimensional mesh according to the displacement vector are encoded; and decoding the first identifier and the second identifier from the bitstream.

With this, the decoding device that performs the decoding method can identify the displacement vector and the second three-dimensional mesh by only checking the identifiers. Accordingly, it is possible to reduce the processing amount.

A decoding method according to Example 7 may be the decoding method according to Example 6, in which the bitstream includes the first identifier and the second identifier in a first header.

With this, the decoding device that has obtained the bitstream can identify the displacement vector and the second three-dimensional mesh related to information included in a payload corresponding to the first header, by only checking the identifiers included in the first header. Accordingly, it is possible to reduce the processing amount.

A decoding method according to Example 8 may be the decoding method according to Example 7, in which the bitstream additionally includes the second identifier in a second header different from the first header.

With this, the decoding device that has obtained the bitstream can identify the second three-dimensional mesh related to each of information included in a payload corresponding to the first header and information included in a payload corresponding to the second header, by only checking the identifier included in the first header and the second header. Accordingly, it is possible to reduce the processing amount.

A decoding method according to Example 9 may be the decoding method according to Example 8, in which the first three-dimensional mesh is a three-dimensional mesh obtained by subdividing a base mesh to add a vertex to the base mesh, and the second header is a header of the base mesh.

With this, the decoding device that has obtained the bitstream can identify the second three-dimensional mesh related to the base mesh by only checking the identifier included in the header of the base mesh. Accordingly, it is possible to reduce the processing amount.

A decoding method according to Example 10 may be the decoding method according to Example 9, in which the bitstream further includes, in the second header, a third identifier indicating the base mesh.

With this, the decoding device that has obtained the bitstream can identify the base mesh by only checking the identifier included in the header of the base mesh. Accordingly, it is possible to reduce the processing amount.

An encoding device according to Example 11 includes a circuit and memory connected to the circuit, in which, in operation, the circuit: obtains a first identifier indicating a displacement vector and a second identifier indicating a second three-dimensional mesh that is a three-dimensional mesh obtained by displacing a vertex of a first three-dimensional mesh according to the displacement vector; and encodes the first identifier and the second identifier into a bitstream.

With this, the same advantageous effects as those of the encoding method according to Example 1 can be produced.

A decoding device according to Example 12 includes a circuit and memory connected to the circuit, in which, in operation, the circuit: obtains a bitstream into which a first identifier indicating a displacement vector and a second identifier indicating a second three-dimensional mesh that is a three-dimensional mesh obtained by displacing a vertex of a first three-dimensional mesh according to the displacement vector are encoded; and decodes the first identifier and the second identifier from the bitstream.

With this, the same advantageous effects as those of the decoding method according to Example 6 can be produced.

Moreover, these general or specific aspects may be implemented using a system, a device, a method, an integrated circuit, a computer program, or a non-transitory computer-readable recording medium such as a CD-ROM, or any combination of systems, devices, methods, integrated circuits, computer programs, and recording media.

### Expressions and terms

The following expressions and terms will be used herein.

### Three-dimensional mesh

A three-dimensional mesh is a set of a plurality of faces and indicates, for example, a three-dimensional object. In addition, a three-dimensional mesh is mainly constituted of vertex information, connection information, and attribute information. A three-dimensional mesh may be expressed as a polygon mesh or a mesh. In addition, a three-dimensional mesh may have a temporal change. A three-dimensional mesh may include metadata related to vertex information, connection information, and attribute information or other additional information.

### Vertex information

Vertex information is information indicating a vertex. For example, vertex information indicates a position of a vertex in a three-dimensional space. In addition, a vertex corresponds to a vertex of a face that constitutes a three-dimensional mesh. Vertex information may be expressed as "geometry". In addition, vertex information may also be expressed as position information.

### Connection information

Connection information is information indicating a connection between vertexes. For example, connection information indicates a connection for constructing a face or an edge of a three-dimensional mesh. Connection information may be expressed as "connectivity". In addition, connection information may also be expressed as face information.

### Attribute information

Attribute information is information indicating an attribute of a vertex or a face. For example, attribute information indicates an attribute such as a color, an image, a normal vector, and the like associated with a vertex or a face. Attribute information may be expressed as "texture".

### Face

A face is an element that constitutes a three-dimensional mesh. Specifically, a face is a polygon on a plane in a three-dimensional space. For example, a face can be determined as a triangle in the three-dimensional space.

### Plane

A plane is a two-dimensional plane in a three-dimensional space. For example, a polygon is formed on a plane and a plurality of polygons are formed on a plurality of planes.

### Bitstream

A bitstream corresponds to encoded information. A bitstream can also be expressed as a stream, an encoded bitstream, a compressed bitstream, or an encoded signal.

### Encoding and decoding

The expression "encode" may be replaced with expressions such as store, include, write, describe, signalize, send out, notify, save, or compress and such expressions may be interchangeably used. For example, encoding information may mean including information in a bitstream. In addition, encoding information in a bitstream may mean encoding the information and generating a bitstream that includes the encoded information.

In addition, the expression "decode" may be replaced with expressions such as read, interpret, scan, load, derive, acquire, receive, extract, restore, reconstruct, decompress, or expand and such expressions may be interchangeably used. For example, decoding information may mean acquiring information from a bitstream. In addition, decoding information from a bitstream may mean decoding the bitstream and acquiring information included in the bitstream.

### Ordinal numbers

In the description, an ordinal number such as first, second, or the like may be affixed to a constituent element or the like. Such ordinal numbers may be replaced as necessary. In addition, an ordinal number may be newly affixed to or removed from a constituent element or the like. Furthermore, the ordinal numbers may be affixed to elements in order to identify the elements and may not correspond to any meaningful order.

### Three-dimensional mesh

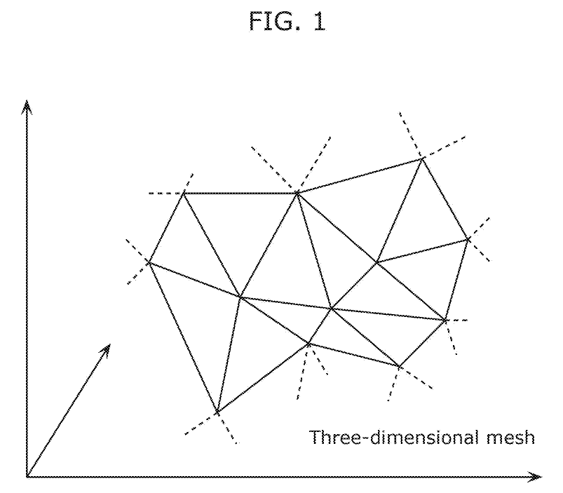

FIG. 1 is a conceptual diagram illustrating a three-dimensional mesh according to the present embodiment. The three-dimensional mesh is constituted of a plurality of faces. For example, each face is a triangle. Vertexes of the triangles are determined in a three-dimensional space. In addition, a three-dimensional mesh indicates a three-dimensional object. Each face may have a color or an image.

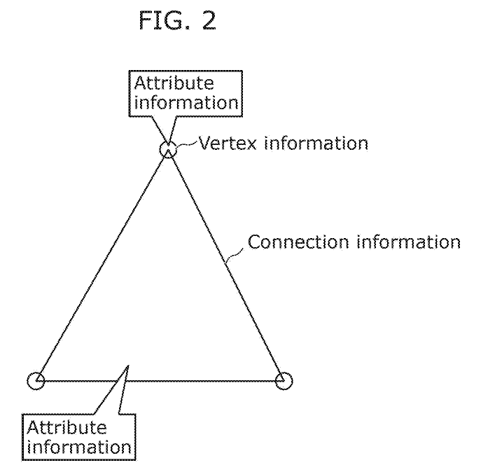

FIG. 2 is a conceptual diagram illustrating basic elements of a three-dimensional mesh according to the present embodiment. The three-dimensional mesh is constituted of vertex information, connection information, and attribute information. Vertex information indicates a position of a vertex of a face in a three-dimensional space. Connection information indicates a connection between vertexes. A face can be identified based on vertex information and connection information. In other words, an uncolored three-dimensional object is formed in a three-dimensional space based on vertex information and connection information.

Attribute information may be associated with a vertex or associated with a face. Attribute information associated with a vertex may be expressed as "attribute per point". Attribute information associated with a vertex may indicate an attribute of the vertex itself or indicate an attribute of a face connected to the vertex.

For example, a color may be associated with a vertex as attribute information. The color associated with the vertex may be the color of the vertex or the color of a face connected to the vertex. The color of the face may be an average of a plurality of colors associated with a plurality of vertexes of the face. In addition, a normal vector may be associated with a vertex or a face as attribute information. Such a normal vector can express a front and a rear of a face.

In addition, a two-dimensional image may be associated with a face as attribute information. The two-dimensional image associated with a face is also expressed as a texture image or an "attribute map". In addition, information indicating mapping between a face and a two-dimensional image may be associated with the face as attribute information. Such information indicating mapping may be expressed as mapping information, vertex information of a texture image, texture coordinates, or an "attribute UV coordinate".

Furthermore, information on a color, an image, a moving image, and the like to be used as attribute information may be expressed as "parametric space".

A texture is reflected in a three-dimensional object based on such attribute information. In other words, a colored three-dimensional object is formed in a three-dimensional space based on vertex information, connection information, and attribute information.

Note that while attribute information is associated with a vertex or a face in the description given above, alternatively, attribute information may be associated with an edge.

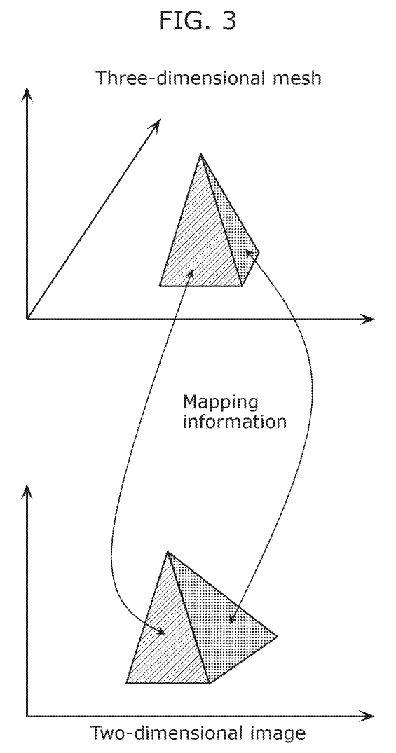

FIG. 3 is a conceptual diagram illustrating mapping according to the present embodiment. For example, a region of a two-dimensional image on a two-dimensional plane can be mapped to a face of a three-dimensional mesh in a three-dimensional space. Specifically, coordinate information of a region in the two-dimensional image is associated with a face of the three-dimensional mesh. Accordingly, an image of the mapped region in the two-dimensional image is reflected in the face of the three-dimensional mesh.

The use of mapping enables a two-dimensional image to be used as attribute information to be separated from the three-dimensional mesh. For example, in encoding of the three-dimensional mesh, the two-dimensional image may be encoded based on an image encoding system or a video encoding system.

### System configuration

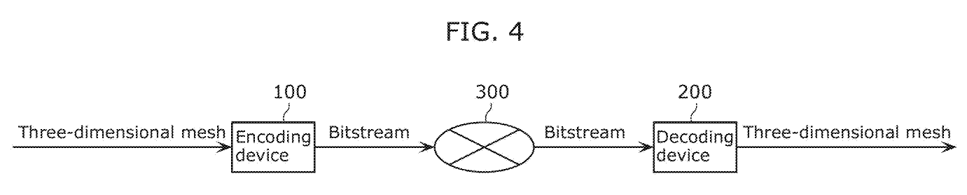

FIG. 4 is a block diagram illustrating a configuration example of an encoding/decoding system according to the present embodiment. In FIG. 4, the encoding/decoding system includes encoding device 100 and decoding device 200.

For example, encoding device 100 acquires a three-dimensional mesh and encodes the three-dimensional mesh into a bitstream. In addition, encoding device 100 outputs the bitstream to network 300. For example, the bitstream includes an encoded three-dimensional mesh and control information for decoding the encoded three-dimensional mesh. Encoding of the three-dimensional mesh causes information of the three-dimensional mesh to be compressed.

Network 300 transmits the bitstream from encoding device 100 to decoding device 200. Network 300 may be the Internet, a wide area network (WAN), a local area network (LAN), or a combination thereof. Network 300 is not necessarily limited to two-way communication and may be a unidirectional communication network for terrestrial digital broadcasting, satellite broadcasting, or the like.

In addition, network 300 may be replaced with a recording medium such as a DVD (digital versatile disc), a BD (Blu-Ray Disc (registered trademark)), or the like.

Decoding device 200 acquires a bitstream and decodes a three-dimensional mesh from the bitstream. Decoding of the three-dimensional mesh causes information of the three-dimensional mesh to be expanded. For example, decoding device 200 decodes a three-dimensional mesh according to a decoding method corresponding to an encoding method used by encoding device 100 to encode the three-dimensional mesh. In other words, encoding device 100 and decoding device 200 perform encoding and decoding according to an encoding method and a decoding method which correspond to each other.

Note that the three-dimensional mesh before encoding can also be expressed as an original three-dimensional mesh. In addition, the three-dimensional mesh after decoding is also expressed as a reconstructed three-dimensional mesh.

### Encoding device

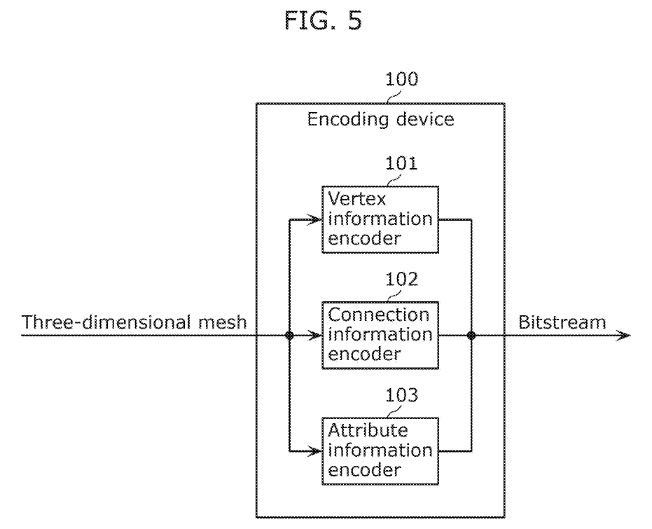

FIG. 5 is a block diagram illustrating a configuration example of encoding device 100 according to the present embodiment. For example, encoding device 100 includes vertex information encoder 101, connection information encoder 102, and attribute information encoder 103.

Vertex information encoder 101 is an electric circuit which encodes vertex information. For example, vertex information encoder 101 encodes vertex information into a bitstream according to a format defined with respect to the vertex information.

Connection information encoder 102 is an electric circuit which encodes connection information. For example, connection information encoder 102 encodes connection information into a bitstream according to a format defined with respect to the connection information.

Attribute information encoder 103 is an electric circuit which encodes attribute information. For example, attribute information encoder 103 encodes attribute information into a bitstream according to a format defined with respect to the attribute information.

Variable-length coding or fixed length coding may be used for encoding vertex information, connection information, and attribute information. The variable-length coding may accommodate Huffman coding, context-adaptive binary arithmetic coding (CABAC), or the like.

Vertex information encoder 101, connection information encoder 102, and attribute information encoder 103 may be integrated. Alternatively, each of vertex information encoder 101, connection information encoder 102, and attribute information encoder 103 may be more finely segmentalized into a plurality of constituent elements.

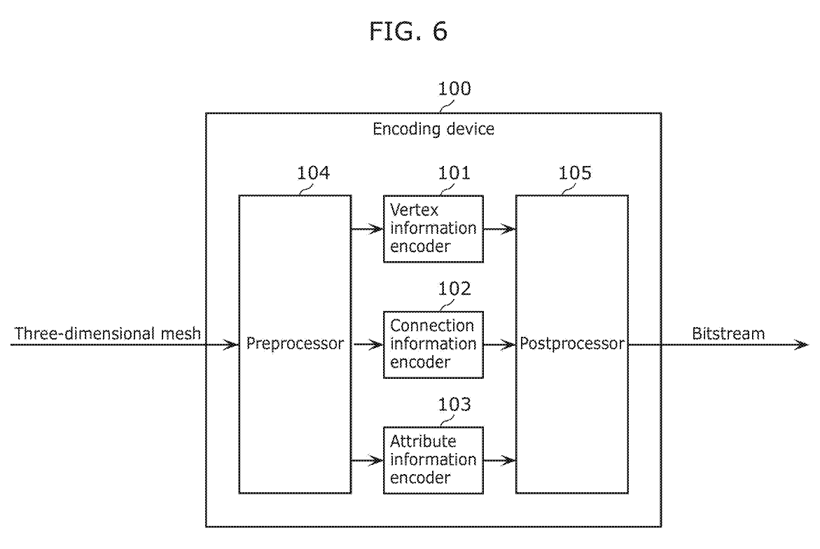

FIG. 6 is a block diagram illustrating another configuration example of encoding device 100 according to the present embodiment. For example, in addition to the components illustrated in FIG. 5, encoding device 100 includes preprocessor 104 and postprocessor 105.

Preprocessor 104 is an electric circuit which performs processing before encoding of vertex information, connection information, and attribute information. For example, preprocessor 104 may perform transformation processing, demultiplexing, multiplexing, or the like with respect to a three-dimensional mesh before encoding. More specifically, for example, preprocessor 104 may demultiplex vertex information, connection information, and attribute information from the three-dimensional mesh before encoding.

Postprocessor 105 is an electric circuit which performs processing after the encoding of vertex information, connection information, and attribute information. For example, postprocessor 105 may perform transformation processing, demultiplexing, multiplexing, or the like with respect to vertex information, connection information, and attribute information after encoding. More specifically, for example, postprocessor 105 may multiplex vertex information, connection information, and attribute information after encoding into a bitstream. In addition, for example, postprocessor 105 may further perform variable-length coding with respect to vertex information, connection information, and attribute information after the encoding.

### Decoding device

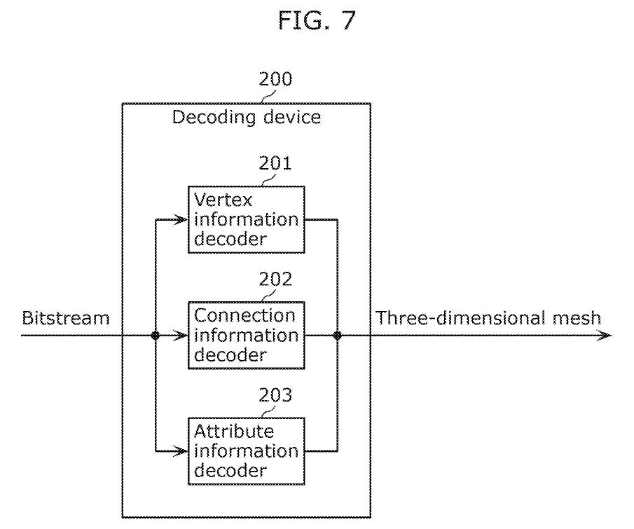

FIG. 7 is a block diagram illustrating a configuration example of decoding device 200 according to the present embodiment. For example, decoding device 200 includes vertex information decoder 201, connection information decoder 202, and attribute information decoder 203.

Vertex information decoder 201 is an electric circuit which decodes vertex information. For example, vertex information decoder 201 decodes vertex information from a bitstream according to a format defined with respect to the vertex information.

Connection information decoder 202 is an electric circuit which decodes connection information. For example, connection information decoder 202 decodes connection information from a bitstream according to a format defined with respect to the connection information.

Attribute information decoder 203 is an electric circuit which decodes attribute information. For example, attribute information decoder 203 decodes attribute information from a bitstream according to a format defined with respect to the attribute information.

Variable-length decoding or fixed length decoding may be used for decoding vertex information, connection information, and attribute information. The variable-length decoding may accommodate Huffman coding, context-adaptive binary arithmetic coding (CABAC), or the like.

Vertex information decoder 201, connection information decoder 202, and attribute information decoder 203 may be integrated. Alternatively, each of vertex information decoder 201, connection information decoder 202, and attribute information decoder 203 may be more finely segmentalized into a plurality of constituent elements.

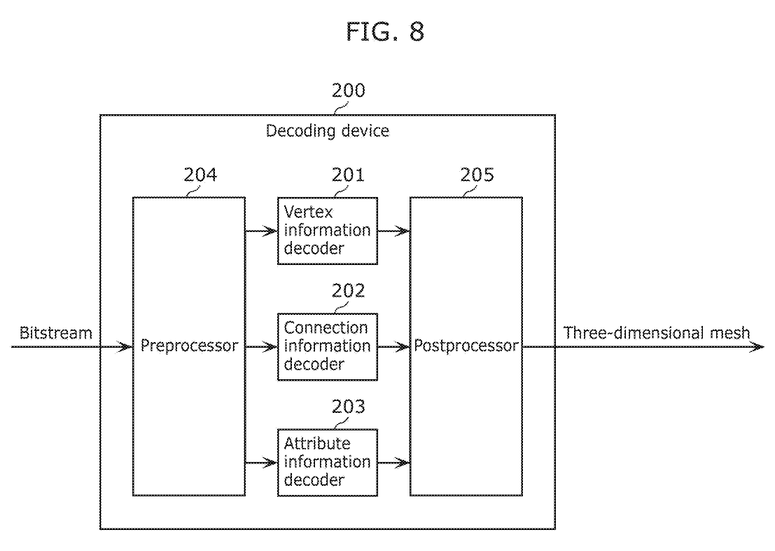

FIG. 8 is a block diagram illustrating another configuration example of decoding device 200 according to the present embodiment. For example, in addition to the components illustrated in FIG. 7, decoding device 200 includes preprocessor 204 and postprocessor 205.

Preprocessor 204 is an electric circuit which performs processing before decoding of vertex information, connection information, and attribute information. For example, preprocessor 204 may perform transformation processing, demultiplexing, multiplexing, or the like with respect to a bitstream before decoding of vertex information, connection information, and attribute information.

More specifically, for example, preprocessor 204 may demultiplex, from a bitstream, a sub-bitstream corresponding to vertex information, a sub-bitstream corresponding to connection information, and a sub-bitstream corresponding to attribute information. In addition, for example, preprocessor 204 may perform variable-length decoding with respect to the bitstream in advance before decoding of vertex information, connection information, and attribute information.

Postprocessor 205 is an electric circuit which performs processing after the decoding of vertex information, connection information, and attribute information. For example, postprocessor 205 may perform transformation processing, demultiplexing, multiplexing, or the like with respect to vertex information, connection information, and attribute information after decoding. More specifically, for example, postprocessor 205 may multiplex vertex information, connection information, and attribute information after decoding into a three-dimensional mesh.

### Bitstream

Vertex information, connection information, and attribute information are encoded and stored in a bitstream. A relationship between these pieces of information and the bitstream will be described below.

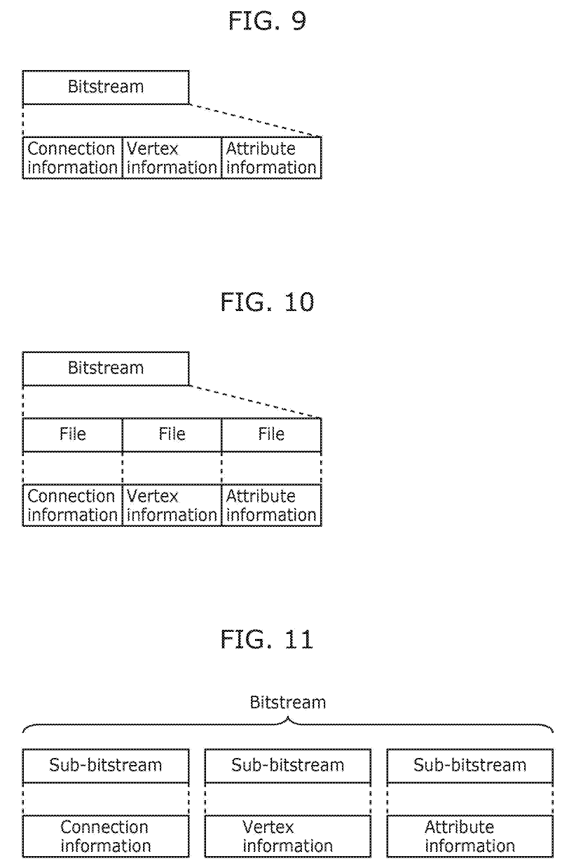

FIG. 9 is a conceptual diagram illustrating a configuration example of a bitstream according to the present embodiment. In this example, connection information, vertex information, and attribute information are integrated in the bitstream. For example, connection information, vertex information, and attribute information may be included in one file.

In addition, a plurality of portions of the pieces of information may be sequentially stored such as a first portion of connection information, a first portion of vertex information, a first portion of attribute information, a second portion of connection information, a second portion of vertex information, a second portion of attribute information, ... The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 10 is a conceptual diagram illustrating another configuration example of a bitstream according to the present embodiment. In the example, a plurality of files are included in a bitstream and connection information, vertex information, and attribute information are respectively stored in different files. While a file including connection information, a file including vertex information, and a file including attribute information are illustrated here, storage formats are not limited to this example. For example, two types of information among connection information, vertex information, and attribute information may be included in one file and the one remaining type of information may be included in another file.

Alternatively, the pieces of information can be stored by being divided into a larger number of files. For example, a plurality of portions of connection information may be stored in a plurality of files, a plurality of portions of vertex information may be stored in a plurality of files, and a plurality of portions of attribute information may be stored in a plurality of files. The plurality of portions may correspond to a plurality of temporally different portions, correspond to a plurality of spatially different portions, or correspond to a plurality of different faces.

Furthermore, an order of storage of connection information, vertex information, and attribute information is not limited to the example described above and an order of storage that differs from the above may be used.

FIG. 11 is a conceptual diagram illustrating another configuration example of a bitstream according to the present embodiment. In the example, a bitstream is constituted of a plurality of separable sub-bitstreams and connection information, vertex information, and attribute information are respectively stored in different sub-bitstreams.

While a sub-bitstream including connection information, a sub-bitstream including vertex information, and a sub-bitstream including attribute information are illustrated here, storage formats are not limited to this example.

For example, two types of information among connection information, vertex information, and attribute information may be included in one sub-bitstream and the one remaining type of information may be included in another sub-bitstream. Specifically, attribute information such as a two-dimensional image may be stored in a sub-bitstream conforming to an image coding system separately from a sub-bitstream of connection information and vertex information.

In addition, each sub-bitstream may include a plurality of files. Furthermore, a plurality of portions of connection information may be stored in a plurality of files, a plurality of portions of vertex information may be stored in a plurality of files, and a plurality of portions of attribute information may be stored in a plurality of files.

Furthermore, an order of storage of connection information, vertex information, and attribute information is not limited to the example illustrated in FIG. 9, FIG. 10, and FIG. 11, and an order of storage that differs from this example may be used. For example, vertex information, connection information, and attribute information may be stored in a bitstream in this order. Alternatively, in an order other than this order, e.g., in any of orders: connection information, attribute information, and vertex information; vertex information, attribute information, and connection information; attribute information, connection information, and vertex information; and attribute information, vertex information, and connection information, these pieces of information may be stored in a bitstream.

Furthermore, each of connection information, vertex information, and attribute information may be divided into a plurality of data items, and the plurality of data items may be stored in a bitstream in a periodic order or in a random order.

### Specific example

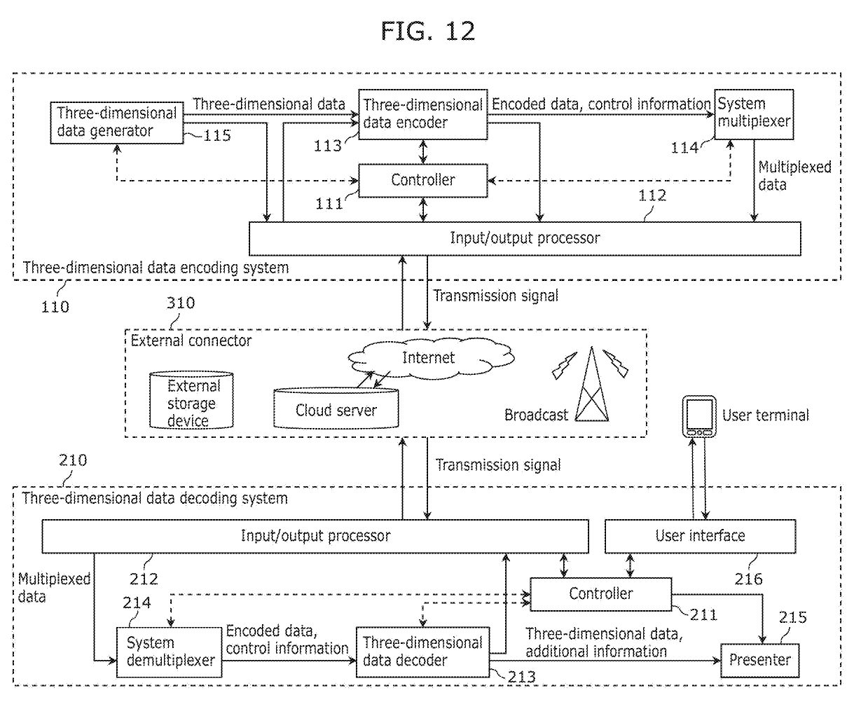

FIG. 12 is a block diagram illustrating a specific example of the encoding/decoding system according to the present embodiment. In FIG. 12, the encoding/decoding system includes three-dimensional data encoding system 110, three-dimensional data decoding system 210, and external connector 310.

Three-dimensional data encoding system 110 includes controller 111, input/output processor 112, three-dimensional data encoder 113, three-dimensional data generator 115, and system multiplexer 114. Three-dimensional data decoding system 210 includes controller 211, input/output processor 212, three-dimensional data decoder 213, system demultiplexer 214, presenter 215, and user interface 216.

In three-dimensional data encoding system 110, sensor data is input from a sensor terminal to three-dimensional data generator 115. Three-dimensional data generator 115 generates three-dimensional data that is point cloud data, mesh data, or the like from the sensor data and inputs the three-dimensional data to three-dimensional data encoder 113.

For example, three-dimensional data generator 115 generates vertex information and generates connection information and attribute information which correspond to the vertex information. Three-dimensional data generator 115 may process vertex information when generating connection information and attribute information. For example, three-dimensional data generator 115 may reduce a data amount by deleting overlapping vertexes or transform vertex information (position shift, rotation, normalization, or the like). In addition, three-dimensional data generator 115 may render attribute information.

While three-dimensional data generator 115 is a constituent element of three-dimensional data encoding system 110 in FIG. 12, three-dimensional data generator 115 may be disposed on the outside independent of three-dimensional data encoding system 110.

For example, a sensor terminal that provides sensor data for generating three-dimensional data may be a mobile object such as an automobile, a flying object such as an airplane, a mobile terminal, a camera, or the like. Alternatively, a range sensor such as LIDAR, a millimeter-wave radar, an infrared sensor, or a range finder, a stereo camera, a combination of a plurality of monocular cameras, or the like may be used as the sensor terminal.

The sensor data may be a distance (position) of an object, a monocular camera image, a stereo camera image, a color, a reflectance, an attitude or an orientation of a sensor, a gyro, a sensing position (GPS information or elevation), a velocity, an acceleration, a time of day of sensing, air temperature, air pressure, humidity, magnetism, or the like.

Three-dimensional data encoder 113 corresponds to encoding device 100 illustrated in FIG. 5 and the like. For example, three-dimensional data encoder 113 encodes three-dimensional data and generates encoded data. In addition, three-dimensional data encoder 113 generates control information when encoding the three-dimensional data. Furthermore, three-dimensional data encoder 113 inputs the encoded data to system multiplexer 114 together with the control information.

The encoding system of three-dimensional data may be an encoding system using geometry or an encoding system using a video codec. In this case, an encoding system using geometry may also be expressed as a geometry-based encoding system. An encoding system using a video codec may also be expressed as a video-based encoding system.

System multiplexer 114 multiplexes encoded data and control information input from three-dimensional data encoder 113 and generates multiplexed data using a prescribed multiplexing system. System multiplexer 114 may multiplex other media such as video, audio, subtitles, application data, or document files, reference time information, or the like together with the encoded data and control information of three-dimensional data. Furthermore, system multiplexer 114 may multiplex attribute information related to sensor data or three-dimensional data.

For example, multiplexed data has a file format for accumulation, a packet format for transmission, or the like. ISOBMFF or an ISOBMFF-based system may be used as an accumulation system or a transmission system. Alternatively, MPEG-DASH, MMT, MPEG-2 TS Systems, RTP, or the like may be used.

In addition, multiplexed data is output as a transmission signal by input/output processor 112 to external connector 310. The multiplexed data may be transmitted as a transmission signal in a wired manner or in a wireless manner. Alternatively, the multiplexed data is accumulated in an internal memory or a storage device. The multiplexed data may be transmitted via the Internet to a cloud server or stored in an external storage device.

For example, the transmission or accumulation of the multiplexed data is performed by a method in accordance with a medium for transmission or accumulation such as broadcasting or communication. As a communication protocol, http, ftp, TCP, UDP, IP, or a combination thereof may be used. In addition, a pull-type communication scheme may be used or a push-type communication scheme may be used.

Ethernet (registered trademark), USB, RS-232C, HDMI (registered trademark), a coaxial cable, or the like may be used for wired transmission. In addition, 3GPP (registered trademark), 3G/4G/5G as specified by IEEE, a wireless LAN, Bluetooth, or a millimeter-wave may be used for wireless transmission. Furthermore, for example, DVB-T2, DVB-S2, DVB-C2, ATSC 3.0, ISDB-S3, or the like may be used as a broadcasting system.

Note that sensor data may be input to three-dimensional data generator 115 or system multiplexer 114. In addition, three-dimensional data or encoded data may be output as-is as a transmission signal to external connector 310 via input/output processor 112. The transmission signal output from three-dimensional data encoding system 110 is input to three-dimensional data decoding system 210 via external connector 310.

In addition, each operation of three-dimensional data encoding system 110 may be controlled by controller 111 which executes application programs.

In three-dimensional data decoding system 210, a transmission signal is input to input/output processor 212. Input/output processor 212 decodes multiplexed data having a file format or a packet format from the transmission signal and inputs the multiplexed data to system demultiplexer 214. System demultiplexer 214 acquires encoded data and control information from the multiplexed data and inputs the encoded data and the control information to three-dimensional data decoder 213. System demultiplexer 214 may extract other media, reference time information, or the like from the multiplexed data.

Three-dimensional data decoder 213 corresponds to decoding device 200 illustrated in FIG. 7 and the like. For example, three-dimensional data decoder 213 decodes three-dimensional data from the encoded data based on an encoding system specified in advance. Subsequently, the three-dimensional data is presented to a user by presenter 215.

In addition, additional information such as sensor data may be input to presenter 215. Presenter 215 may present three-dimensional data based on the additional information. In addition, an instruction by the user may be input to user interface 216 from a user terminal. Furthermore, presenter 215 may present three-dimensional data based on the input instruction.

Note that input/output processor 212 may acquire three-dimensional data and encoded data from external connector 310.

In addition, each operation of three-dimensional data decoding system 210 may be controlled by controller 211 which executes application programs.

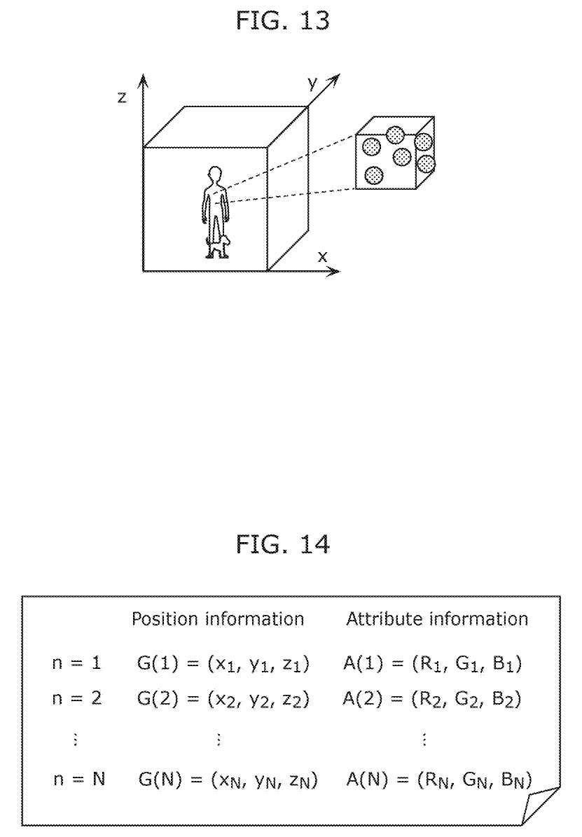

FIG. 13 is a conceptual diagram illustrating a configuration example of point cloud data according to the present embodiment. Point cloud data refers to data of a point cloud that indicates a three-dimensional object.

Specifically, a point cloud is constituted of a plurality of points and has position information which indicates a three-dimensional coordinate position of each point and attribute information which indicates an attribute of each point. The position information is also expressed as geometry.

For example, a type of attribute information may be a color, a reflectance, or the like. Attribute information related to one type may be associated with one point, attribute information related to a plurality of different types may be associated with one point, or attribute information having a plurality of values with respect to a same type may be associated with one point.

FIG. 14 is a conceptual diagram illustrating a data file example of the point cloud data according to the present embodiment. The example is an example of a case where items of position information and items of attribute information have a one-to-one correspondence and the example indicates position information and attribute information of N-number of points which constitute the point cloud data. In this example, position information is information indicating a three-dimensional coordinate position by three axes of x, y, and z and attribute information is information indicating a color by RGB. As a representative data file of point cloud data, a PLY file or the like can be used.

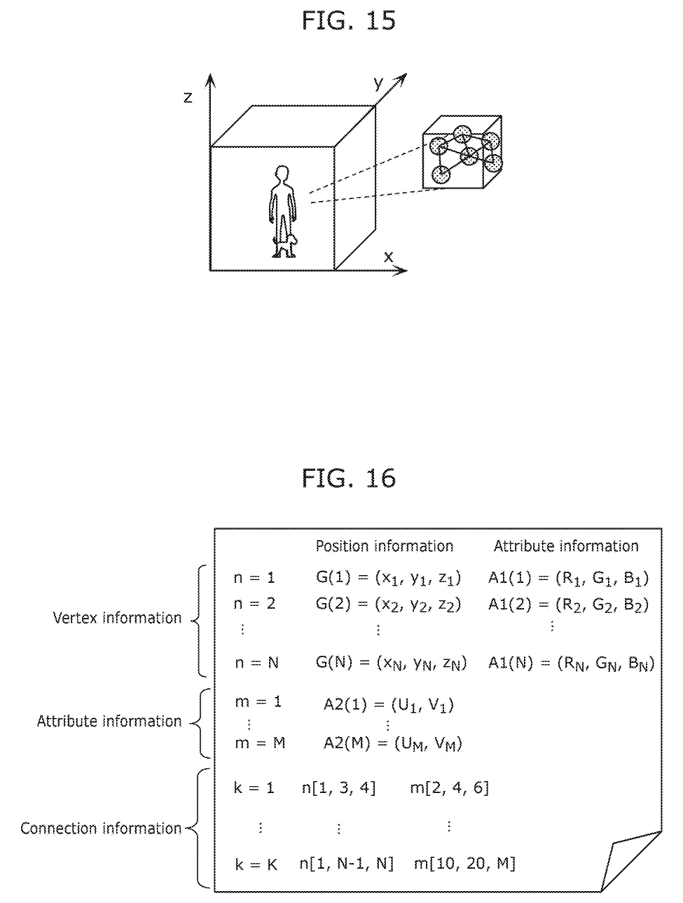

FIG. 15 is a conceptual diagram illustrating a configuration example of mesh data according to the present embodiment. Mesh data is data used in CG (computer graphics) or the like and is data of a three-dimensional mesh which represents a three-dimensional shape of an object by a plurality of faces. Each face is also expressed as a polygon and has a polygonal shape such as a triangle or a quadrilateral.

Specifically, in addition to the plurality of points which constitute a point cloud, a three-dimensional mesh is constituted of a plurality of edges and a plurality of faces. Each point is also expressed as a vertex or a position. Each edge corresponds to a line segment which connects two vertexes. Each face corresponds to an area enclosed by three or more edges.

In addition, a three-dimensional mesh has position information indicating three-dimensional coordinate positions of vertexes. The position information is also expressed as vertex information or geometry. Furthermore, a three-dimensional mesh has connection information indicating a relationship among a plurality of vertexes constituting an edge or a face. The connection information is also expressed as connectivity. In addition, a three-dimensional mesh has attribute information indicating an attribute with respect to a vertex, an edge, or a face. The attribute information in a three-dimensional mesh is also expressed as a texture.

For example, attribute information may indicate a color, a reflectance, or a normal vector with respect to a vertex, an edge, or a face. An orientation of a normal vector can express a front and a rear of a face.

An object file or the like may be used as a data file format of mesh data.

FIG. 16 is a conceptual diagram illustrating a data file example of the mesh data according to the present embodiment. In the example, a data file includes pieces of position information G(1) to G(N) and pieces of attribute information A1(1) to A1(N) of N-number of vertexes which constitute a three-dimensional mesh. In addition, in the example, M-number of pieces of attribute information A2(1) to A2(M) are included. An item of attribute information need not correspond one-to-one to a vertex and need not correspond one-to-one to a face. In addition, attribute information need not exist.

Connection information is indicated by a combination of indexes of vertexes. n [1, 3, 4] indicates a face of a triangle constituted of three vertexes n = 1, n = 3, and n = 4. In addition, m [2, 4, 6] indicates that pieces of attribute information m = 2, m = 4, and m = 6 respectively correspond to the three vertexes.

In addition, a substantive content of the attribute information may be described in a separate file. Furthermore, a pointer with respect to the content may be associated with a vertex, a face, or the like. For example, attribute information indicating an image with respect to a face may be stored in a two-dimensional attribute map file. In addition, a file name of the attribute map and a two-dimensional coordinate value in the attribute map may be described in pieces of attribute information A2(1) to A2(M). Methods of designating attribute information with respect to a face are not limited to these methods and any kind of method may be used.

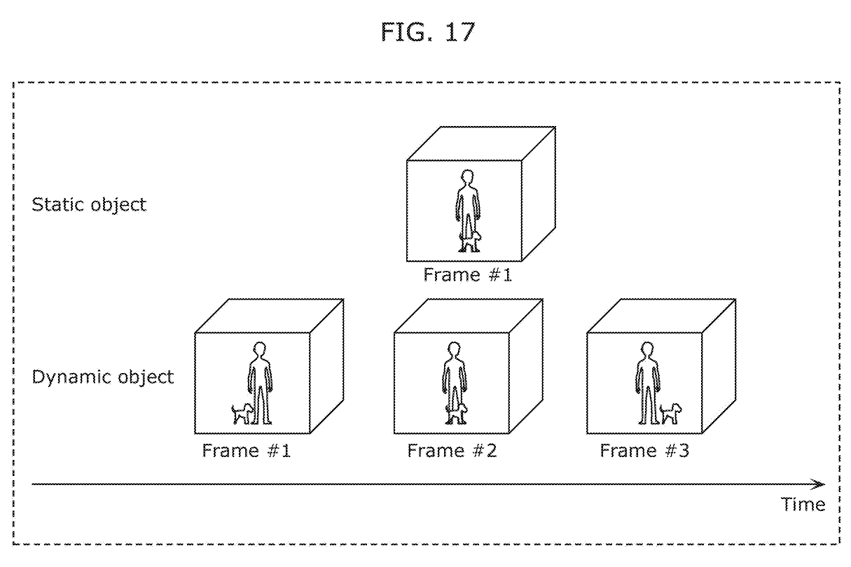

FIG. 17 is a conceptual diagram illustrating a type of three-dimensional data according to the present embodiment. Point cloud data and mesh data may either indicate a static object or a dynamic object. A static object is an object that does not temporally change and a dynamic object is an object that temporally changes. A static object may correspond to three-dimensional data with respect to an arbitrary time point.

For example, point cloud data with respect to an arbitrary time point may be expressed as a PCC frame. In addition, mesh data with respect to an arbitrary time point may be expressed as a mesh frame. Furthermore, a PCC frame and a mesh frame may be simply expressed as a frame.

In addition, an area of an object may be limited to a certain range in a similar manner to ordinary video data or need not be limited in a similar manner to map data. Furthermore, a density of points or faces may be set in various ways. Sparse point cloud data or sparse mesh data may be used or dense point cloud data or dense mesh data may be used.

Next, encoding and decoding of a point cloud or a three-dimensional mesh will be described. A device, processing, or a syntax for encoding and decoding vertex information of a three-dimensional mesh according to the present disclosure may be applied to the encoding and decoding of a point cloud. A device, processing, or a syntax for encoding and decoding a point cloud according to the present disclosure may be applied to the encoding and decoding of vertex information of a three-dimensional mesh.

In addition, a device, processing, or a syntax for encoding and decoding attribute information of a point cloud according to the present disclosure may be applied to the encoding and decoding of connection information or attribute information of a three-dimensional mesh. Furthermore, a device, processing, or a syntax for encoding and decoding connection information or attribute information of a three-dimensional mesh according to the present disclosure may be applied to the encoding and decoding of attribute information of a point cloud.

Furthermore, at least a part of processing may be commonalized between the encoding and decoding of point cloud data and the encoding and decoding of mesh data. Accordingly, sizes of circuits and software programs can be suppressed.

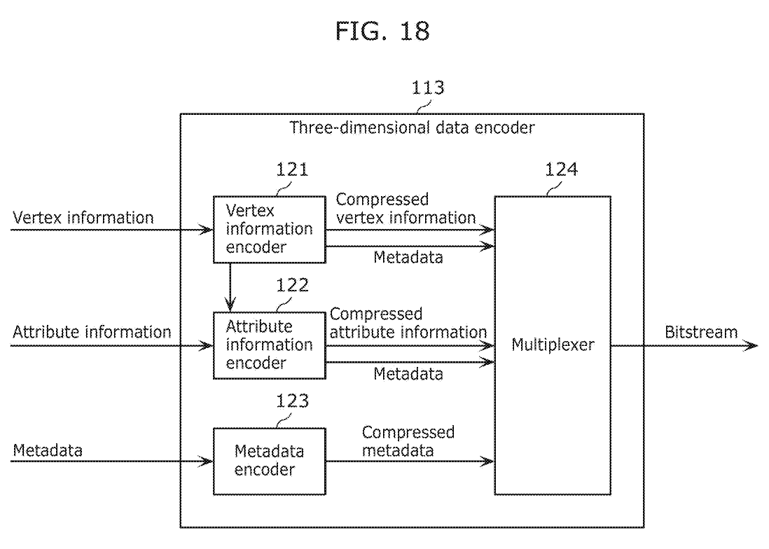

FIG. 18 is a block diagram illustrating a configuration example of three-dimensional data encoder 113 according to the present embodiment. In this example, three-dimensional data encoder 113 includes vertex information encoder 121, attribute information encoder 122, metadata encoder 123, and multiplexer 124. Vertex information encoder 121, attribute information encoder 122, and multiplexer 124 may correspond to vertex information encoder 101, attribute information encoder 103, postprocessor 105, and the like illustrated in FIG. 6.

In addition, in this example, three-dimensional data encoder 113 encodes three-dimensional data according to a geometry-based encoding system. Encoding according to the geometry-based encoding system takes a three-dimensional structure into consideration. Furthermore, in encoding according to the geometry-based encoding system, attribute information is encoded using configuration information obtained during encoding of vertex information.

Specifically, first, vertex information, attribute information, and metadata included in three-dimensional data generated from sensor data are respectively input to vertex information encoder 121, attribute information encoder 122, and metadata encoder 123. In this case, connection information included in three-dimensional data may be handled in a similar manner to attribute information. In addition, in the case of point cloud data, position information may be handled as vertex information.

Vertex information encoder 121 encodes vertex information into compressed vertex information and outputs the compressed vertex information to multiplexer 124 as encoded data. In addition, vertex information encoder 121 generates metadata of the compressed vertex information and outputs the metadata to multiplexer 124. Furthermore, vertex information encoder 121 generates configuration information and outputs the configuration information to attribute information encoder 122.

Attribute information encoder 122 encodes attribute information into compressed attribute information using the configuration information generated by vertex information encoder 121 and outputs the compressed attribute information to multiplexer 124 as encoded data. In addition, attribute information encoder 122 generates metadata of the compressed attribute information and outputs the metadata to multiplexer 124.

Metadata encoder 123 encodes compressible metadata into compressed metadata and outputs the compressed metadata to multiplexer 124 as encoded data. The metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

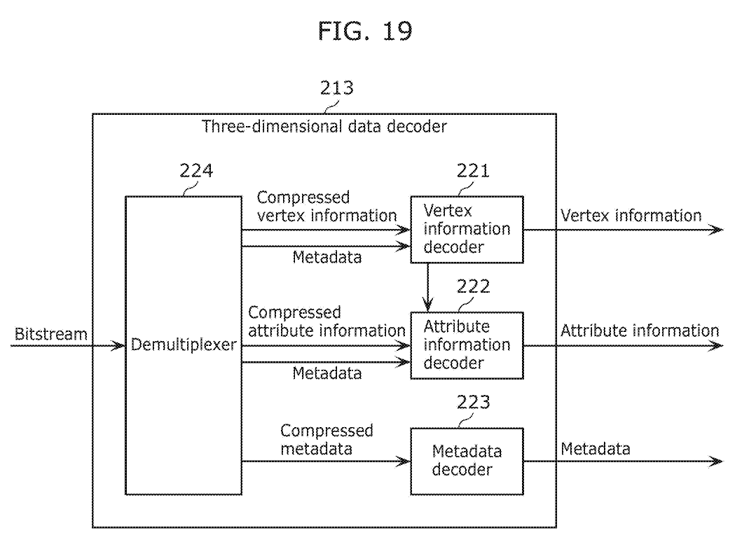

FIG. 19 is a block diagram illustrating a configuration example of three-dimensional data decoder 213 according to the present embodiment. In this example, three-dimensional data decoder 213 includes vertex information decoder 221, attribute information decoder 222, metadata decoder 223, and demultiplexer 224. Vertex information decoder 221, attribute information decoder 222, and demultiplexer 224 may correspond to vertex information decoder 201, attribute information decoder 203, preprocessor 204, and the like illustrated in FIG. 8.

In addition, in this example, three-dimensional data decoder 213 decodes three-dimensional data according to a geometry-based encoding system. Decoding according to the geometry-based encoding system takes a three-dimensional structure into consideration. Furthermore, in decoding according to the geometry-based encoding system, attribute information is decoded using configuration information obtained during decoding of vertex information.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information and the metadata of the compressed vertex information are input to vertex information decoder 221. The compressed attribute information and the metadata of the compressed attribute information are input to attribute information decoder 222. The metadata is input to metadata decoder 223.

Vertex information decoder 221 decodes vertex information from the compressed vertex information using the metadata of the compressed vertex information. In addition, vertex information decoder 221 generates configuration information and outputs the configuration information to attribute information decoder 222. Attribute information decoder 222 decodes attribute information from the compressed attribute information using the configuration information generated by vertex information decoder 221 and the metadata of the compressed attribute information. Metadata decoder 223 decodes metadata from the compressed metadata. The metadata decoded by metadata decoder 223 may be used to decode vertex information and to decode attribute information.

Subsequently, the vertex information, the attribute information, and the metadata are output from three-dimensional data decoder 213 as three-dimensional data. For example, the metadata is metadata of vertex information and attribute information and can be used in an application program.

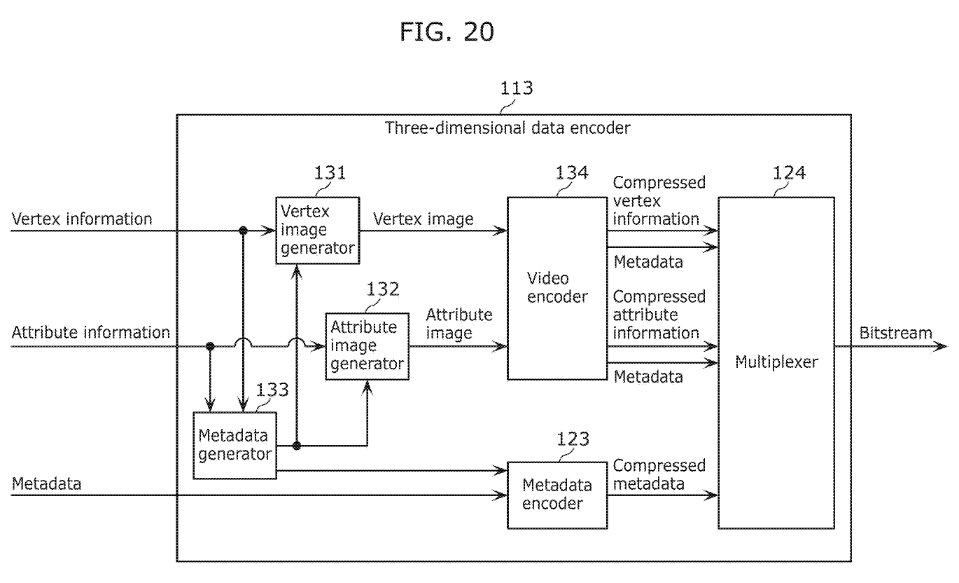

FIG. 20 is a block diagram illustrating another configuration example of three-dimensional data encoder 113 according to the present embodiment. In this example, three-dimensional data encoder 113 includes vertex image generator 131, attribute image generator 132, metadata generator 133, video encoder 134, metadata encoder 123, and multiplexer 124. Vertex image generator 131, attribute image generator 132, and video encoder 134 may correspond to vertex information encoder 101, attribute information encoder 103, and the like illustrated in FIG. 6.

In addition, in this example, three-dimensional data encoder 113 encodes three-dimensional data according to a video-based encoding system. In encoding according to the video-based encoding system, a plurality of two-dimensional images are generated from three-dimensional data and the plurality of two-dimensional images are encoded according to a video encoding system. In this case, the video encoding system may be HEVC (high efficiency video coding), VVC (versatile video coding), or the like.

Specifically, first, vertex information and attribute information included in three-dimensional data generated from sensor data are input to metadata generator 133. In addition, the vertex information and the attribute information are respectively input to vertex image generator 131 and attribute image generator 132. Furthermore, the metadata included in the three-dimensional data is input to metadata encoder 123. In this case, connection information included in three-dimensional data may be handled in a similar manner to attribute information. In addition, in the case of point cloud data, position information may be handled as vertex information.

Metadata generator 133 generates map information of a plurality of two-dimensional images from the vertex information and the attribute information. In addition, metadata generator 133 inputs the map information into vertex image generator 131, attribute image generator 132, and metadata encoder 123.

Vertex image generator 131 generates a vertex image based on the vertex information and the map information and inputs the vertex image into video encoder 134. Attribute image generator 132 generates an attribute image based on the attribute information and the map information and inputs the attribute image into video encoder 134.

Video encoder 134 respectively encodes the vertex image and the attribute image into compressed vertex information and compressed attribute information according to the video encoding system and outputs the compressed vertex information and the compressed attribute information to multiplexer 124 as encoded data. In addition, video encoder 134 generates metadata of the compressed vertex information and metadata of the compressed attribute information and outputs the pieces of metadata to multiplexer 124.

Metadata encoder 123 encodes compressible metadata into compressed metadata and outputs the compressed metadata to multiplexer 124 as encoded data. Compressible metadata includes map information. In addition, the metadata encoded by metadata encoder 123 may be used to encode vertex information and to encode attribute information.

Multiplexer 124 multiplexes the compressed vertex information, the metadata of the compressed vertex information, the compressed attribute information, the metadata of the compressed attribute information, and the compressed metadata into a bitstream. In addition, multiplexer 124 inputs the bitstream into a system layer.

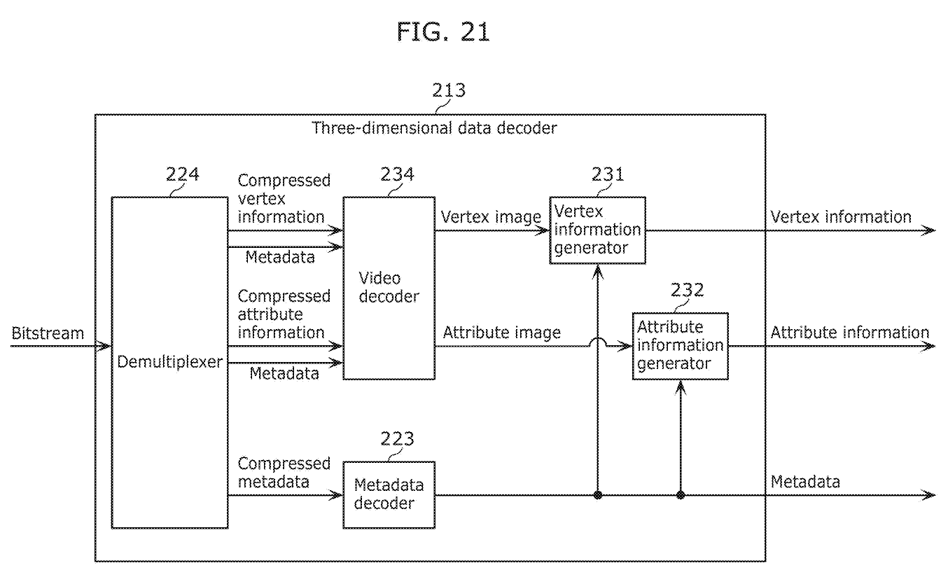

FIG. 21 is a block diagram illustrating another configuration example of three-dimensional data decoder 213 according to the present embodiment. In this example, three-dimensional data decoder 213 includes vertex information generator 231, attribute information generator 232, video decoder 234, metadata decoder 223, and demultiplexer 224. Vertex information generator 231, attribute information generator 232, and video decoder 234 may correspond to vertex information decoder 201, attribute information decoder 203, and the like illustrated in FIG. 8.

In addition, in this example, three-dimensional data decoder 213 decodes three-dimensional data according to a video-based encoding system. In decoding according to the video-based encoding system, a plurality of two-dimensional images are decoded according to a video encoding system and three-dimensional data is generated from the plurality of two-dimensional images. In this case, the video encoding system may be HEVC (high efficiency video coding), VVC (versatile video coding), or the like.

Specifically, first, a bitstream is input from a system layer into demultiplexer 224. Demultiplexer 224 separates compressed vertex information, metadata of the compressed vertex information, compressed attribute information, metadata of the compressed attribute information, and compressed metadata from the bitstream. The compressed vertex information, the metadata of the compressed vertex information, the compressed attribute information, and the metadata of the compressed attribute information are input to video decoder 234. The compressed metadata is input to metadata decoder 223.

Video decoder 234 decodes a vertex image according to the video encoding system. In doing so, video decoder 234 decodes the vertex image from the compressed vertex information using the metadata of the compressed vertex information. In addition, video decoder 234 inputs the vertex image into vertex information generator 231. Furthermore, video decoder 234 decodes an attribute image according to the video encoding system. In doing so, video decoder 234 decodes the attribute image from the compressed attribute information using the metadata of the compressed attribute information. In addition, video decoder 234 inputs the attribute image into attribute information generator 232.

Metadata decoder 223 decodes metadata from the compressed metadata. The metadata decoded by metadata decoder 223 includes map information to be used to generate vertex information and to generate attribute information. In addition, the metadata decoded by metadata decoder 223 may be used to decode the vertex image and to decode the attribute image.

Vertex information generator 231 reproduces vertex information from the vertex image according to the map information included in the metadata decoded by metadata decoder 223. Attribute information generator 232 reproduces attribute information from the attribute image according to the map information included in the metadata decoded by metadata decoder 223.

Subsequently, the vertex information, the attribute information, and the metadata are output from three-dimensional data decoder 213 as three-dimensional data. For example, the metadata is metadata of vertex information and attribute information and can be used in an application program.

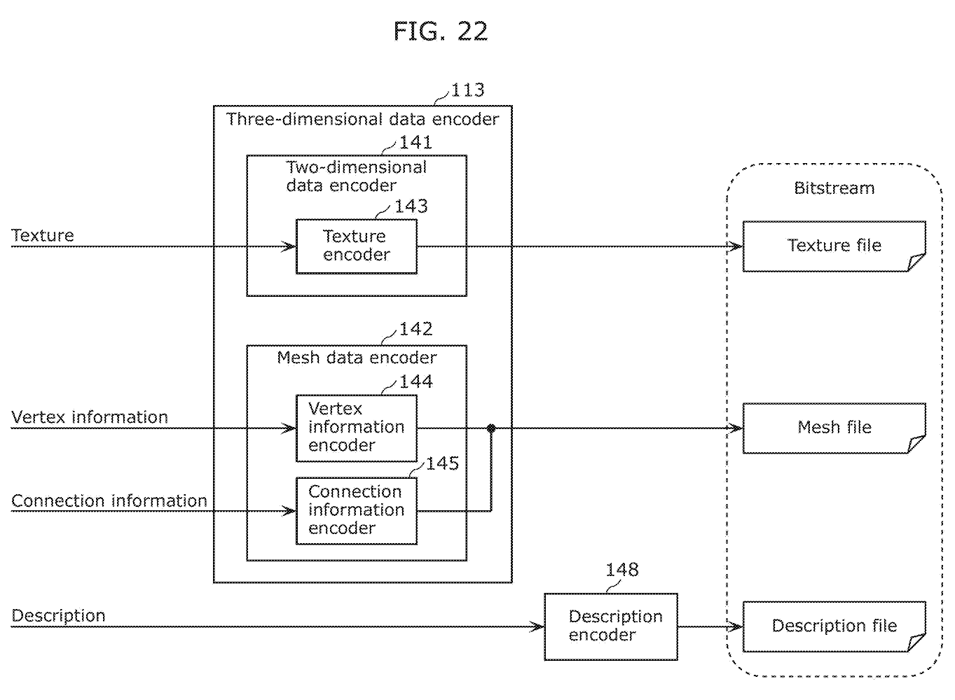

FIG. 22 is a conceptual diagram illustrating a specific example of encoding processing according to the present embodiment. FIG. 22 illustrates three-dimensional data encoder 113 and description encoder 148. In this example, three-dimensional data encoder 113 includes two-dimensional data encoder 141 and mesh data encoder 142. Two-dimensional data encoder 141 includes texture encoder 143. Mesh data encoder 142 includes vertex information encoder 144 and connection information encoder 145.

Vertex information encoder 144, connection information encoder 145, and texture encoder 143 may correspond to vertex information encoder 101, connection information encoder 102, attribute information encoder 103, and the like illustrated in FIG. 6.

For example, two-dimensional data encoder 141 operates as texture encoder 143 and generates a texture file by encoding a texture corresponding to attribute information as two-dimensional data according to an image encoding system or a video encoding system.

In addition, mesh data encoder 142 operates as vertex information encoder 144 and connection information encoder 145 and generates a mesh file by encoding vertex information and connection information. Mesh data encoder 142 may further encode mapping information with respect to a texture. The encoded mapping information may be included in a mesh file.

In addition, description encoder 148 generates a description file by encoding a description corresponding to metadata such as text data. Description encoder 148 may encode a description in the system layer. For example, description encoder 148 may be included in system multiplexer 114 illustrated in FIG. 12.

Due to the operation described above, a bitstream including a texture file, a mesh file, and a description file is generated. The files may be multiplexed in the bitstream in a file format such as gITF (graphics language transmission format) or USD (universal scene description).

Note that three-dimensional data encoder 113 may include two mesh data encoders as mesh data encoder 142. For example, one mesh data encoder encodes vertex information and connection information of a static three-dimensional mesh and the other mesh data encoder encodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

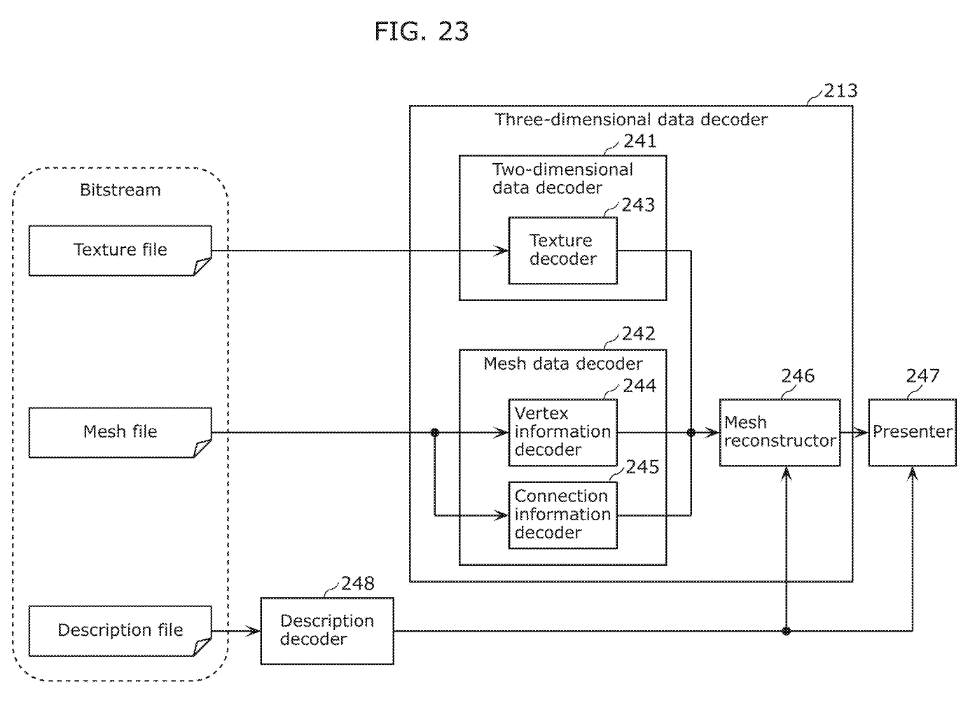

FIG. 23 is a conceptual diagram illustrating a specific example of decoding processing according to the present embodiment. FIG. 23 illustrates three-dimensional data decoder 213, description decoder 248, and presenter 247. In this example, three-dimensional data decoder 213 includes two-dimensional data decoder 241, mesh data decoder 242, and mesh reconstructor 246. Two-dimensional data decoder 241 includes texture decoder 243. Mesh data decoder 242 includes vertex information decoder 244 and connection information decoder 245.

Vertex information decoder 244, connection information decoder 245, texture decoder 243, and mesh reconstructor 246 may correspond to vertex information decoder 201, connection information decoder 202, attribute information decoder 203, postprocessor 205, and the like illustrated in FIG. 8. Presenter 247 may correspond to presenter 215 and the like illustrated in FIG. 12.

For example, two-dimensional data decoder 241 operates as texture decoder 243 and decodes a texture corresponding to attribute information from a texture file as two-dimensional data according to an image encoding system or a video encoding system.

In addition, mesh data decoder 242 operates as vertex information decoder 244 and connection information decoder 245 and decodes vertex information and connection information from a mesh file. Mesh data decoder 242 may further decode mapping information with respect to a texture from the mesh file.

Furthermore, description decoder 248 decodes a description corresponding to metadata such as text data from a description file. Description decoder 248 may decode a description in the system layer. For example, description decoder 248 may be included in system demultiplexer 214 illustrated in FIG. 12.

Mesh reconstructor 246 reconstructs a three-dimensional mesh from vertex information, connection information, and a texture according to a description. Presenter 247 renders and outputs the three-dimensional mesh according to the description.

Due to the operation described above, a three-dimensional mesh is reconstructed and output from a bitstream including a texture file, a mesh file, and a description file.

Note that three-dimensional data decoder 213 may include two mesh data decoders as mesh data decoder 242. For example, one mesh data decoder decodes vertex information and connection information of a static three-dimensional mesh and the other mesh data decoder decodes vertex information and connection information of a dynamic three-dimensional mesh.

In addition, two mesh files may be included in the bitstream so as to correspond to the three-dimensional meshes. For example, one mesh file corresponds to the static three-dimensional mesh and the other mesh file corresponds to the dynamic three-dimensional mesh.

Furthermore, the static three-dimensional mesh may be an intra-frame three-dimensional mesh which is encoded using intra-prediction and the dynamic three-dimensional mesh may be an inter-frame three-dimensional mesh which is encoded using inter-prediction. In addition, as information of the dynamic three-dimensional mesh, difference information between vertex information or connection information of the intra-frame three-dimensional mesh and vertex information or connection information of the inter-frame three-dimensional mesh may be used.

An encoding system of a dynamic three-dimensional mesh may be called DMC (dynamic mesh coding). In addition, a video-based encoding system of a dynamic three-dimensional mesh may be called VDMC (video-based dynamic mesh coding).

An encoding system of a point cloud may be called PCC (point cloud compression). A video-based encoding system of a point cloud may be called V-PCC (video-based point cloud compression). In addition, a geometry-based encoding system of a point cloud may be called G-PCC (geometry-based point cloud compression).

### Implementation example

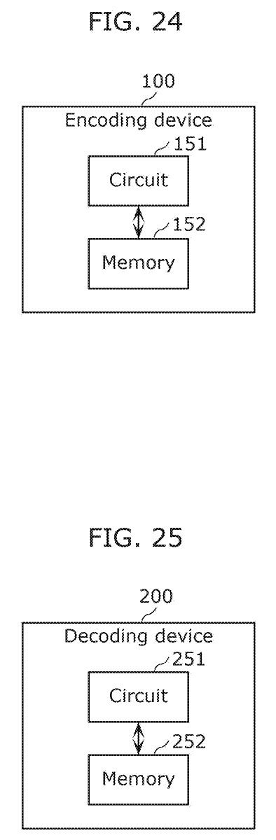

FIG. 24 is a block diagram illustrating an implementation example of encoding device 100 according to the present embodiment. Encoding device 100 includes circuit 151 and memory 152. For example, a plurality of constituent elements of encoding device 100 illustrated in FIG. 5 and the like are implemented by circuit 151 and memory 152 illustrated in FIG. 24.

Circuit 151 is a circuit which performs information processing and which is capable of accessing memory 152. For example, circuit 151 is a dedicated or general-purpose electric circuit which encodes a three-dimensional mesh. Circuit 151 may be a processor such as a CPU. Alternatively, circuit 151 may be a set of a plurality of electric circuits.

Memory 152 is a dedicated or general-purpose memory that stores information used by circuit 151 to encode a three-dimensional mesh. Memory 152 may be an electric circuit and may be connected to circuit 151. In addition, memory 152 may be included in circuit 151. Alternatively, memory 152 may be a set of a plurality of electric circuits. Furthermore, memory 152 may be a magnetic disk, an optical disk, or the like or may be expressed as a storage, a recording medium, or the like. In addition, memory 152 may be a non-volatile memory or a volatile memory.

For example, memory 152 may store a three-dimensional mesh or a bitstream. In addition, memory 152 may store a program used by circuit 151 to encode a three-dimensional mesh.

Note that in encoding device 100, all of the plurality of constituent elements illustrated in FIG. 5 and the like need not be implemented and all of the plurality of processing steps described herein need not be performed. A part of the plurality of constituent elements illustrated in FIG. 5 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in encoding device 100.

FIG. 25 is a block diagram illustrating an implementation example of decoding device 200 according to the present embodiment. Decoding device 200 includes circuit 251 and memory 252. For example, a plurality of constituent elements of decoding device 200 illustrated in FIG. 7 and the like are implemented by circuit 251 and memory 252 illustrated in FIG. 25.

Circuit 251 is a circuit which performs information processing and which is capable of accessing memory 252. For example, circuit 251 is a dedicated or general-purpose electric circuit which decodes a three-dimensional mesh. Circuit 251 may be a processor such as a CPU. Alternatively, circuit 251 may be a set of a plurality of electric circuits.

Memory 252 is a dedicated or general-purpose memory that stores information used by circuit 251 to decode a three-dimensional mesh. Memory 252 may be an electric circuit and may be connected to circuit 251. In addition, memory 252 may be included in circuit 251. Alternatively, memory 252 may be a set of a plurality of electric circuits. Furthermore, memory 252 may be a magnetic disk, an optical disk, or the like or may be expressed as a storage, a recording medium, or the like. In addition, memory 252 may be a non-volatile memory or a volatile memory.

For example, memory 252 may store a three-dimensional mesh or a bitstream. In addition, memory 252 may store a program used by circuit 251 to decode a three-dimensional mesh.

Note that in decoding device 200, all of the plurality of constituent elements illustrated in FIG. 7 and the like need not be implemented and all of the plurality of processing steps described herein need not be performed. A part of the plurality of constituent elements illustrated in FIG. 7 and the like may be included in another device and a part of the plurality of processing steps described herein may be executed by another device. In addition, a plurality of constituent elements according to the present disclosure may be optionally combined and implemented or a plurality of processing steps according to the present disclosure may be optionally combined and executed in decoding device 200.

An encoding method and a decoding method including steps performed by each constituent element of encoding device 100 and decoding device 200 according to the present disclosure may be executed by any device or system. For example, a part of or all of the encoding method and the decoding method may be executed by a computer including a processor, a memory, an input/output circuit, and the like. In doing so, the encoding method and the decoding method may be executed by having the computer execute a program that enables the computer to execute the encoding method and the decoding method.

In addition, a program or a bitstream may be recorded on a non-transitory computer-readable recording medium such as a CD-ROM.

An example of a program may be a bitstream. For example, a bitstream including an encoded three-dimensional mesh includes a syntax element that enables decoding device 200 to decode the three-dimensional mesh. In addition, the bitstream causes decoding device 200 to decode the three-dimensional mesh according to the syntax element included in the bitstream. Therefore, a bitstream can perform a similar role to a program.

The bitstream described above may be an encoded bitstream including an encoded three-dimensional mesh or a multiplexed bitstream including an encoded three-dimensional mesh and other information.

In addition, each constituent element of encoding device 100 and decoding device 200 may be constituted of dedicated hardware, general-purpose hardware which executes the program or the like described above, or a combination thereof. Furthermore, the general-purpose hardware may be constituted of a memory on which a program is recorded, a general-purpose processor which reads the program from the memory and executes the program, and the like. In this case, the memory may be a semiconductor memory, a hard disk, or the like and the general-purpose processor may be a CPU or the like.

Furthermore, the dedicated hardware may be constituted of a memory, a dedicated processor, and the like. For example, the dedicated processor may execute the encoding method and the decoding method by referring to a memory for recording data.

In addition, as described above, the respective constituent elements of encoding device 100 and decoding device 200 may be electric circuits. The electric circuits may constitute one electric circuit as a whole or may be respectively different electric circuits. Furthermore, the electric circuits may correspond to dedicated hardware or to general-purpose hardware which executes the program or the like described above. Moreover, encoding device 100 and decoding device 200 may be implemented as integrated circuits.

In addition, encoding device 100 may be a transmitting device which transmits a three-dimensional mesh. Decoding device 200 may be a receiving device which receives a three-dimensional mesh.

### Encoding and decoding of displacement

The following terms will be used here as examples.

### Image

An image is a data unit constituted of a set of pixels. An image includes a picture or blocks, which are smaller than a picture. Images include a still image in addition to a moving image.

### Picture

A picture is an image processing unit constituted of a set of pixels. A picture will also be referred to as a frame or a field.

### Block

A block is a processing unit constituted of a set of a particular number of pixels. For a block, the terms shown as the following examples are also used. The shapes of blocks are not particularly limited. Examples of blocks can include a rectangle shape of M × N pixels or a square shape of M × M pixels. The examples of blocks may also include a triangular shape, a circular shape, and other shapes. Examples of blocks are as follows.

Slice, tile, or brick

CTU, super block, or basic dividing unit

VPDU, processing dividing unit for hardware

CU, processing block unit, prediction block unit (PU), or orthogonal transform block unit (TU)

Sub-block

### Pixel or sample

A pixel or a sample is the smallest point of an image, in other words, the smallest unit. Pixels or samples include not only a pixel at an integer position but also a pixel at a sub-pixel position that is generated based on a pixel at an integer position.

### Pixel value or sample value

A pixel value or a sample value is an eigen value of a pixel. Pixel values or sample values include a luma value, a chroma value, and an RGB gradation level. Pixel values or sample values can also include a depth value or a binary value of 0 or 1.

### Flag

A flag indicates one or more bits. A flag is, for example, a parameter or an index represented by two or more bits. A flag may indicate not only a value represented by a binary number but also a value represented by a numerical value other than a binary number.

### Signal

A signal is one that is symbolized or encoded to convey information. Signals include a discrete digital signal and an analog signal that takes a continuous value.

### Stream or bitstream

A stream or a bitstream is a digital data string indicating a digital data flow. A stream or a bitstream may be one stream or may be constituted of a plurality of streams having a plurality of hierarchical layers. A stream or a bitstream may be transmitted in serial communication using a single transmission path or may be transmitted in packet communication using a plurality of transmission paths.

### Difference

In the case of scalar quantities, a difference can include a simple difference (x - y) and a difference calculation. Differences can include an absolute value of a difference (|x - y|), a squared difference (x^2 - y^2), a square root of a difference (√(x - y)), a weighted difference (ax - by: a and b are constants), or an offset difference (x - y + a: a is an offset).

### Sum

In the case of scalar quantities, sums can include a simple sum (x + y) and a sum calculation. Sums include an absolute value of a sum (|x + y|), a squared sum (x^2 + y^2), a square root of a sum (√(x + y)), a weighted sum (ax + by: a and b are constants), and an offset sum (x + y + a: a is an offset).

### "Based on"

The phrase "based on something" means that a thing other than the "something" may be taken into consideration. In addition, the term "based on" may be used in a case where a direct result is obtained or a case where a result is obtained through an interim result.

### "Used" or "using"

The phrase "something is used" or "using something" means that a thing other than the "something" may be taken into consideration. In addition, the term "used" or "using" may be used in a case where a direct result is obtained or a case where a result is obtained through an interim result.

### Prohibit, forbid

The term "prohibit" or "forbid" can be rephrased as "does not permit" or "does not allow." In addition, the phrase "being not prohibited/forbidden" or "being permitted/allowed" does not always mean "obligation."

### "Limit", or "restriction/restrict/restricted"

The term "limit" or "restriction/restrict/restricted" can be rephrased as "does not permit/allow" or "being not permitted/allowed." In addition, the phrase "being prohibited/forbidden," "being not prohibited/forbidden," "being not permitted/allowed," or "being permitted/allowed" does not always mean "obligation." Furthermore, part of something may be prohibited/forbidden quantitatively or qualitatively, or something may be fully prohibited/forbidden quantitatively or qualitatively.

### Chroma

Chroma is an adjective that is represented by the symbols Cb and Cr, specifying that a sample array or a single sample represents one of two color difference signals related to primary colors. The term chroma may be used instead of the term chrominance.

### Luma

Luma is an adjective that is represented by the symbol or subscript Y or L, specifying that a sample array or a single sample represents a monochrome signal related to primary colors. The term luma may be used instead of the term luminance.

Hereinafter, an encoding/decoding system of the present embodiment will be described.

A generic three-dimensional model (also referred to as a 3D model) represents an object digitally such that a user can explorer a model using zooming, panning, and rotation in all three dimensions while rendering it temporally. One way to construct such a representation is to construct a 3D mesh using triangles. The model stores the positions of the vertices of each triangle, connectivity of the vertices of the triangle with each other, and the attributes associated therewith (such as a normal, UV patches, etc.).

Storing all of these types of information in an uncompressed form needs very large storage space, which in turn needs a very large bandwidth for transmission. The triangles forming the mesh often have a repetitive pattern and similar attributes especially in the temporal and spatial neighborhood. The repetition can be used to formulate an efficient encoding and decoding method for storage and transmission. One such encoding and decoding method is Video-based Dynamic Mesh Coding (V-DMC).

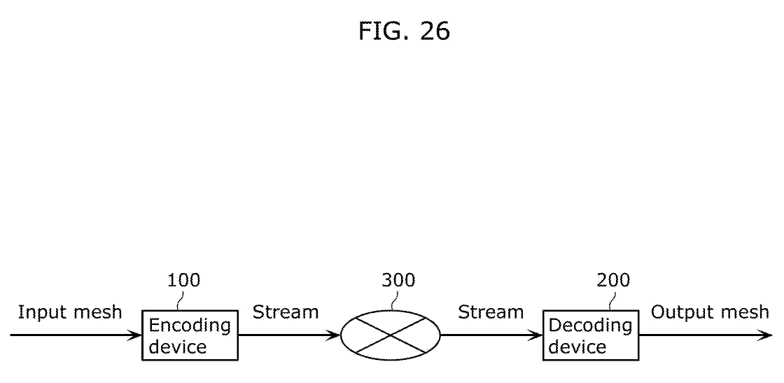

FIG. 26 is a block diagram illustrating another configuration example of the encoding/decoding system according to the present embodiment. As illustrated in FIG. 26, the encoding/decoding system includes encoding device 100 and decoding device 200.

The encoding/decoding system receives a three-dimensional mesh (also referred to as a 3D mesh) that is input in the form of three-dimensional coordinates (vertex information), connectivity (connection information), and associated attributes (attribute information) of vertices. Note that the 3D mesh can include not only geometry but also a texture map.

Encoding device 100 takes in the 3D mesh that has been input (also referred to as an input 3D mesh or an input mesh) in the form of the vertices' three-dimensional coordinates, connectivity, and associated attributes. Encoding device 100 is responsible for encoding all related information into a stream. The stream may include a single bitstream or a plurality of bitstreams.

Network 300 transmits the stream generated by the encoding device to decoding device 200. Network 300 may be the Internet, a wide area network (WAN), a local area network (LAN), or any combination of these networks. Network 300 is not always limited to a bidirectional communication network. Network 300 may be a unidirectional communication network that transmits broadcast waves of digital terrestrial broadcasting, satellite broadcasting, or the like. Alternatively, network 300 may be replaced by a recording medium such as a Digital Versatile Disc (DVD), a Blue-Ray Disc (BD), or the like on which the stream is recorded.

The stream is transmitted to decoding device 200 through network 300. Decoding device 200 decodes the bitstream to produce a three-dimensional mesh using the decoded vertices' three-dimensional coordinates, connectivity, and associated attributes. Decoding device 200 outputs the produced three-dimensional mesh (also referred to as an output 3D mesh or an output mesh).

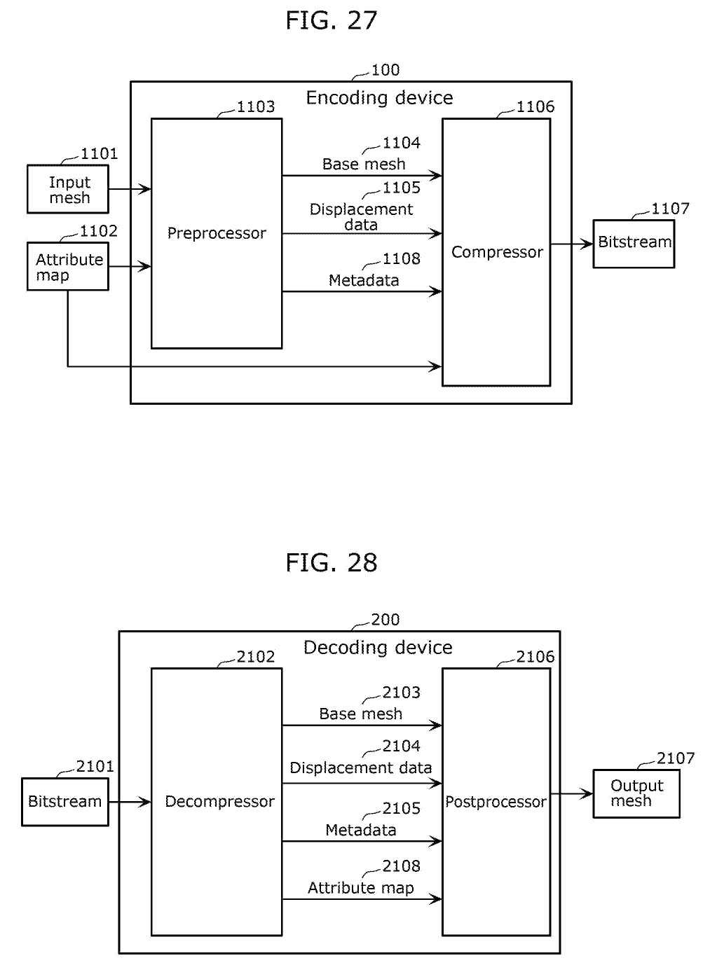

FIG. 27 is a diagram illustrating another configuration example of encoding device 100.

As illustrated in FIG. 27, encoding device 100 includes preprocessor 1103 and compressor 1106.

Encoding device 100 reads input mesh 1101 and attribute map 1102 and passes them to preprocessor 1103. Preprocessor 1103 processes the input mesh to extract base mesh 1104 and displacement data 1105. Attribute map 1102 along with base mesh 1104 and displacement data 1105 having been extracted are passed to compressor 1106.

Compressor 1106 compresses base mesh 1104, displacement data 1105, and attribute map 1102 to generate bitstream 1107. Compressor 1106 can additionally include metadata 1108 in bitstream 1107 to send the supplementary information to decoding device 200.

FIG. 28 is a diagram illustrating another configuration example of decoding device 200.

As illustrated in FIG. 28, decoding device 200 includes decompressor 2102 and postprocessor 2106.

Decoding device 200 reads bitstream 2101 and passes it to decompressor 2102. Decompressor 2102 decompresses base mesh 2103, displacement data 2104, and attribute map 2108 from bitstream 2101 and passes them to postprocessor 2106. One example of displacement data 2104 is displacement vectors.

Postprocessor 2106 processes base mesh 2103 as per displacement data 2104 and attribute map 2108 to produce output mesh 2107. Postprocessor 2106 may additionally use information from metadata 2105 to produce output mesh 2107.

Hereinafter, details of the configuration of encoding device 100 will be described.

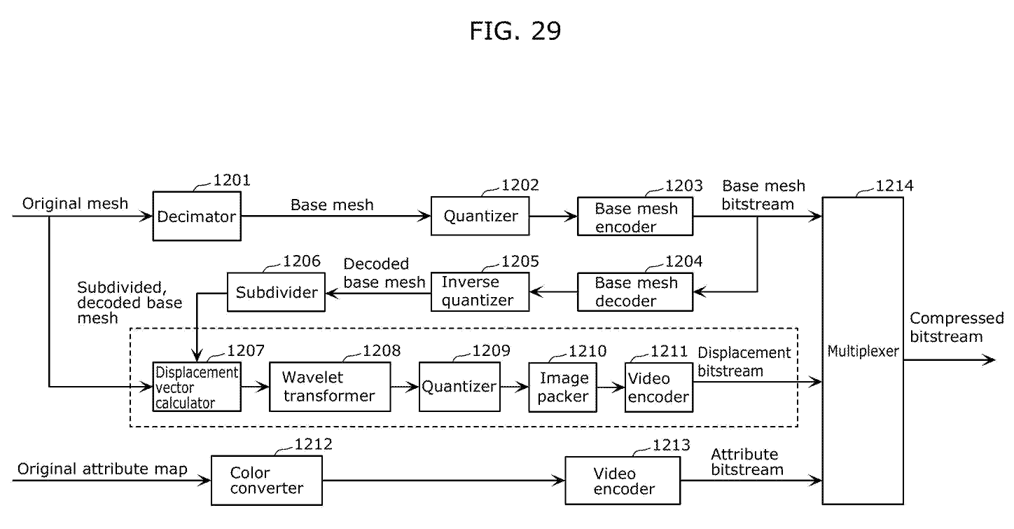

FIG. 29 is a block diagram illustrating a detailed configuration example of encoding device 100.

As illustrated in FIG. 29, encoding device 100 includes decimator 1201, quantizer 1202, base mesh encoder 1203, base mesh decoder 1204, inverse quantizer 1205, subdivider 1206, displacement vector calculator 1207, wavelet transformer 1208, quantizer 1209, image packer 1210, video encoder 1211, color converter 1212, video encoder 1213, and multiplexer 1214.

Decimator 1201 acquires a mesh that is input into encoding device 100 (equivalent to input mesh 1101) as an original mesh and performs a decimating process (in other words, a thinning-out process) on the acquired original mesh to produce a base mesh. The decimating process is a process of deleting (in other words, thinning out) some of vertices included in the original mesh. The decimating process may include a process of changing the positions of at least some of the vertices included in the original mesh or may include a process of changing the connectivity of at least some of the vertices included in the original mesh. The decimating process will also be referred to simply as decimating.

The base mesh produced through the decimating process is a mesh including fewer vertices than the original mesh. The vertices of the base mesh may be positioned differently from the vertices of the original mesh. In addition, the connectivity of the vertices of the base mesh may be different from the connectivity of the vertices of the original mesh. Decimator 1201 provides the produced base mesh to quantizer 1202.

Quantizer 1202 quantizes the base mesh produced by decimator 1201. Quantizer 1202 provides the quantized base mesh to base mesh encoder 1203.

Base mesh encoder 1203 encodes the base mesh quantized by quantizer 1202 into a bitstream (also referred to as a base mesh bitstream) (in other words, generates the base mesh bitstream). Base mesh encoder 1203 provides the base mesh bitstream to base mesh decoder 1204 and multiplexer 1214.

Base mesh decoder 1204 decodes the base mesh bitstream provided from base mesh encoder 1203 to acquire the quantized base mesh. Base mesh decoder 1204 provides the quantized base mesh to inverse quantizer 1205.

Inverse quantizer 1205 inverse quantizes the quantized base mesh provided from base mesh decoder 1204 to produce the base mesh (also referred to as a decoded base mesh). Inverse quantizer 1205 provides the decoded base mesh to subdivider 1206. The processes of quantization and inverse quantization may make the decoded base mesh produced by inverse quantizer 1205 different from the base mesh produced by decimator 1201.

Subdivider 1206 performs a subdivision process on the decoded base mesh produced by inverse quantizer 1205. The subdivision process can be a process of subdividing each face included in the decoded base mesh to segmentalize the face. Subdivider 1206 provides the subdivided, decoded base mesh to displacement vector calculator 1207.

Specifically, subdivider 1206 subdivides a mesh by generating a new vertex between two vertices that are included in the mesh and connected to each other. Repeating the generation of new vertex can increase the number of the vertices included in the mesh to a predetermined number. The iteration of the subdivision over the entire mesh (in other words, the plurality of executions of the subdivision) generates a plurality of levels of detail (LoD) layers.

Displacement vector calculator 1207 acquires the original mesh acquired by encoding device 100 and acquires, from subdivider 1206, the subdivided, decoded base mesh. Displacement vector calculator 1207 calculates vectors from the vertices of the subdivided, decoded base mesh to the vertices, faces, or edges of the original mesh, as displacement vectors. Displacement vector calculator 1207 provides the displacement vectors to wavelet transformer 1208.

Wavelet transformer 1208 performs a wavelet transforming process on the displacement vectors calculated by displacement vector calculator 1207 to acquire wavelet coefficients. Wavelet transformer 1208 provides the wavelet coefficients to quantizer 1209. In the wavelet transformation, wavelet transformer 1208 assigns the vertices to a plurality of LoD layers and applies, for example, the lifting scheme to the displacement vectors of the vertices. Wavelet transformer 1208 can thus calculate wavelet coefficients representing various components from low-frequency components to high-frequency components.

Quantizer 1209 quantizes the wavelet coefficients acquired by wavelet transformer 1208. Quantizer 1209 can quantize the wavelet coefficients for each LoD layer. Quantizer 1209 provides the quantized wavelet coefficients to image packer 1210.

Image packer 1210 generates an image containing the wavelet coefficients quantized by quantizer 1209. Image packer 1210 can generate the image by mapping the wavelet coefficients quantized by quantizer 1209 onto pixels in a two-dimensional image format. Image packer 1210 provides the generated image to video encoder 1211. In the process of mapping the quantized wavelet coefficients onto the pixels in the two-dimensional image format, mapping information that represents the assignment of the quantized wavelet coefficients to the pixels in the two-dimensional image format can be used.

Video encoder 1211 encodes the image generated by image packer 1210 into a bitstream (also referred to as a displacement bitstream) (in other words, generates the displacement bitstream). Video encoder 1211 provides the displacement bitstream to multiplexer 1214. The displacement bitstream can be a bitstream including displacement information in the form of an image. The format of the image can be, for example, a format including two items of chroma information and one item of luma information.

Color converter 1212 acquires an attribute map acquired by encoding device 100 as an original attribute map and performs a color converting process on the original attribute map. The color converting process can include a process of converting a representation form of color or a color space. Color converter 1212 provides the attribute map subjected to the color converting process to video encoder 1213. Note that although here is described the case where the original attribute map is input into color converter 1212 by way of example, the feature map may be converted in accordance with the structure of the decoded mesh in the case where the decoded mesh differs from the original mesh in the number or positions of the vertices.

Video encoder 1213 encodes the attribute map converted by color converter 1212 into a bitstream (also referred to as an attribute bitstream) (in other words, generates the attribute bitstream). Video encoder 1213 provides the attribute bitstream to multiplexer 1214.

Multiplexer 1214 acquires the base mesh bitstream from base mesh encoder 1203, acquires the displacement bitstream from video encoder 1211, acquires the attribute bitstream from video encoder 1213, and multiplexes these bitstreams to generate and output a compressed bitstream. Outputting the compressed bitstream by multiplexer 1214 can be equivalent to outputting of the bitstream by encoding device 100.

Note that the process of encoding the wavelet coefficients into the displacement bitstream, which is executed by image packer 1210 and video encoder 1211, may be performed through an arithmetic encoding process. In addition, encoding device 100 may be configured to be capable of selecting whether the process is to be executed through the process by image packer 1210 and video encoder 1211 (also referred to as a video encoding process) or executed through the arithmetic encoding process. An example of such a configuration will be described below.

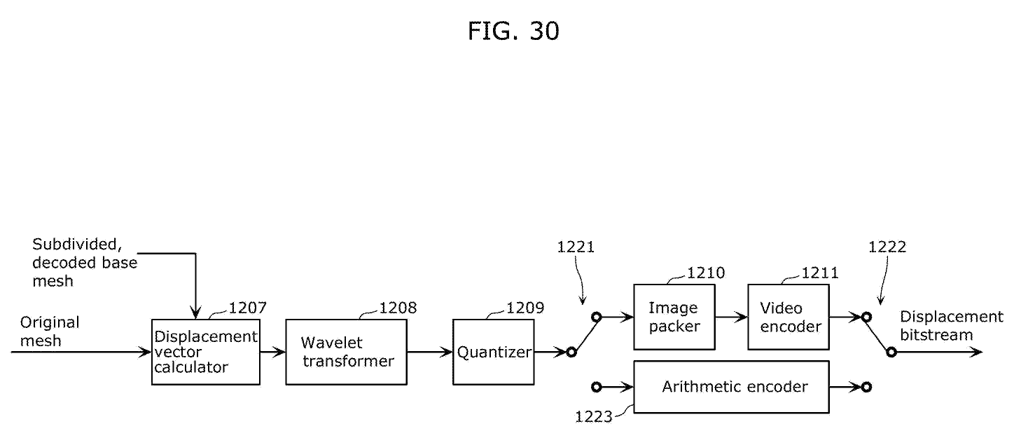

FIG. 30 is a block diagram illustrating a detailed configuration variation of encoding device 100. FIG. 30 illustrates a variation of the functional blocks enclosed by the dotted-line frame illustrated in FIG. 29.

Displacement vector calculator 1207, wavelet transformer 1208, quantizer 1209, image packer 1210, and video encoder 1211 illustrated in FIG. 30 are the same as those illustrated in FIG. 29.

As illustrated in FIG. 30, encoding device 100 further includes switcher 1221, switcher 1222, and arithmetic encoder 1223.

Switcher 1221 and switcher 1222 are switchers that switch whether image packer 1210 and video encoder 1211 or arithmetic encoder 1223 is to execute the process of encoding the wavelet coefficients into the displacement bitstream.

Switcher 1221 and switcher 1222 may dynamically switch a constituent component that is to execute the process to image packer 1210 and video encoder 1211 or arithmetic encoder 1223. Switcher 1221 and switcher 1222 may be configured to always (in other words, fixedly) use image packer 1210 and video encoder 1211 as the constituent component that is to execute the process or may be configured to always (in other words, fixedly) use arithmetic encoder 1223 as the constituent component.

Arithmetic encoder 1223 executes the process of encoding the wavelet coefficients into the displacement bitstream by means of arithmetic encoding.

Note that encoding device 100 may add, to header information, information indicating whether the process of encoding the wavelet coefficients into the displacement bitstream has been executed by image packer 1210 and video encoder 1211 (in other words, the process has been executed through the video encoding process) or by arithmetic encoder 1223 (in other words, the process has been executed through the arithmetic encoding process). This enables decoding device 200 receiving the bitstream encoded in the above manner to appropriately decode the bitstream by switching decoding methods of decoding the bitstream with reference to the header information.

Hereinafter, an encoding process performed by encoding device 100 will be described in detail.

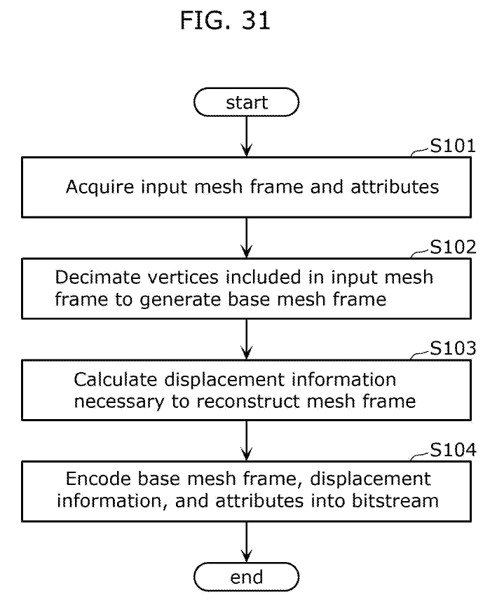

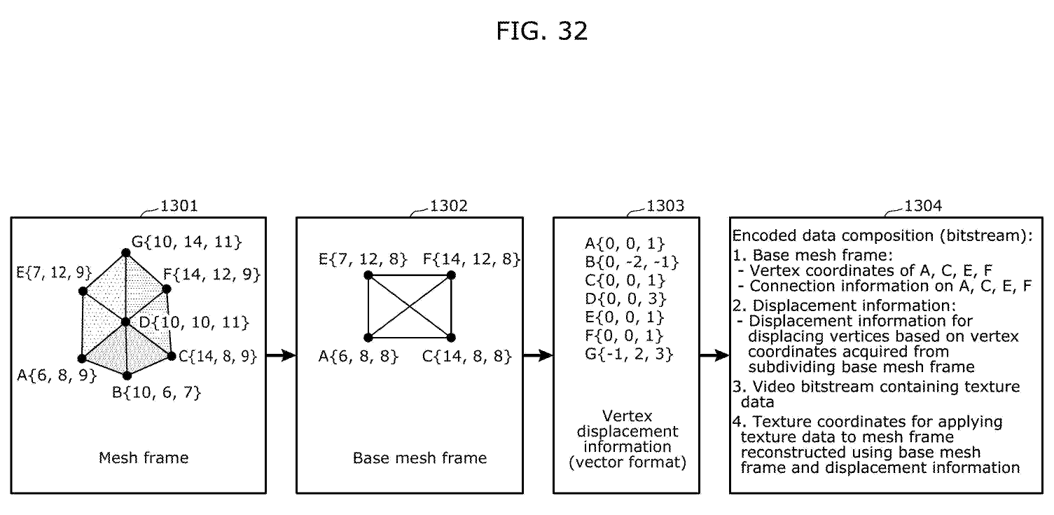

FIG. 31 is a flowchart illustrating the process by encoding device 100. FIG. 32 is an explanatory diagram schematically illustrating the encoding of a mesh frame. With reference to FIG. 31 and FIG. 32, the process by encoding device 100 will be described.

In step S101, encoding device 100 reads a 3D mesh frame, which is an input mesh frame, and its attributes. The input mesh frame is a mesh frame input into encoding device 100. An example of the 3D mesh frame being the input mesh frame is illustrated as mesh frame 1301 (see FIG. 32).

In step S102, encoding device 100 performs the decimating process on the input mesh frame that is read in step S101 to produce a base mesh frame, which has a smaller number of vertices than the input mesh frame. The base mesh frame produced by decimating mesh frame 1301 is illustrated as base mesh frame 1302 (see FIG. 32).

In step S103, encoding device 100 calculates displacement information to be used by decoding device 200 to reconstruct the mesh frame. The displacement information is equivalent to displacement vectors from the vertices of the base mesh frame produced in step S102 to the vertices of the input mesh frame. Methods of calculating the displacement information include a method in which the sets of coordinates of the vertices of the base mesh frame are subtracted from the coordinates of the vertices of the input mesh frame. The displacement information calculated from mesh frame 1301 and base mesh frame 1302 is illustrated as displacement information 1303 (see FIG. 32). Displacement information 1303 is in a vector format. In other words, displacement information 1303 is represented as displacement vectors.

In step S104, encoding device 100 encodes the base mesh frame produced in step S102, the displacement information generated in step S103, and the attributes of the input mesh frame into a bitstream (equivalent to a compressed bitstream). An example of the bitstream is illustrated as bitstream 1304 (see FIG. 32).

Specifically, bitstream 1304 includes sets of vertex coordinates of and connection information on vertices A, C, E, and F, the displacement information, a video bitstream including texture data, and a compressed attribute map (see FIG. 32). The displacement information includes displacement information for displacing vertices based on the vertex coordinates acquired from the base mesh frame that has been subdivided. The compressed attribute map includes texture coordinates used to apply the texture data to the mesh frame that is reconstructed using the base mesh frame and the displacement information.

Hereinafter, details of the configuration of decoding device 200 will be described.

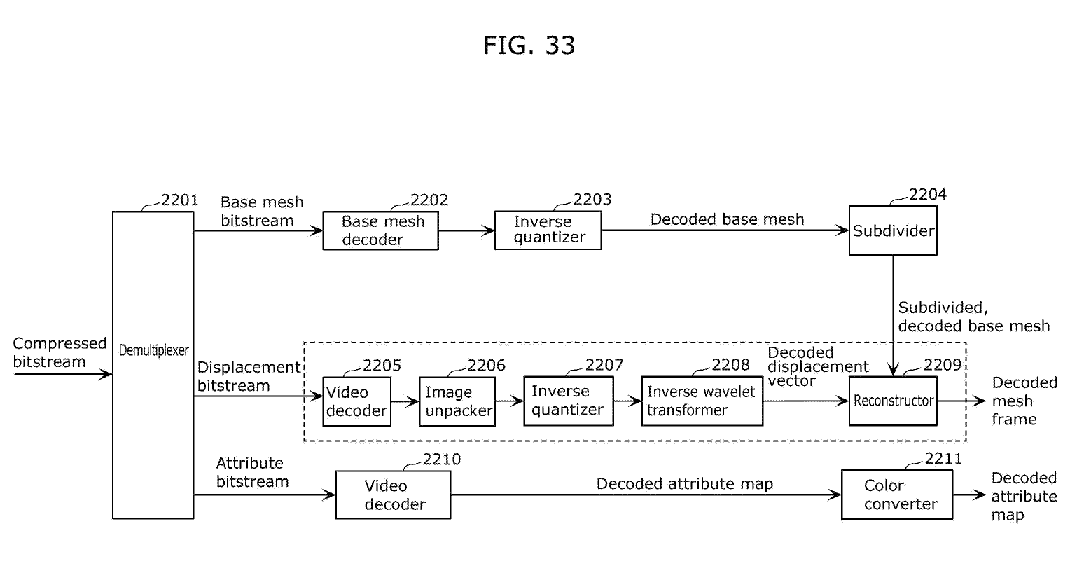

FIG. 33 is a block diagram illustrating a detailed configuration example of decoding device 200.

As illustrated in FIG. 33, decoding device 200 includes demultiplexer 2201, base mesh decoder 2202, inverse quantizer 2203, subdivider 2204, video decoder 2205, image unpacker 2206, inverse quantizer 2207, inverse wavelet transformer 2208, reconstructor 2209, video decoder 2210, and color converter 2211.

Demultiplexer 2201 acquires a compressed bitstream input into decoding device 200 and separates a base mesh bitstream, a displacement bitstream, and an attribute bitstream from the compressed bitstream. Demultiplexer 2201 provides the base mesh bitstream to base mesh decoder 2202, provides the displacement bitstream to video decoder 2205, and provides the attribute bitstream to video decoder 2210. The compressed bitstream input into decoding device 200 can be, for example, a compressed bitstream output by encoding device 100. The description will be made on this case as an example.

Base mesh decoder 2202 decodes the base mesh bitstream provided from demultiplexer 2201 to acquire a quantized base mesh. Base mesh decoder 2202 provides the quantized base mesh to inverse quantizer 2203.

Inverse quantizer 2203 inverse quantizes the quantized base mesh provided from base mesh decoder 2202 to produce the base mesh (also referred to as a decoded base mesh). Inverse quantizer 2203 provides the decoded base mesh to subdivider 2204.

Subdivider 2204 performs the subdivision process on the decoded base mesh produced by inverse quantizer 2203. The subdivision process is the same as the subdivision process executed by subdivider 1206. Subdivider 2204 provides the subdivided, decoded base mesh to reconstructor 2209.

Video decoder 2205 decodes displacement bitstream provided from demultiplexer 2201 into an image. The image can be an image in which quantized wavelet coefficients are contained by the mapping of the quantized wavelet coefficients onto pixels in a two-dimensional image format. Video decoder 2205 provides the image to image unpacker 2206.

Image unpacker 2206 takes out the quantized wavelet coefficients from the image provided from video decoder 2205. In the process of taking out the quantized wavelet coefficients from the image, a mapping that represents the assignment of the quantized wavelet coefficients to the pixels in the two-dimensional image format can be used. Image unpacker 2206 provides the quantized wavelet coefficients taken out from the image to inverse quantizer 2207.

Inverse quantizer 2207 inverse quantizes the quantized wavelet coefficients provided from image unpacker 2206 to generate wavelet coefficients.

Inverse wavelet transformer 2208 performs an inverse wavelet transforming process on the wavelet coefficients provided from inverse quantizer 2207 to generate displacement vectors (equivalent to decoded displacement vectors). The inverse wavelet transforming process is equivalent to the inverse transform of the wavelet transforming process performed by wavelet transformer 1208. Inverse wavelet transformer 2208 provides the generated decoded displacement vectors to reconstructor 2209.

Reconstructor 2209 reconstructs a mesh (equivalent to a decoded mesh frame) using the subdivided, decoded base mesh provided from subdivider 2204 and the decoded displacement vectors provided from inverse wavelet transformer 2208. Reconstructor 2209 outputs the reconstructed, decoded mesh as output mesh 2107.

Video decoder 2210 decodes the attribute bitstream provided from demultiplexer 2201 into an attribute map (equivalent to a decoded attribute map). Video decoder 2210 provides the decoded attribute map to color converter 2211.

Color converter 2211 performs a color converting process on the decoded attribute map provided from video decoder 2210. The color converting process is equivalent to the inverse conversion of the color converting process executed by color converter 1212 and can include a process of converting a representation form of color or a color space. Color converter 2211 outputs the decoded attribute map subjected to the color converting process.

Note that the process of decoding the displacement bitstream into the wavelet coefficients, which is executed by video decoder 2205 and image unpacker 2206, may be performed through an arithmetic encoding process. In addition, decoding device 200 may be configured to be capable of selecting whether the process is to be executed through the process by video decoder 2205 and image unpacker 2206 (also referred to as a video decoding process) or executed through the arithmetic encoding process. An example of such a configuration will be described below.

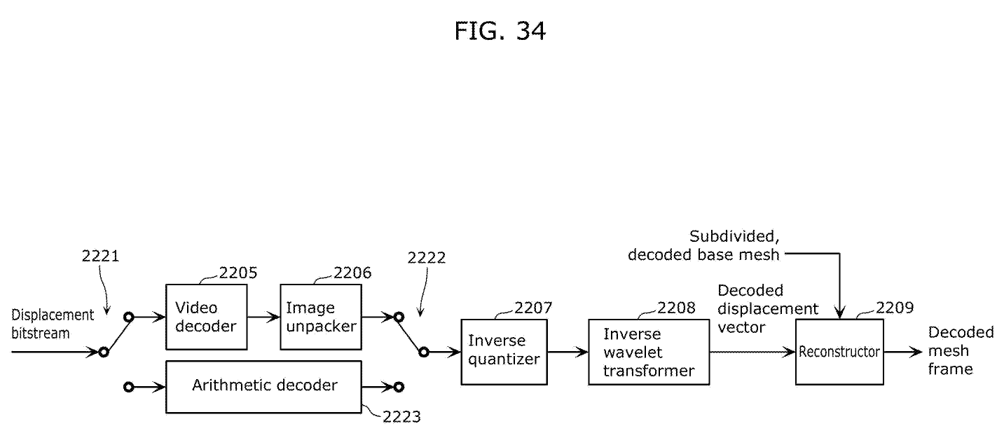

FIG. 34 is a block diagram illustrating a detailed configuration variation of decoding device 200. FIG. 34 illustrates a variation of the functional blocks enclosed by the dotted-line frame illustrated in FIG. 33.

Video decoder 2205, image unpacker 2206, inverse quantizer 2207, inverse wavelet transformer 2208, and reconstructor 2209 illustrated in FIG. 34 are the same as those illustrated in FIG. 33.

As illustrated in FIG. 34, decoding device 200 further includes switcher 2221, switcher 2222, and arithmetic decoder 2223.

Switcher 2221 and switcher 2222 are switchers that switch whether video decoder 2205 and image unpacker 2206 or arithmetic decoder 2223 is to execute the process of decoding the displacement bitstream into the wavelet coefficients.

Switcher 2221 and switcher 2222 may dynamically switch a constituent component that is to execute the process to video decoder 2205 and image unpacker 2206 or arithmetic decoder 2223. Switcher 2221 and switcher 2222 may be configured to always (in other words, fixedly) use video decoder 2205 and image unpacker 2206 as the constituent component that is to execute the process or may be configured to always (in other words, fixedly) use arithmetic decoder 2223 as the constituent component.

Arithmetic decoder 2223 executes the process of decoding the displacement bitstream into the wavelet coefficients by means of arithmetic decoding.

Note that information indicating whether video decoder 2205 and image unpacker 2206 or arithmetic decoder 2223 has executed the process of decoding the displacement bitstream into the wavelet coefficients (in other words, whether the process has been executed through the video decoding process or the arithmetic decoding process) may have been added to header information. In this case, decoding device 200 can appropriately decode the bitstream by switching the decoding methods of decoding the bitstream with reference to the header information.

Hereinafter, a decoding process performed by decoding device 200 will be described in detail.

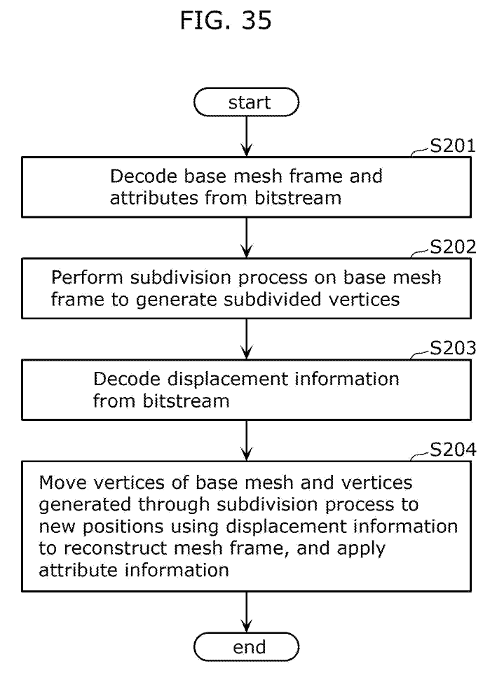

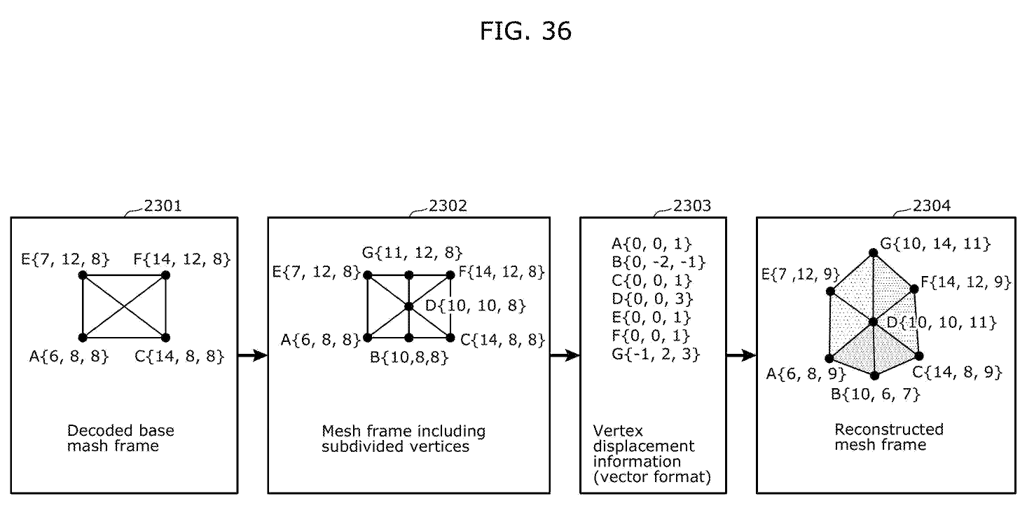

FIG. 35 is a flowchart illustrating the process by decoding device 200. FIG. 36 is an explanatory diagram schematically illustrating the decoding of a mesh frame (3D mesh). With reference to FIG. 35 and FIG. 36, the process by decoding device 200 will be described.

In step S201, decoding device 200 decodes a base mesh frame and attributes from a bitstream (equivalent to a compressed bitstream). An example of the decoded base mesh frame (equivalent to a decoded base mesh frame) is illustrated as decoded base mesh frame 2301 (see FIG. 36).

In step S202, decoding device 200 performs the subdivision process on the base mesh frame decoded in step S201 to produce subdivided vertices. An example of the base mesh frame (mesh frame) including the subdivided vertices is illustrated as base mesh frame 2302 (see FIG. 36).

In step S203, decoding device 200 decodes displacement information from the bitstream (equivalent to the compressed bitstream). An example of the decoded displacement information is illustrated as displacement information 2303 (see FIG. 36). Displacement information 2303 is in a vector format. In other words, displacement information 2303 is represented as displacement vectors.

In step S204, using the displacement information, decoding device 200 moves the vertices of the base mesh frame including the subdivided vertices to new positions to reconstruct the shape of the mesh frame and further applies attribute information to restore the mesh frame. An example of the attributes is texture. An example of the reconstructed mesh frame is illustrated as mesh frame 2304 (see FIG. 36).

Hereinafter, the subdivision will be described. The subdivision is executed by a subdivider (specifically, subdivider 1206 or subdivider 2204).

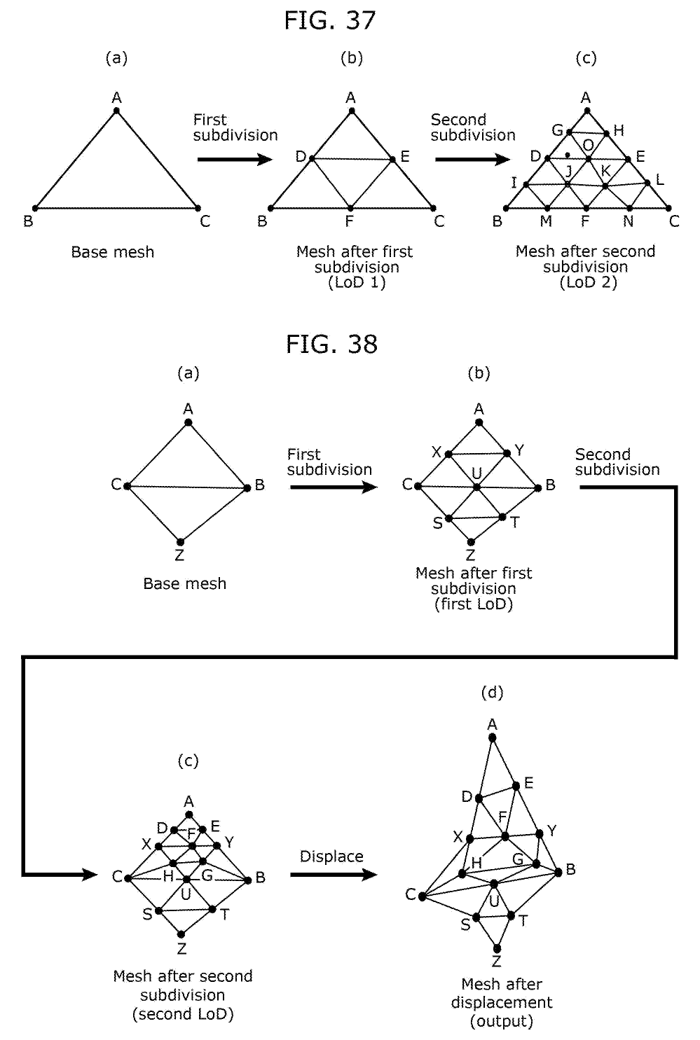

FIG. 37 is an explanatory diagram illustrating an example of the subdivision.

A base mesh illustrated in (a) in FIG. 37 includes vertices A, B, and C and connection information indicating their connectivity.

In (b) in FIG. 37, a mesh produced by the first subdivision, in other words, a mesh after the first subdivision is illustrated. In the first subdivision, the subdivider generates vertices D, E, and F and connection information indicating their connectivity. This mesh produced by the subdivider will also be referred to as LoD1 or a first LoD.

Vertex D in the mesh after the first subdivision is a vertex that is generated by subdivision based on vertex A and vertex B. Likewise, vertex F is a vertex that is generated by subdivision based on vertex B and vertex C. Vertex E is a vertex that is generated by subdivision based on vertex A and vertex C.

Note that, as an example, vertex D can be the midpoint of segment AB (in other words, edge AB) connecting vertices A and B, which are used to generate vertex D. Likewise, vertex E can be the midpoint of segment AC. Vertex F can be the midpoint of segment BC.

In (c) in FIG. 37, a mesh produced by the second subdivision, in other words, a mesh after the second subdivision is illustrated. In the second subdivision, the subdivider generates vertices G, H, I, J, K, L, M, N, and O and connection information indicating their connectivity. This mesh produced by the subdivider will also be referred to as LoD2 or a second LoD.

Vertex G in the mesh after the second subdivision is a vertex that is generated by subdivision based on vertex A and vertex D. Likewise, vertex H is a vertex that is generated by subdivision based on vertex A and vertex E. Vertex I is a vertex that is generated by subdivision based on vertex B and vertex D. Vertex J is a vertex that is generated by subdivision based on vertex D and vertex F. Vertex K is a vertex that is generated by subdivision based on vertex E and vertex F. Vertex L is a vertex that is generated by subdivision based on vertex C and vertex E. Vertex M is a vertex that is generated by subdivision based on vertex B and vertex F. Vertex N is a vertex that is generated by subdivision based on vertex C and vertex F. Vertex O is a vertex that is generated by subdivision based on vertex D and vertex E.

Note that, as an example, vertex G can be the midpoint of segment AD (in other words, edge AD) connecting vertices A and D, which are used to generate vertex G. Likewise, vertex H can be the midpoint of segment AE. Vertex I can be the midpoint of segment BD. Vertex J can be the midpoint of segment DF. Vertex K can be the midpoint of segment EF. Vertex L can be the midpoint of segment CE. Vertex M can be the midpoint of segment BF. Vertex N can be the midpoint of segment CF. Vertex O can be the midpoint of segment DE.

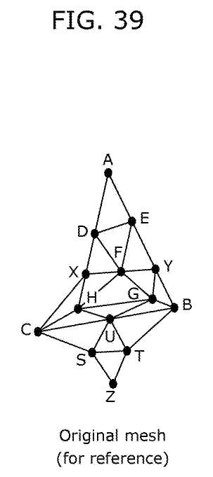

Hereinafter, the displacement of vertices will be described with reference to FIG. 38 and FIG. 39. The displacement of vertices is executed by reconstructor 2209.

FIG. 38 is an explanatory diagram illustrating an example of the displacement of vertices in which the vertices are subdivided and then displaced. FIG. 39 is an explanatory diagram illustrating an example of the vertices of the original mesh.

A base mesh illustrated in (a) in FIG. 38 includes vertices A, B, C, and Z and connection information indicating their connectivity.

In (b) in FIG. 38, a mesh produced by the first subdivision, in other words, a mesh after the first subdivision (i.e., a first LoD) is illustrated. In the first subdivision, the subdivider generates vertex S, T, U, X, or Y and connection information indicating their connectivity. Vertex S, T, U, X, or Y is similar to vertices D, E, and F illustrated in (b) in FIG. 37.

In (c) in FIG. 38, a mesh produced by the second subdivision, in other words, a mesh after the second subdivision (i.e., a second LoD) is illustrated. In the second subdivision, the subdivider generates vertices D, E, F, G, and H and connection information indicating their connectivity. Vertices D, E, F, G, and H are similar to vertices G, H, I, J, K, L, M, N, or O illustrated in (c) in FIG. 37.

In (d) in FIG. 38, a mesh including vertices that are subdivided and then displaced is illustrated. Vertices A, B, C, D, E, F, G, H, S, T, U, X, Y, and Z illustrated in (d) in FIG. 38 are at positions that are displaced from positions of the respective vertices illustrated in (c) in FIG. 38 using the displacement information.

The original mesh illustrated in FIG. 39 is an example of the mesh input into encoding device 100, that is, a mesh before encoding.

The mesh illustrated in FIG. 38 has a shape similar to that of the original mesh illustrated in FIG. 39. Since the displacement information is generated by displacement vector calculator 1207 of encoding device 100 as information indicating the displacement from the vertices of the base mesh to the vertices of the original mesh, the mesh having the shape similar to that of the original mesh is generated by the reconstruction of the mesh using the displacement information that has been generated in such a manner.

Decoding device 200 is capable of outputting the mesh illustrated in (d) in FIG. 38.

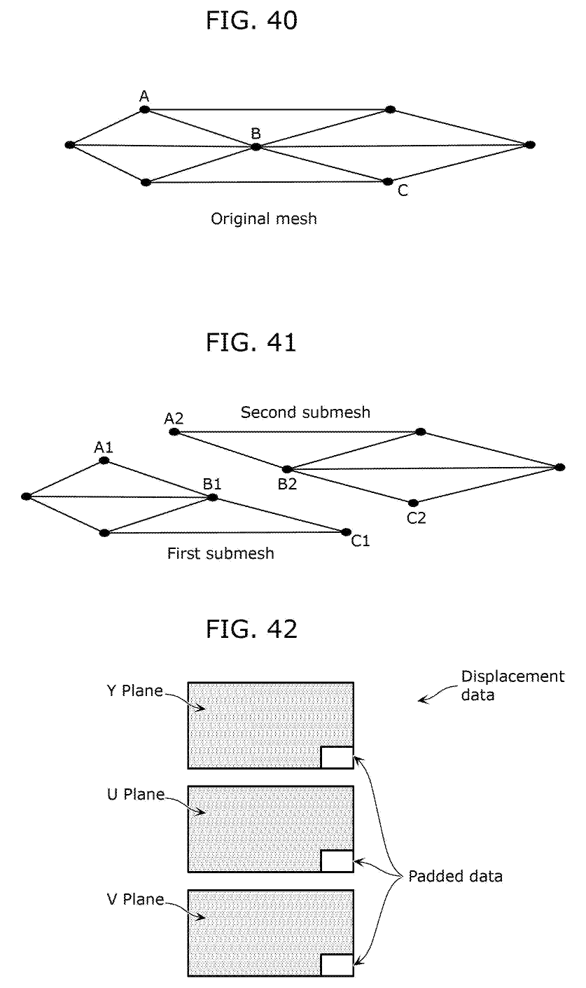

Next, the division of a mesh into submeshes will be described with reference to FIG. 40 and FIG. 41.

The mesh can be divided into a plurality of portions each of which is smaller than the mesh and can be encoded. When the mesh is divided, the vertices of the mesh can be divided such that sets of coordinates and connectivity of the vertices included in each portion are independently encodable.

FIG. 40 is an explanatory diagram illustrating an example of a mesh. FIG. 41 is an explanatory diagram illustrating an example of the division of a mesh into submeshes.

The mesh illustrated in FIG. 40 is an original mesh and may also be referred to as a full mesh, in contrast to a submesh.

FIG. 41 illustrates how the full mesh illustrated in FIG. 40 is divided into two submeshes. For vertices A, B, and C of the full mesh (see FIG. 40), vertex A is duplicated into vertex A1 and vertex A2, vertex B is duplicated into vertex B1 and vertex B2, and vertex C is duplicated into vertex C1 and vertex C2. Thus, the two submeshes (i.e., a first submesh and a second submesh) are created from the full mesh. The first submesh and the second submesh are meshes that are independently decodable.

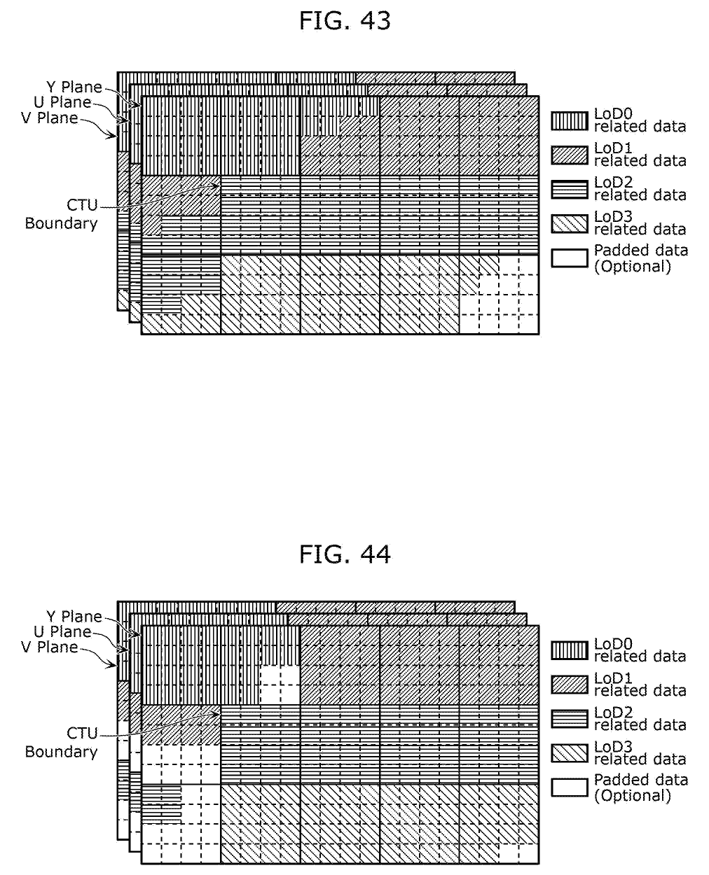

Hereinafter, the packing of displacement information into an image frame will be described with reference to FIG. 42, FIG. 43, and FIG. 44.

FIG. 42, FIG. 43, and FIG. 44 are explanatory diagrams illustrating examples of packing the displacement information into an image frame. Note that the image frame can be rephrased as a video frame.

Items of displacement data on vertices are mapped into, for example, components of an image frame in a YUV format (i.e., into Y components (Y Plane), U components (U Plane), and V components (V Plane)), thus being encoded as image frame data. This case will be described below as an example. Note that, as another example, the items of displacement data on vertices may be mapped into components of an image frame in an RGB format (R components, G components, and B components), thus being encoded as the image frame data.

Decoding device 200 can use an image encoding module to extract the items of displacement data. Each of the items of displacement data may be in the form of an X component, a Y component, or a Z component in a global coordinate system (e.g., a Cartesian coordinate system) or a normal, a tangent, or a bi-tangent component in a local coordinate system. Methods of mapping the displacement data into the image frame include the following methods.

For example, in a first method, the items of displacement data are arranged in a traversing order in the image frame. An example of the packing of the items of displacement data in this case is illustrated in FIG. 42. The items of displacement data are directly mapped onto the image frame according to a predefined traversing order.

Note that the image frame has a fixed height and width, and thus there are cases where the items of displacement data do not fit exactly in the frame. In such a case, the remaining part of the image frame is padded with data for padding (also referred to as Padded data) (see FIG. 42).

For example, in a second method, the items of displacement data are separated into a plurality of LoDs and mapped into the Y components, U components, and V components of the image frame. An example of the packing of the items of displacement data in this case is illustrated in FIG. 43. Here, the items of displacement data in the image frame for the next LoD start immediately after the items of displacement data for the previous LoD end. As in the first method, in the case where the items of displacement data do not exactly fit in the image frame, the image frame is padded at its end portion (see FIG. 43).

For example, in a third method, the items of displacement data corresponding to the LoDs are mapped onto the Y components, U components, and V components of the image frame in a manner different from the second method. An example of the packing of the items of displacement data in this case is illustrated in FIG. 44. In this manner, each LoD can be independently decoded. In the third method, interim padding is performed for each LoD's displacement data to provide CTU alignment together with the padding at the end of the video frame (see FIG. 44).

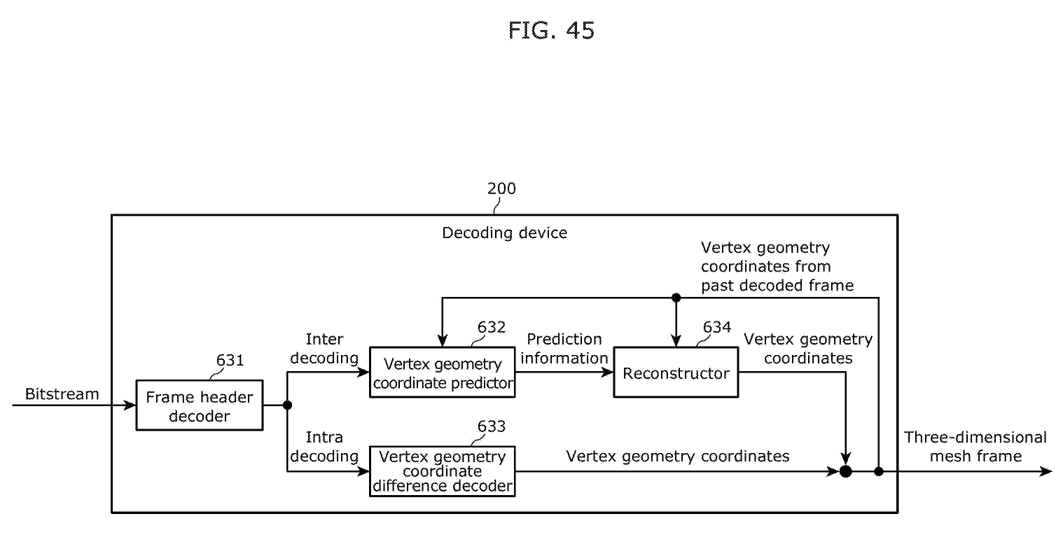

FIG. 45 is a block diagram illustrating a detailed configuration example of decoding device 200 according to the present embodiment. Specifically, FIG. 45 illustrates an example of the configuration of a geometry coordinate decoder included in decoding device 200.

In this example, decoding device 200 includes frame header decoder 631, vertex geometry coordinate predictor 632, vertex geometry coordinate difference decoder 633, and reconstructor 634.

Frame header decoder 631 reads a bitstream, decodes a frame header in the bitstream, and determines whether to intra-decode (intra-predict) or inter-decode (inter-predict) frame data.

When the inter-decoding is selected, the frame data included in the bitstream is output to vertex geometry coordinate predictor 632.

Vertex geometry coordinate predictor 632 outputs prediction information to reconstructor 634. One example of the prediction information is motion vectors.

Reconstructor 634 outputs three-dimensional coordinates of a vertex (vertex geometry coordinates) using vertex coordinates from a frame decoded in the past and the prediction information.

On the other hand, when the intra-decoding is selected, the frame data included in the bitstream is output to vertex geometry coordinate difference decoder 633.

In order to produce vertex coordinates, vertex geometry coordinate difference decoder 633 decodes the frame data encoded as a difference between coordinates of vertices included in the frame. Only one of the vertex geometry coordinates from vertex geometry coordinate difference decoder 633 and the vertex geometry coordinates from reconstructor 634 is used for producing the decoded three-dimensional mesh frame.

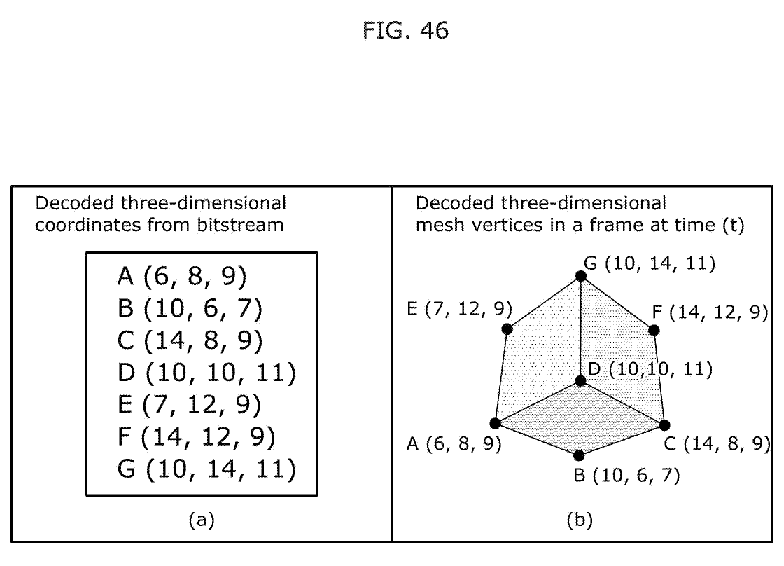

FIG. 46 is a diagram for describing coordinates of vertices in a three-dimensional mesh according to the present embodiment. Specifically, FIG. 46 illustrates an example in which the whole of a three-dimensional mesh frame is decoded using coordinates (positions) of actual vertices included in the bitstream.

The coordinates of vertex A included in the three-dimensional mesh frame at a time (t) are decoded to be (6, 8, 9) in the Cartesian coordinate system (x, y, z) as illustrated in (a) in FIG. 46. Similarly, the coordinates of vertex B are decoded to be (10, 6, 7), and the coordinates of vertex C are decoded to be (14, 8, 9). Vertices D to G are also decoded in the same manner.

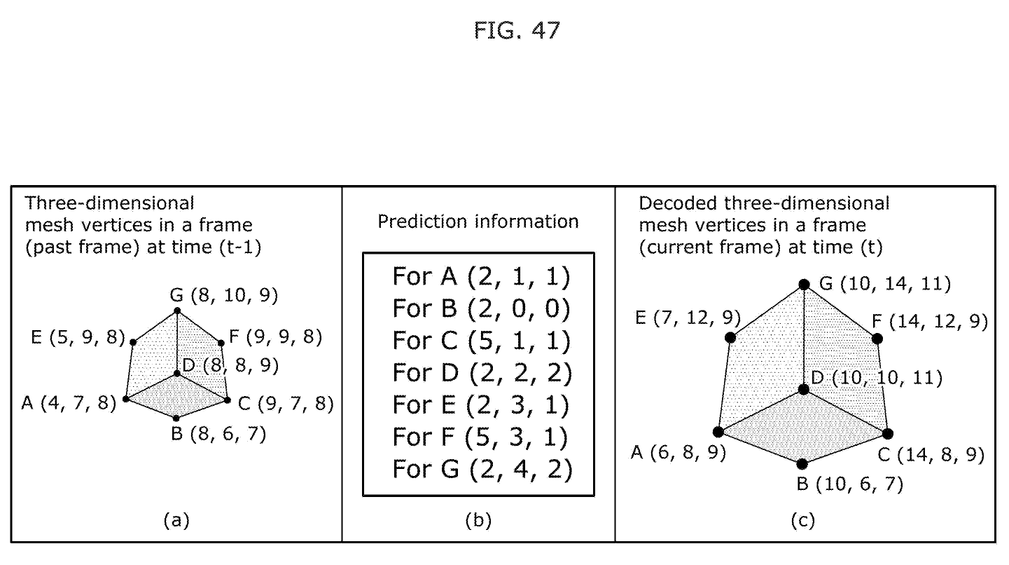

FIG. 47 is a diagram for describing prediction information according to the present embodiment. Specifically, FIG. 47 illustrates another example in which the whole of a three-dimensional mesh frame at a time (t) is decoded using a frame at a time (t-1) (past frame) and prediction information included in the bitstream.

Coordinates (6, 8, 9) of vertex A in the frame to be decoded (present frame) are decoded by summing coordinates (4, 7, 8) of vertex A in the past frame and values (2, 1, 1) relating to vertex A indicated by the prediction information. Similarly, coordinates (10, 6, 7) of vertex B in the present frame are decoded by summing coordinates (8, 6, 7) of vertex B in the past frame and values (2, 0, 0) relating to vertex B indicated by the prediction information.

As one method of encoding a three-dimensional mesh frame, it can be contemplated to divide an original three-dimensional mesh (original mesh) into smaller meshes (submeshes) and encode each submesh independently. The vertices in the three-dimensional mesh frame are divided such that information indicating coordinates of vertices in each partition and connection information on the vertices can be independently encoded. Each smaller mesh resulting from the division is referred to as a submesh.

Next, encoding and decoding using CABAC are described. Note that the three-dimensional data encoding device described below is one specific example of encoding device 100, and the three-dimensional data decoding device described below is one specific example of decoding device 200.

In order to divide point cloud data into tiles and slices and efficiently encode or decode the divisional data, an appropriate control is needed on the encoder side and the decoder side. By making the encoding and decoding of each piece of divisional data independent, rather than dependent, from the other pieces of divisional data, a multi-thread or multi-core processor can be used to process the pieces of divisional data in the respective threads/cores in parallel, and the performance is improved.

There are various methods of dividing point cloud data into tiles and slices. For example, there is a method of dividing point cloud data based on an attribute of an object, such as a road surface, of point cloud data or a characteristic, such as color information such as green, of point cloud data.

CABAC is an abbreviation of context-based adaptive binary arithmetic coding, which is an encoding method that realizes an arithmetic encoding (entropy encoding) with high compression ratio by increasing the probability precision by successively updating a context (a model for estimating the probability of occurrence of an input binary symbol) based on the encoded information.

In order to process pieces of divisional data such as tiles or slices in parallel, each piece of divisional data needs to be independently encoded or decoded. In order to make CABAC for the pieces of divisional data independent from each other, CABAC needs to be initialized at the top of each piece of divisional data. However, there is no mechanism therefor.

A CABAC initialization flag is used to initialize CABAC in CABAC encoding and decoding.

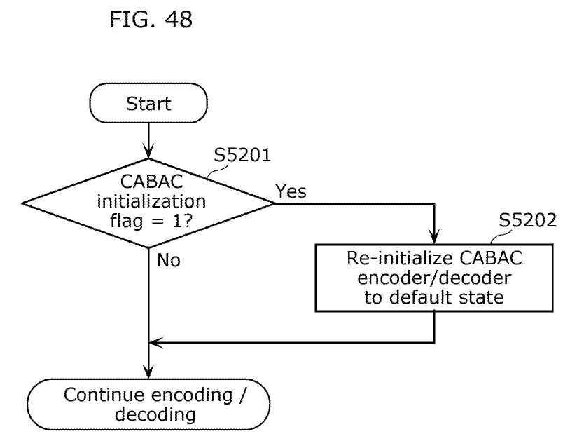

FIG. 48 is a flowchart of a process of initializing CABAC in response to a CABAC initialization flag.

The three-dimensional data encoding device or three-dimensional data decoding device determines whether the CABAC initialization flag is 1 or not in encoding or decoding (S5201).

When the CABAC initialization flag is 1 (if Yes in S5201), the three-dimensional data encoding device or three-dimensional data decoding device initializes a CABAC encoder/decoder to a default state (S5202), and continues the encoding or decoding.

When the CABAC initialization flag is not 1 (if No in S5201), the three-dimensional data encoding device or three-dimensional data decoding device does not perform the initialization, and continues the encoding or decoding.

That is, when initializing CABAC, cabac_init_flag is set to 1, and the CABAC encoder or CABAC decoder is initialized or re-initialized. When initializing CABAC, an initial value (default state) of a context used for the CABAC process is set.

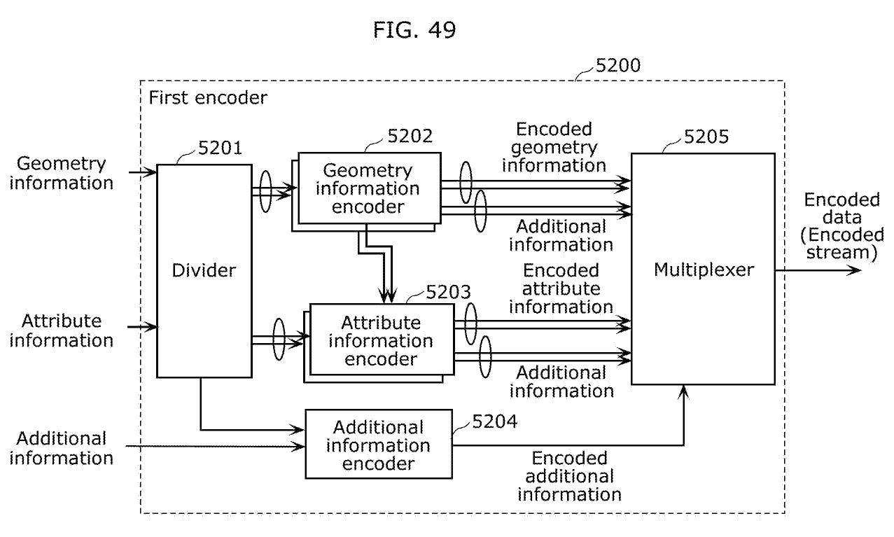

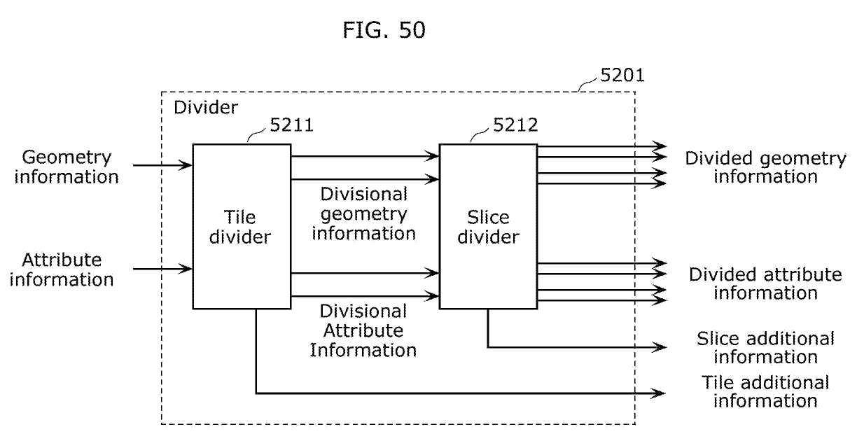

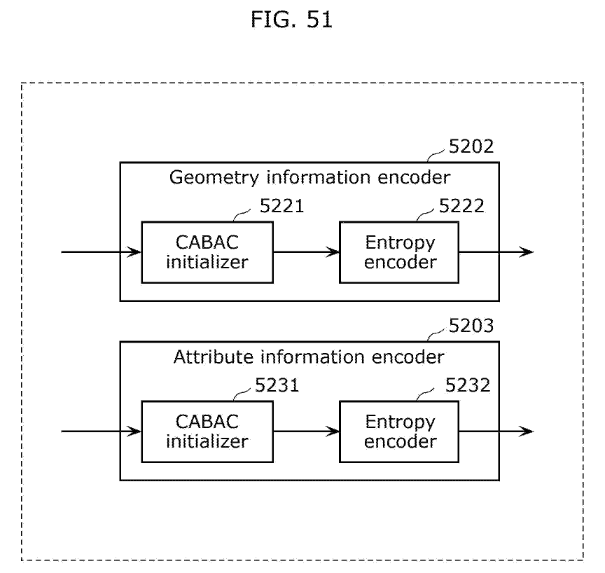

An encoding process will be described. FIG. 49 is a block diagram illustrating a configuration of first encoder 5200 included in the three-dimensional data encoding device according to this embodiment. FIG. 50 is a block diagram illustrating a configuration of divider 5201 according to this embodiment. FIG. 51 is a block diagram illustrating a configuration of geometry information encoder 5202 and attribute information encoder 5203 according to this embodiment.

First encoder 5200 generates encoded data (encoded stream) by encoding point cloud data in a first encoding method (geometry-based PCC (GPCC)). First encoder 5200 includes divider 5201, a plurality of geometry information encoders 5202, a plurality of attribute information encoders 5203, additional information encoder 5204, and multiplexer 5205.

Divider 5201 generates a plurality of pieces of divisional data by dividing point cloud data. Specifically, divider 5201 generates a plurality of pieces of divisional data by dividing a space of point cloud data into a plurality of subspaces. Here, a subspace is a combination of tiles or slices or a combination of tiles and slices. More specifically, point cloud data includes geometry information, attribute information, and additional information. Divider 5201 divides geometry information into a plurality of pieces of divisional geometry information, and divides attribute information into a plurality of pieces of divisional attribute information. Divider 5201 also generates additional information concerning the division.

As illustrated in FIG. 50, divider 5201 includes tile divider 5211 and slice divider 5212. For example, tile divider 5211 divides a point cloud into tiles. Tile divider 5211 may determine a quantization value used for each divisional tile as tile additional information.

Slice divider 5212 further divides a tile obtained by tile divider 5211 into slices. Slice divider 5212 may determine a quantization value used for each divisional slice as slice additional information.

The plurality of geometry information encoders 5202 generate a plurality of pieces of encoded geometry information by encoding a plurality of pieces of divisional geometry information. For example, the plurality of geometry information encoders 5202 processes a plurality of pieces of divisional geometry information in parallel.

As illustrated in FIG. 51, geometry information encoder 5202 includes CABAC initializer 5221 and entropy encoder 5222. CABAC initializer 5221 initializes or re-initializes CABAC in response to a CABAC initialization flag. Entropy encoder 5222 encodes divisional geometry information according to CABAC.

The plurality of attribute information encoders 5203 generate a plurality of pieces of encoded attribute information by encoding a plurality of pieces of divisional attribute information. For example, the plurality of attribute information encoders 5203 process a plurality of pieces of divisional attribute information in parallel.

As illustrated in FIG. 51, attribute information encoder 5203 includes CABAC initializer 5231 and entropy encoder 5232. CABAC initializer 5231 initializes or re-initializes CABAC in response to a CABAC initialization flag. Entropy encoder 5232 encodes divisional attribute information according to CABAC.

Additional information encoder 5204 generates encoded additional information by encoding additional information included in the point cloud data and additional information concerning the data division generated in the division by divider 5201.

Multiplexer 5205 generates encoded data (encoded stream) by multiplexing a plurality of pieces of encoded geometry information, a plurality of pieces of encoded attribute information, and encoded additional information, and transmits the generated encoded data. The encoded additional information is used for decoding.

Note that, although FIG. 49 shows an example in which there are two geometry information encoders 5202 and two attribute information encoders 5203, the number of geometry information encoders 5202 and the number of attribute information encoders 5203 may be one, or three or more. The plurality of pieces of divisional data may be processed in parallel in the same chip, such as by a plurality of cores of a CPU, processed in parallel by cores of a plurality of chips, or processed in parallel by a plurality of cores of a plurality of chips.

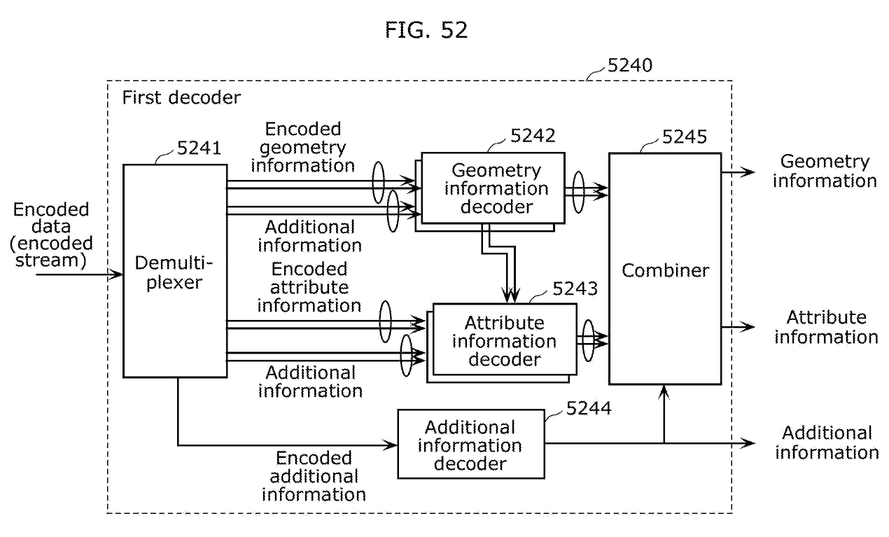

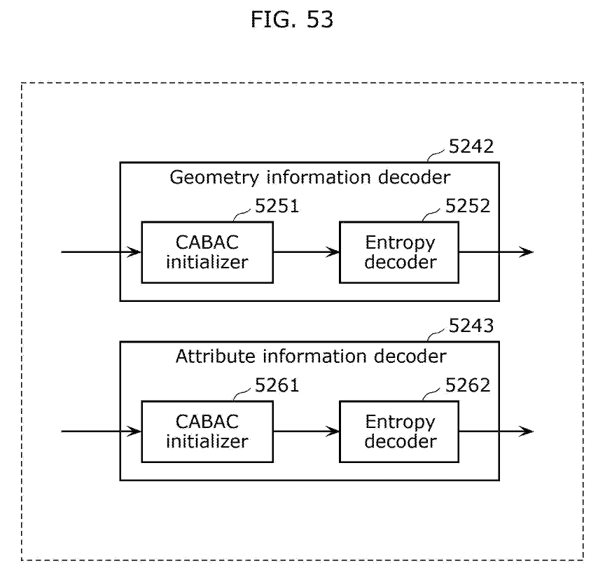

Next, a decoding process will be described. FIG. 52 is a block diagram illustrating a configuration of first decoder 5240. FIG. 53 is a block diagram illustrating a configuration of geometry information decoder 5242 and attribute information decoder 5243.

First decoder 5240 reproduces point cloud data by decoding encoded data (encoded stream) generated by encoding the point cloud data in the first encoding method (GPCC). First decoder 5240 includes demultiplexer 5241, a plurality of geometry information decoders 5242, a plurality of attribute information decoders 5243, additional information decoder 5244, and combiner 5245.

Demultiplexer 5241 generates a plurality of pieces of encoded geometry information, a plurality of pieces of encoded attribute information, and encoded additional information by demultiplexing encoded data (encoded stream).

The plurality of geometry information decoders 5242 generates a plurality of pieces of quantized geometry information by decoding a plurality of pieces of encoded geometry information. For example, the plurality of geometry information decoders 5242 process a plurality of pieces of encoded geometry information in parallel.

As illustrated in FIG. 53, geometry information decoder 5242 includes CABAC initializer 5251 and entropy decoder 5252. CABAC initializer 5251 initializes or re-initializes CABAC in response to a CABAC initialization flag. Entropy decoder 5252 decodes geometry information according to CABAC.

The plurality of attribute information decoders 5243 generate a plurality of pieces of divisional attribute information by decoding a plurality of pieces of encoded attribute information. For example, the plurality of attribute information decoders 5243 process a plurality of pieces of encoded attribute information in parallel.

As illustrated in FIG. 53, attribute information decoder 5243 includes CABAC initializer 5261 and entropy decoder 5262. CABAC initializer 5261 initializes or re-initializes CABAC in response to a CABAC initialization flag. Entropy decoder 5262 decodes attribute information according to CABAC.

The plurality of additional information decoders 5244 generate additional information by decoding encoded additional information.

Combiner 5245 generates geometry information by combining a plurality of pieces of divisional geometry information using additional information. Combiner 5245 generates attribute information by combining a plurality of pieces of divisional attribute information using additional information. For example, combiner 5245 first generates point cloud data associated with a tile by combining decoded point cloud data associated with slices using slice additional information. Combiner 5245 then reproduces the original point cloud data by combining point cloud data associated with tiles using tile additional information.

Note that, although FIG. 52 shows an example in which there are two geometry information decoders 5242 and two attribute information decoders 5243, the number of geometry information decoders 5242 and the number of attribute information decoders 5243 may be one, or three or more. The plurality of pieces of divisional data may be processed in parallel in the same chip, such as by a plurality of cores of a CPU, processed in parallel by cores of a plurality of chips, or processed in parallel by a plurality of cores of a plurality of chips.

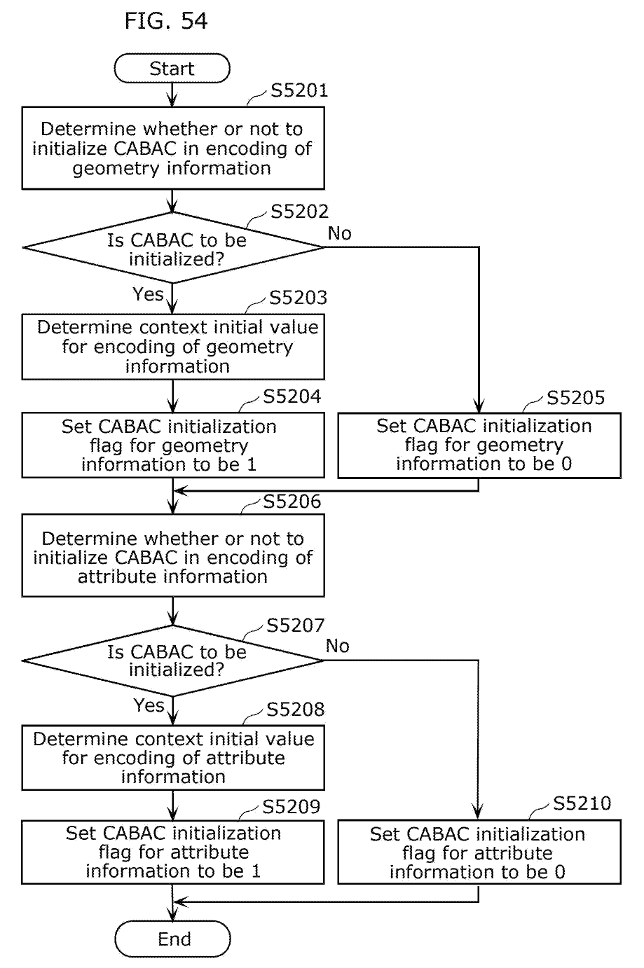

FIG. 54 is a flowchart illustrating an example of a process associated with the initialization of CABAC in the encoding of geometry information or the encoding of attribute information.

First, the three-dimensional data encoding device determines, for each slice, whether or not to initialize CABAC in the encoding of geometry information for the slice based on a predetermined condition (S5201).

When it is determined to initialize CABAC (if Yes in S5202), the three-dimensional data encoding device determines a context initial value used for the encoding of geometry information (S5203). The context initial value is set by considering encoding characteristics. The initial value may be a predetermined value or may be adaptively determined depending on the characteristics of data in the slice.

The three-dimensional data encoding device then sets the CABAC initialization flag for geometry information to be 1, and sets the context initial value (S5204). When initializing CABAC, the initialization process is performed using the context initial value in the encoding of geometry information.

On the other hand, when it is determined not to initialize CABAC (if No in S5202), the three-dimensional data encoding device sets the CABAC initialization flag for geometry information to be 0 (S5205).

The three-dimensional data encoding device then determines, for each slice, whether or not to initialize CABAC in the encoding of attribute information for the slice based on a predetermined condition (S5206).

When it is determined to initialize CABAC (if Yes in S5207), the three-dimensional data encoding device determines a context initial value used for the encoding of attribute information (S5208). The context initial value is set by considering encoding characteristics. The initial value may be a predetermined value or may be adaptively determined depending on the characteristics of data in the slice.

The three-dimensional data encoding device then sets the CABAC initialization flag for attribute information to be 1, and sets the context initial value (S5209). When initializing CABAC, the initialization process is performed using the context initial value in the encoding of attribute information.

On the other hand, when it is determined not to initialize CABAC (if No in S5207), the three-dimensional data encoding device sets the CABAC initialization flag for attribute information to be 0 (S5210).

Note that, in the flowchart of FIG. 54, the processing concerning geometry information and the processing concerning attribute information may be performed in reverse order or in parallel.

Note that, although the flowchart of FIG. 54 shows a slice-based process as an example, a tile-based process or a process on a basis of other data units can be performed in the same manner as the slice-based process. That is, slice in the flowchart of FIG. 54 can be replaced with tile or other data units.

The predetermined condition for the geometry information and the predetermined condition for the attribute information may be the same condition or different conditions.

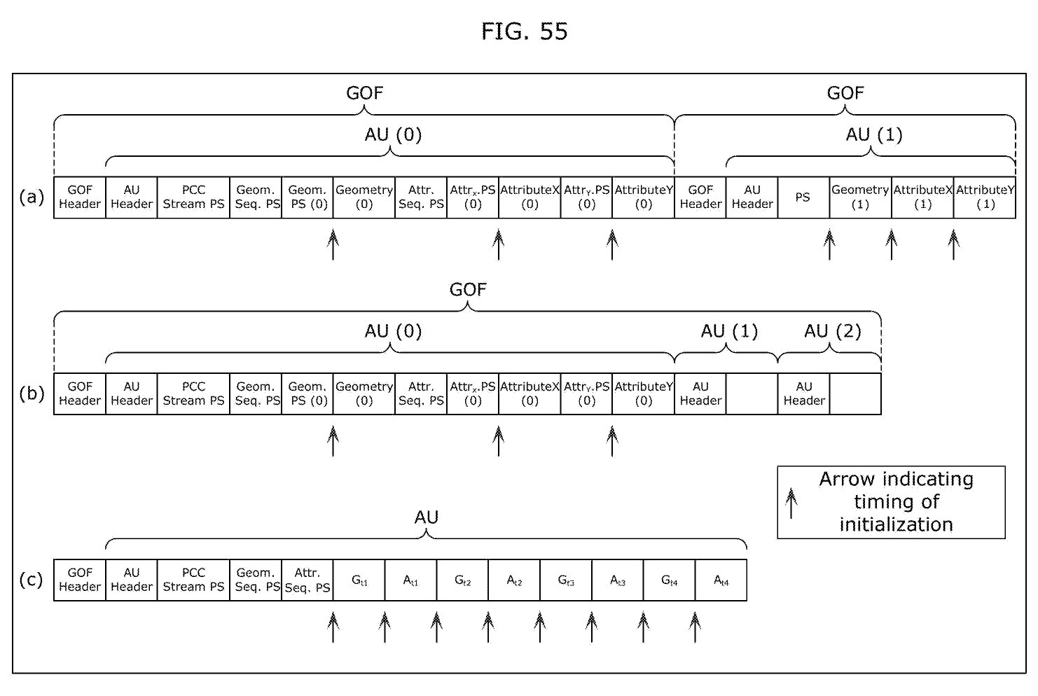

FIG. 55 is a diagram illustrating an example of timings of CABAC initialization for point cloud data in the form of a bitstream.

Point cloud data includes geometry information and zero or more pieces of attribute information. That is, point cloud data may include no attribute information or include a plurality of pieces of attribute information.

For example, as attribute information on a three-dimensional point, point cloud data may include color information, may include color information and reflection information, or may include one or more pieces of color information each linked to one or more pieces of point-of-view information.

In any configuration, the method described in this embodiment can be applied.

Next, a condition for determination of whether to initialize CABAC will be described.

It may be determined to initialize CABAC in the encoding of geometry information or attribute information when any of the conditions described below is satisfied.

For example, CABAC may be initialized at the leading data of geometry information or attribute information (each piece of attribute information if there is a plurality of pieces of attribute information). For example, CABAC may be initialized at the top of data forming a PCC frame that can be singly decoded. That is, as illustrated in part (a) of FIG. 55, if PCC frames may be decoded on a frame basis, CABAC can be initialized at the leading data of a PCC frame.

For example, as illustrated in part (b) of FIG. 55, if frames cannot be singly decoded, such as when an inter-prediction is used between PCC frames, CABAC may be initialized at the leading data of a random access unit (GOF, for example).

For example, as illustrated in part (c) of FIG. 55, CABAC may be initialized at the top of one or more pieces of divisional slice data, at the top of one or more pieces of divisional tile data, or at the top of other divisional data.

Although part (c) of FIG. 55 shows tiles as an example, this description holds true for slices. CABAC may be always initialized at the top of a tile or slice or may not be always initialized at the top of a tile or slice.

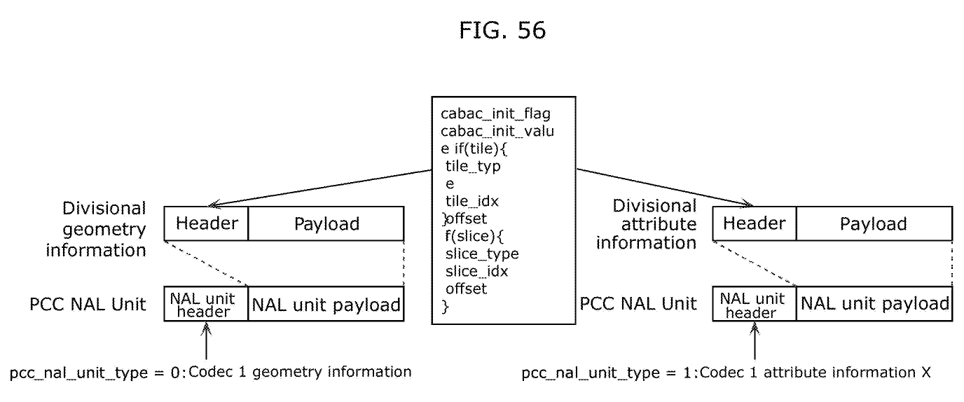

FIG. 56 is a diagram illustrating a configuration of encoded data and a method of storing the encoded data into a NAL unit.

Initialization information may be stored in a header of encoded data or in metadata. The initialization information may also be stored in both the header and the metadata. The initialization information is cabac_init_flag, a CABAC initial value, or an index of a table capable of identifying an initial value.

In this embodiment, "metadata" in a description that something is stored in metadata can be replaced with "header of encoded data" or vice versa.

When the initialization information is stored in the header of encoded data, the initialization information may be stored in the first NAL unit in the encoded data, for example. Initialization information on the encoding of geometry information is stored in geometry information, and initialization information on the encoding of attribute information is stored in attribute information.

cabac_init_flag for the encoding of attribute information and cabac_init_flag for the encoding of geometry information may be set to be the same value or different values. When the flags are set to be the same value, cabac_init_flag may be shared for geometry information and attribute information. When the flags are set to be different values, cabac_init_flag for geometry information and cabac_init_flag for attribute information indicate different values.

The initialization information for geometry information and the initialization information for attribute information may be stored in common metadata, at least one of individual metadata of geometry information and individual metadata of attribute information, or both the common metadata and the individual metadata. A flag may be used which indicates in which of the individual metadata for geometry information, the individual metadata for attribute information, and the common metadata the initialization information is stored.

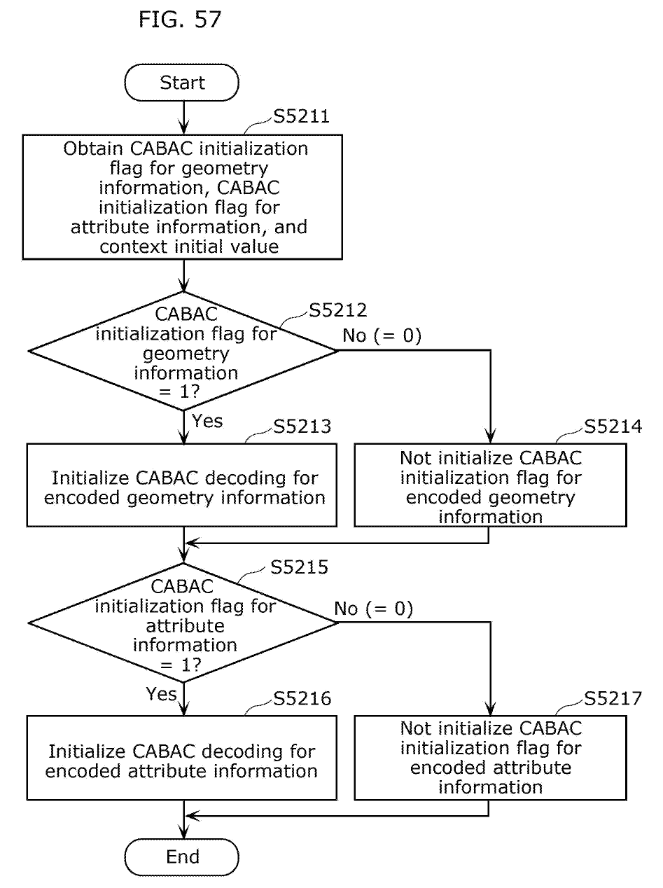

FIG. 57 is a flowchart illustrating an example of a process associated with the initialization of CABAC in the decoding of geometry information or the decoding of attribute information.

The three-dimensional data decoding device analyzes encoded data to obtain a CABAC initialization flag for geometry information, a CABAC initialization flag for attribute information, and a context initial value (S5211).

The three-dimensional data decoding device then determines whether the CABAC initialization flag for geometry information is 1 or not (S5512).

When the CABAC initialization flag for geometry information is 1 (if Yes in S5212), the three-dimensional data decoding device initializes the CABAC decoding for the encoded geometry information using the context initial value in the encoding of the geometry information (S5213).

On the other hand, when the CABAC initialization flag for geometry information is 0 (if No in S5212), the three-dimensional data decoding device does not initialize the CABAC decoding for the encoded geometry information (S5214).

The three-dimensional data decoding device then determines whether the CABAC initialization flag for attribute information is 1 or not (S5215).

When the CABAC initialization flag for attribute information is 1 (if Yes in S5215), the three-dimensional data decoding device initializes the CABAC decoding for the encoded attribute information using the context initial value in the encoding of the attribute information (S5216).

On the other hand, when the CABAC initialization flag for attribute information is 0 (if No in S5215), the three-dimensional data decoding device does not initialize the CABAC decoding for the encoded attribute information (S5217).

Note that, in the flowchart of FIG. 57, the processing concerning geometry information and the processing concerning attribute information may be performed in reverse order or in parallel.

Note that the flowchart of FIG. 57 can be applied to any of the case of slice division and the case of tile division.

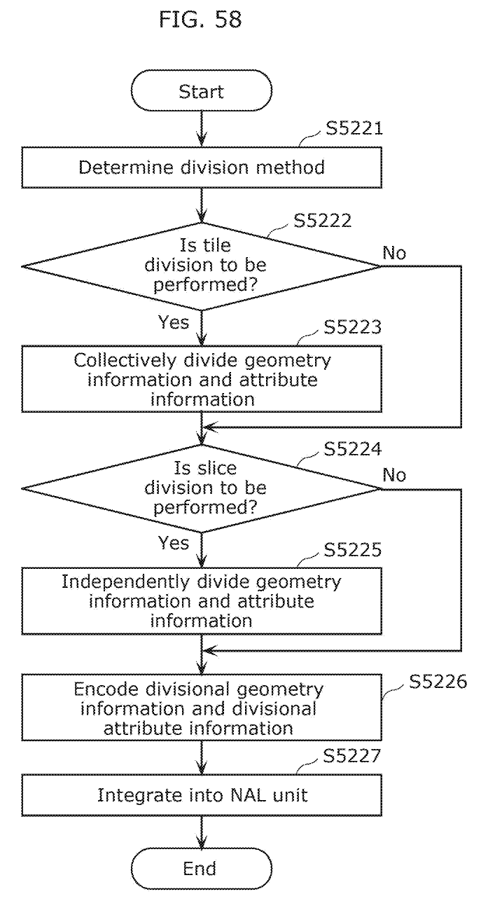

Next, a flow of a process of encoding point cloud data and a flow of a process of decoding point cloud data according to this embodiment will be described. FIG. 58 is a flowchart of a process of encoding point cloud data according to this embodiment.

First, the three-dimensional data encoding device determines a division method to be used (S5221). The division method includes a determination of whether to perform tile division or not and a determination of whether to perform slice division or not. The division method may include the number of tiles or slices in the case where tile division or slice division is performed, and the type of division, for example. The type of division is a scheme based on an object shape, a scheme based on map information or geometry information, or a scheme based on a data amount or processing amount, for example. The division method may be determined in advance.

When tile division is to be performed (if Yes in S5222), the three-dimensional data encoding device generates a plurality of pieces of tile geometry information and a plurality of pieces of tile attribute information by dividing the geometry information and the attribute information on a tile basis (S5223). The three-dimensional data encoding device also generates tile additional information concerning the tile division.

When slice division is to be performed (if Yes in S5224), the three-dimensional data encoding device generates a plurality of pieces of divisional geometry information and a plurality of pieces of divisional attribute information by dividing the plurality of pieces of tile geometry information and the plurality of pieces of tile attribute information (or the geometry information and the attribute information) (S5225). The three-dimensional data encoding device also generates geometry slice additional information and attribute slice additional information concerning the slice division.

The three-dimensional data encoding device then generates a plurality of pieces of encoded geometry information and a plurality of pieces of encoded attribute information by encoding each of the plurality of pieces of divisional geometry information and the plurality of pieces of divisional attribute information (S5226). The three-dimensional data encoding device also generates dependency information.

The three-dimensional data encoding device then generates encoded data (encoded stream) by integrating (multiplexing) the plurality of pieces of encoded geometry information, the plurality of pieces of encoded attribute information and the additional information into a NAL unit (S5227). The three-dimensional data encoding device also transmits the generated encoded data.

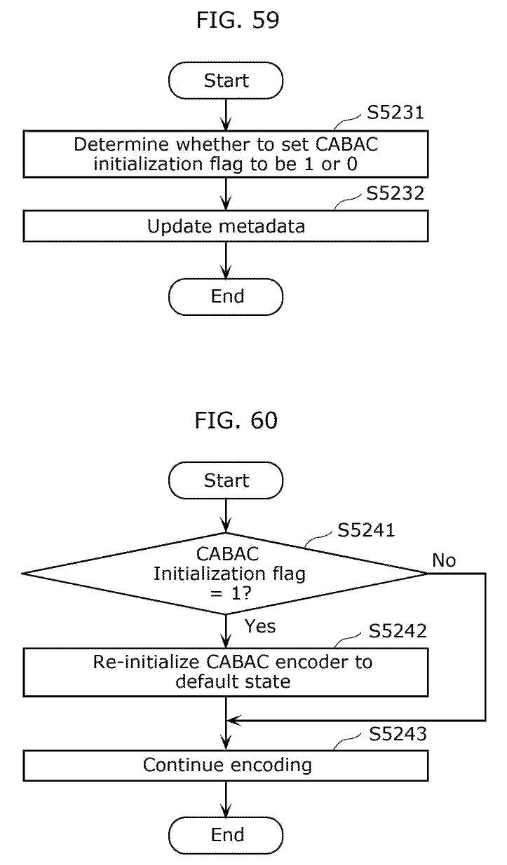

FIG. 59 is a flowchart illustrating an example of a process of determining the value of the CABAC initialization flag and updating additional information in the tile division (S5223) and the slice division (S5525).

In steps S5223 and S5225, tile geometry information and tile attribute information and/or slice geometry information and slice attribute information may be independently divided in respective manners, or may be collectively divided in a common manner. In this way, additional information divided on a tile basis and/or on a slice basis is generated.

In these steps, the three-dimensional data encoding device determines whether to set the CABAC initialization flag to 1 or 0 (S5231).

The three-dimensional data encoding device then updates the additional information to include the determined CABAC initialization flag (S5232).

FIG. 60 is a flowchart illustrating an example of a process of initializing CABAC in the processing of encoding (S5226).

The three-dimensional data encoding device determines whether the CABAC initialization flag is 1 or not (S5241).

When the CABAC initialization flag is 1 (if Yes in S5241), the three-dimensional data encoding device re-initializes the CABAC encoder to the default state (S5242).

The three-dimensional data encoding device then continues the encoding process until a condition for stopping the encoding process is satisfied, such as until there is no data to be encoded (S5243).

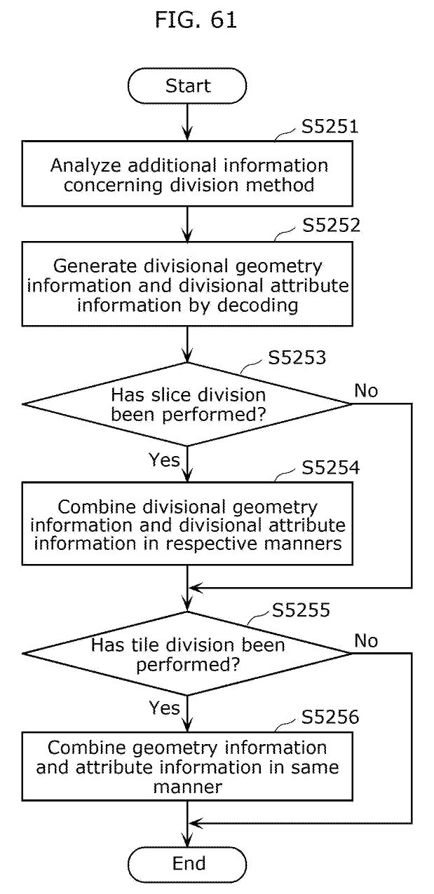

FIG. 61 is a flowchart illustrating a process of decoding point cloud data according to this embodiment. First, the three-dimensional data decoding device determines the division method by analyzing additional information (tile additional information, geometry slice additional information, and attribute slice additional information) concerning the division method included in encoded data (encoded stream) (S5251). The division method includes a determination of whether to perform tile division or not and a determination of whether to perform slice division or not. The division method may include, for example, the number of tiles or slices and the type of division in the case where tile division or slice division is performed.

The three-dimensional data decoding device then generates divisional geometry information and divisional attribute information by decoding a plurality of pieces of encoded geometry information and a plurality of pieces of encoded attribute information included in the encoded data using dependency information included in the encoded data (S5252).

If the additional information indicates that slice division has been performed (if Yes in S5253), the three-dimensional data decoding device generates a plurality of pieces of tile geometry information and a plurality of pieces of tile attribute information by combining the plurality of pieces of divisional geometry information and the plurality of pieces of divisional attribute information based on the geometry slice additional information and the attribute slice additional information (S5254).

If the additional information indicates that tile division has been performed (if Yes in S5255), the three-dimensional data decoding device generates geometry information and attribute information by combining the plurality of pieces of tile geometry information and the plurality of pieces of tile attribute information (the plurality of pieces of divisional geometry information and the plurality of pieces of divisional attribute information) based on the tile additional information (S5256).

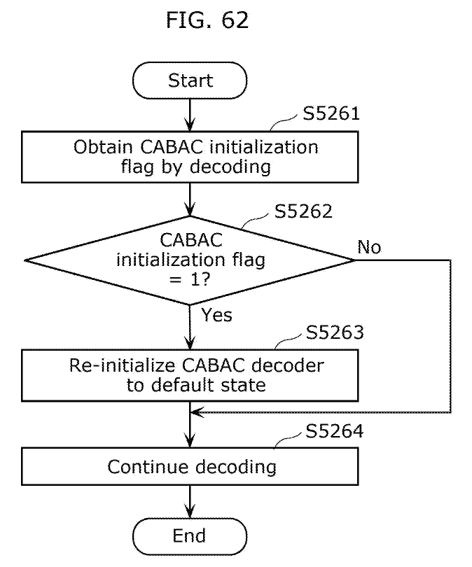

FIG. 62 is a flowchart illustrating an example of a process of initializing the CABAC decoder in the combining (S5254) of information divided into slices and the combining (S5256) of information divided into tiles.

Pieces of slice geometry information and pieces of slice attribute information or pieces of tile geometry information or pieces of tile attribute information may be combined in respective manners or in the same manner.

The three-dimensional data decoding device obtains the CABAC initialization flag by decoding the additional information in the encoded stream.

The three-dimensional data decoding device then determines whether the CABAC initialization flag is 1 or not (S5262).

When the CABAC initialization flag is 1 (if Yes in S5262), the three-dimensional data decoding device re-initializes the CABAC decoder to the default state (S5263).

On the other hand, when the CABAC initialization flag is not 1 (if No in S5262), the three-dimensional data decoding device does not re-initialize the CABAC decoder and proceeds to step S5264.

The three-dimensional data decoding device then continues the decoding process until a condition for stopping the decoding process is satisfied, such as until there is no data to be decoded (S5264).

Next, other conditions concerning the determination of whether to initialize CABAC will be described.

Whether to initialize the encoding of geometry information or the encoding of attribute information may be determined by considering the coding efficiency on a basis of data units, such as tiles or slices. In that case, CABAC may be initialized at the leading data of a tile or slice that satisfies a predetermined condition.

Next, conditions concerning the determination of whether to initialize CABAC in the encoding of geometry information will be described.

For example, the three-dimensional data encoding device may determine the density of point cloud data for each slice, that is, the number of points per unit area belonging to each slice, compare the data density of the slice with the data density of another slice, and determine that the coding efficiency is better when CABAC is not initialized and determine not to initialize CABAC if the variation of the data density satisfies a predetermined condition. On the other hand, if the variation of the data density does not satisfy the predetermined condition, the three-dimensional data encoding device may determine that the coding efficiency is better when CABAC is initialized, and determine to initialize CABAC.

Here, "another slice" may be the preceding slice in the decoding order or a spatially neighboring slice, for example. The three-dimensional data encoding device may not perform the comparison of the data density with that of another slice and may determine whether to initialize CABAC based on whether the data density of the slice is a predetermined data density or not.

When it is determined to initialize CABAC, the three-dimensional data encoding device determines the context initial value used for the encoding of geometry information. The context initial value is set at a value that provides good encoding characteristics in response to the data density. The three-dimensional data encoding device may retain an initial value table for the data density in advance and selects an optimal initial value from the table.

Note that the three-dimensional data encoding device may determine whether to initialize CABAC based on the number of points, the distribution of points, or the imbalance of points, for example, rather than based on the density of a slice described above as an example. Alternatively, the three-dimensional data encoding device may determine whether to initialize CABAC based on a feature quantity or the number of feature points obtained from information on points or based on a recognized object. In that case, a determination criterion may be retained in a memory in the form of a table that associates the determination criterion with a feature quantity or the number of feature points obtained from information on points or an object recognized based on information on points.

For example, the three-dimensional data encoding device may determine an object associated with geometry information of map information and determine whether to initialize CABAC based on the object based on the geometry information. Alternatively, the three-dimensional data encoding device may determine whether to initialize CABAC based on information or a feature quantity obtained by projecting three-dimensional data onto a two-dimensional plane.

Next, conditions concerning the determination of whether to initialize CABAC in the encoding of attribute information will be described.

For example, the three-dimensional data encoding device may compare a color characteristic of the relevant slice with the color characteristic of the preceding slice, and determine that the coding efficiency is better when CABAC is not initialized and determine not to initialize CABAC if the variation of the color characteristic satisfies a predetermined condition. On the other hand, if the variation of the color characteristic does not satisfy the predetermined condition, the three-dimensional data encoding device may determine that the coding efficiency is better when CABAC is initialized, and determine to initialize CABAC. The color characteristic is luminance, chromaticity, or chroma, a histogram thereof, or color continuity, for example.

Here, "another slice" may be the preceding slice in the decoding order or a spatially neighboring slice, for example. The three-dimensional data encoding device may not perform the comparison of the data density with that of another slice and may determine whether to initialize CABAC based on whether the data density of the slice is a predetermined data density or not.

When it is determined to initialize CABAC, the three-dimensional data encoding device determines the context initial value used for the encoding of attribute information. The context initial value is set at a value that provides good encoding characteristics in response to the data density. The three-dimensional data encoding device may retain an initial value table for the data density in advance and select an optimal initial value from the table.

When the attribute information is reflectance, the three-dimensional data encoding device may determine whether to initialize CABAC based on reflectance-based information.

When a three-dimensional point has a plurality of pieces of attribute information, the three-dimensional data encoding device may independently determine initialization information for each piece of attribute information based on the piece of attribute information, may determine initialization information for the plurality of pieces of attribute information based on one of the pieces of attribute information, or may determine initialization information for the plurality of pieces of attribute information using a plurality of pieces of attribute information.

Although an example has been described in which the initialization information for geometry information is determined based on the geometry information, and the initialization information for attribute information is determined based on the attribute information, the initialization information for geometry information and attribute information may be determined based on the geometry information, based on the attribute information, or based on both the geometry information and the attribute information.

The three-dimensional data encoding device may determine initialization information based on a result of simulation of the coding efficiency performed by turning on and off cabac_init_flag or selecting one or more initial values from an initial value table, for example.

When the data division method into tiles, slices or the like is determined based on geometry information or attribute information, the three-dimensional data encoding device may determine initialization information based on the same information as information based on the determination of the division method.

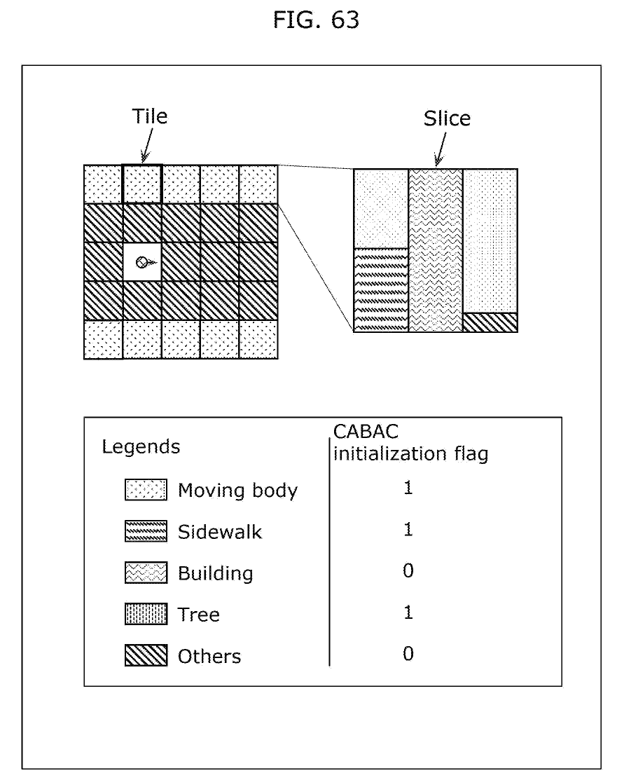

FIG. 63 is a diagram illustrating an example of tiles and slices.

For example, slices in one tile having part of PCC data are recognized as indicated by legends. The CABAC initialization flag can be used to determine whether re-initialization of a context is needed or not in successive slices. For example, in FIG. 63, when one tile includes slice data divided on a basis of objects (such as a moving body, a sidewalk, a building, a tree or other objects), the CABAC initialization flags for slices of a moving body, a sidewalk, and a tree are set to be 1, and the CABAC initialization flags for slices of a building and other objects are set to be 0. This means that, if the sidewalk and the building may be both dense permanent structures and have similar coding efficiencies, the coding efficiency may be able to be improved by avoiding re-initialization of CABAC between the slices for the sidewalk and the building. On the other hand, if the building and the tree may be significantly different in density and coding efficiency, the coding efficiency may be able to be improved by initializing CABAC between the slices for the building and the tree.

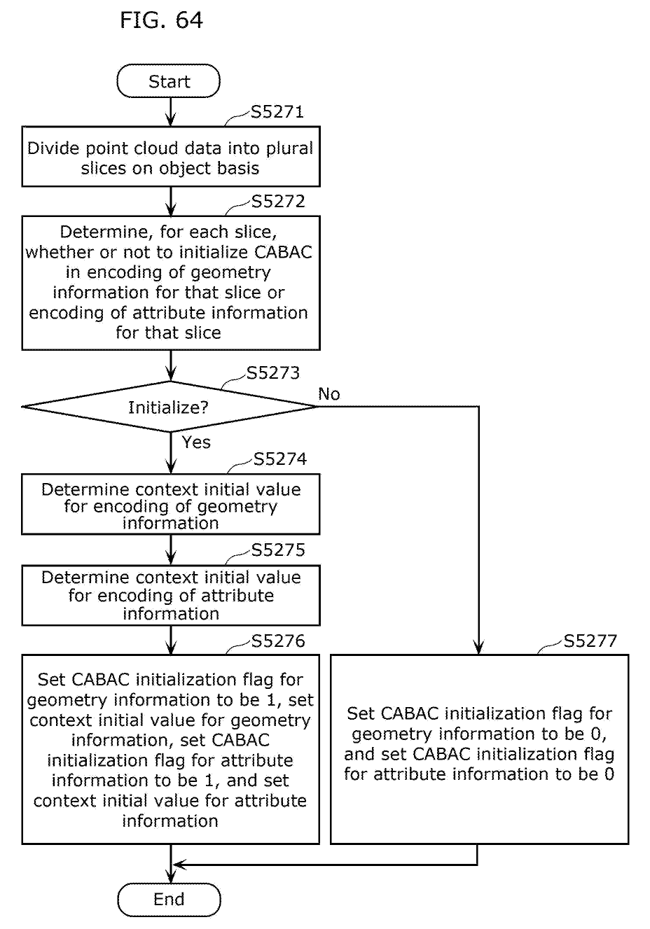

FIG. 64 is a flowchart illustrating an example of the method of determining whether to initialize CABAC and determining a context initial value.

First, the three-dimensional data encoding device divides point cloud data into slices based on an object determined from geometry information (S5271).

The three-dimensional data encoding device then determines, for each slice, whether to initialize CABAC for the encoding of geometry information and the encoding of attribute information based on the data density of the object of the slice (S5272). In other words, the three-dimensional data encoding device determines CABAC initialization information (CABAC initialization flag) for the encoding of geometry information and the encoding of attribute information based on the geometry information. The three-dimensional data encoding device determines an initialization with high coding efficiency based on the point cloud data density, for example. The CABAC initialization information may be indicated by cabac_init_flag that is common to the geometry information and the attribute information.

When it is determined to initialize CABAC (if Yes in S5273), the three-dimensional data encoding device determines a context initial value for the encoding of geometry information (S5274).

The three-dimensional data encoding device then determines a context initial value for the encoding of attribute information (S5275).

The three-dimensional data encoding device then sets the CABAC initialization flag for geometry information to be 1, sets the context initial value for geometry information, sets the CABAC initialization flag for attribute information to be 1, and sets the context initial value for attribute information (S5276). Note that when initializing CABAC, the three-dimensional data encoding device performs the initialization process using a context initial value in each of the encoding of geometry information and the encoding of attribute information.

On the other hand, when it is determined not to initialize CABAC (if No in S5273), the three-dimensional data encoding device sets the CABAC initialization flag for geometry information to be 0, and sets the CABAC initialization flag for attribute information to be 0 (S5277).

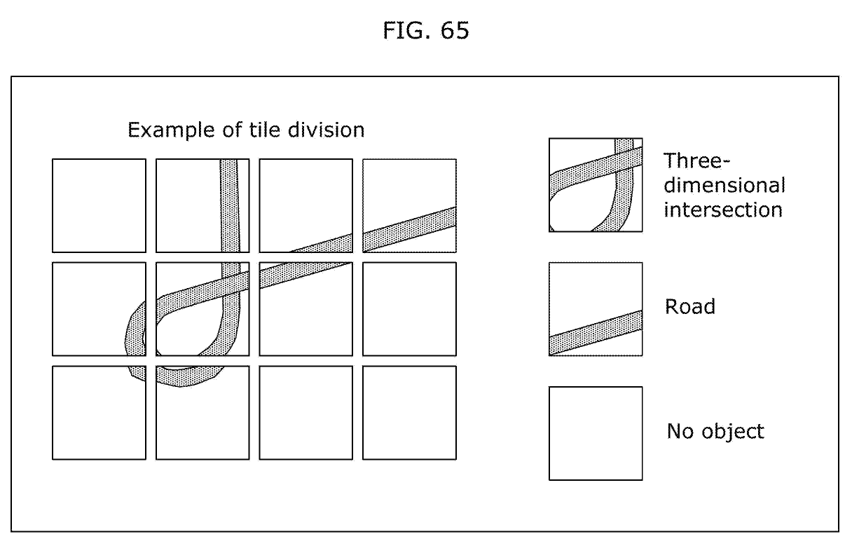

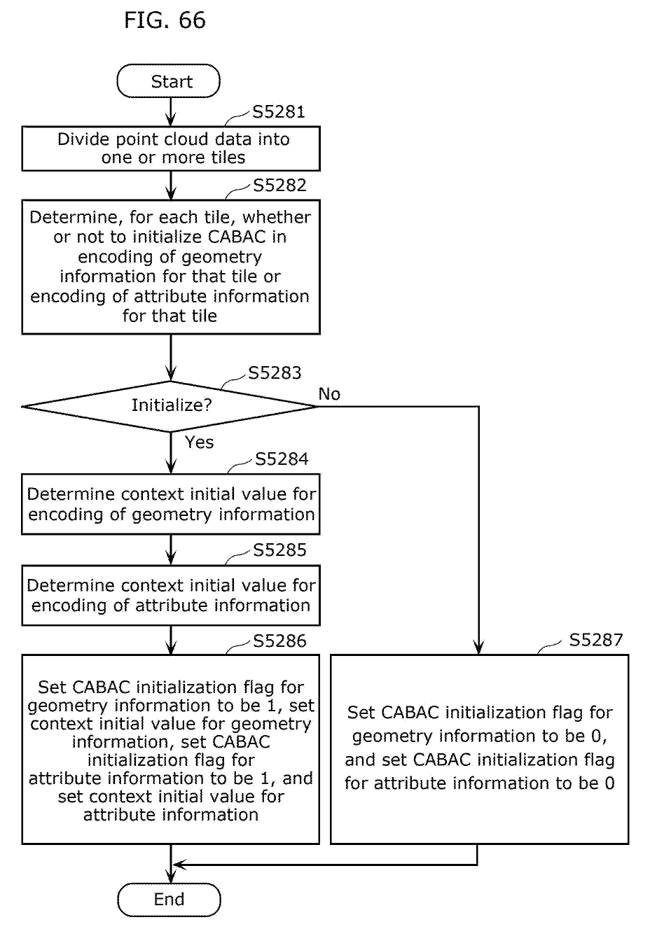

FIG. 65 is a diagram illustrating an example of a case where a map, which is a top view of point cloud data obtained by LiDAR, is divided into tiles. FIG. 66 is a flowchart illustrating another example of the method of determining whether to initialize CABAC and determining a context initial value.

In large-scale map data, the three-dimensional data encoding device divides point cloud data into one or more tiles based on geometry information in a two-dimensional top-view division manner (S5281). The three-dimensional data encoding device may divide point cloud data into square areas as illustrated in FIG. 65, for example. The three-dimensional data encoding device may also divide point cloud data into tiles of different shapes or sizes. The division into tiles may be performed in one or more methods determined in advance or may be adaptively performed.

The three-dimensional data encoding device then determines an object in each tile, and determines whether to initialize CABAC in the encoding of geometry information for the tile or the encoding of attribute information for the tile (S5282). Note that, in the division into slices, the three-dimensional data encoding device recognizes an object (a tree, a human being, a moving body, or a building), and determines whether to perform the slice division and determine an initial value based on the object.

When it is determined to initialize CABAC (if Yes in S5283), the three-dimensional data encoding device determines a context initial value for the encoding of geometry information (S5284).

The three-dimensional data encoding device then determines a context initial value for the encoding of attribute information (S5285).

In steps S5284 and S5285, an initial value for a tile having particular encoding characteristics may be stored as the initial value and used as an initial value for a tile having the same encoding characteristics.

The three-dimensional data encoding device then sets the CABAC initialization flag for geometry information to be 1, sets the context initial value for geometry information, sets the CABAC initialization flag for attribute information to be 1, and sets the context initial value for attribute information (S5286). Note that when initializing CABAC, the three-dimensional data encoding device performs the initialization process using a context initial value in each of the encoding of geometry information and the encoding of attribute information.

On the other hand, when it is determined not to initialize CABAC (if No in S5283), the three-dimensional data encoding device sets the CABAC initialization flag for geometry information to be 0, and sets the CABAC initialization flag for attribute information to be 0 (S5287).

In the context-based adaptive binary arithmetic coding (CABAC) in the embodiment described above, the three-dimensional data encoding device may encode the three-dimensional points included in the data unit using one of encoding schemes different from each other. That is, for each data unit, the three-dimensional data encoding device determines, from among the encoding schemes, an encoding scheme suitable for the data unit as an encoding scheme for encoding three-dimensional points included in the data unit. In encoding of geometry information items of three-dimensional points, the encoding schemes include, for example, an octree encoding, which is an encoding scheme using an octree, and prediction-tree encoding, which is an encoding scheme using a prediction tree.

Signaling of a CABAC initialization flag (hereinafter, also referred to as initialization information or identification information) in such CABAC encoding will be described.

### Signaling

The initialization information is stored in a header of an encoded data item. Examples of the initialization information include caba_init_flag, a CABAC initial value, and an index of a table capable of identifying an initial value. The initialization information is used for initializing CABAC in CABAC encoding and CABAC decoding. In other words, the initialization information (identification information) is information indicating whether a context used for encoding is continuously used.

The three-dimensional data encoding device may store the initialization information in metadata or may write the initialization information in both the header and the metadata. It should be noted that, in the present embodiment, storing in metadata may be interpreted as storing in a header of encoded data; conversely, storing in a header of encoded data may be interpreted as storing in metadata.

It should be noted that the three-dimensional data encoding device may apply the initialization information to any one of encoding geometry information and encoding attribute information. In a case where the initialization information is stored in a header of encoded data, the three-dimensional data encoding device may store, as geometry information, initialization information of encoding of geometry information and may store, as attribute information, initialization information of attribute information.

### Header of Geometry Information

CABAC is an abbreviation of context-based adaptive binary arithmetic coding, which is an encoding method in which a context (a model for estimating an occurrence probability of a binary symbol being input) is successively updated based on encoded information, thus increasing a precision of the probability, so that an arithmetic encoding (entropy encoding) with high compression ratio is realized. To perform parallel processing on data units (divided data items) obtained by dividing a point cloud data item such as tiles or slices, each data unit needs to be encoded or decoded independently. To subject the data units to CABAC independently, CABAC needs to be initialized at a beginning of each data unit in encoding and decoding. The CABAC initialization flag is used for initializing CABAC in CABAC encoding and CABAC decoding.

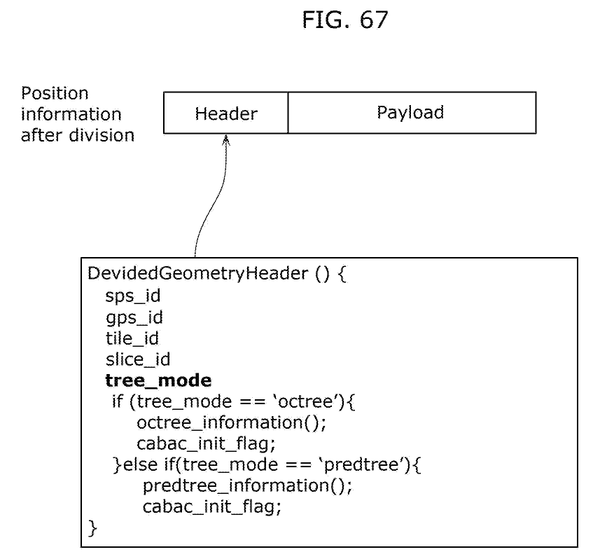

FIG. 67 is a diagram illustrating an example of a data structure of a geometry information item included in each data unit after the division, and a syntax of a header of the geometry information item.

In encoding of geometry information, the three-dimensional data encoding device may apply the initialization information to any one of or both encoding schemes (encoding methods) such as octree encoding and prediction-tree encoding. The octree encoding and the prediction-tree encoding are encoding schemes using different tree structures from each other.

In a case of the octree encoding, which uses an octree structure, the three-dimensional data encoding device retains a context to be used in the octree encoding (i.e., a context for the octree encoding). In a case of the prediction-tree encoding, which uses a prediction-tree structure, the three-dimensional data encoding device retains a context to be used in the prediction-tree encoding (i.e., a context for the prediction-tree encoding).

Storing the initialization information in a header of each divided data unit of geometry information enables the three-dimensional data encoding device to switch whether to initialize a context to be used for the encoding, for each divided data unit. In other words, Storing the identification information in a header of each divided data unit of geometry information enables the three-dimensional data encoding device to switch whether to continuously use a context used for the encoding, for each divided data unit.

SPS_ID indicates an identifier of an SPS (parameter set) that is to be referred to by the data unit. GPS_ID indicates an identifier of a GPS (geometry information parameter set) that is to be referred to by the data unit. Tile_id indicates an identifier of a tile to which the data unit belongs (identifier 1 of divided data). Slice_id indicates an identifier of a slice to which the data unit belongs (identifier 2 of divided data).

Tree_mode indicates a tree structure to be used in encoding of geometry information of the data unit. In a case where there are two types of tree structures, tree_mode may be a flag. For example, tree_mode may be configured to indicate an octree (octree) when its flag is zero and to indicate a prediction tree (predtree) when the flag is one. It should be noted that tree_mode need not be provided in a slice header when tree_mode is provided in a GPS.

Based on tree_mode, the three-dimensional data encoding device may switch among structures of metadata to be used in respective encodings and perform signaling.

For example, when the tree structure is an octree (tree_mode == 'octree'), the three-dimensional data encoding device signals a parameter to be used for the octree encoding (octree_information). Further, a flag indicating whether to initialize a context in the octree encoding (cabac_init_flag), in other words, an identification information item indicating whether to continuously use a context, may be provided.

For example, when the tree structure is a prediction tree (tree_mode == 'predtree'), the three-dimensional data encoding device signals a parameter to be used for the prediction-tree encoding (predtree_information). Further, a flag indicating whether to initialize a context in the prediction-tree encoding (cabac_init_flag), in other words, an identification information item indicating whether to continuously use a context, may be provided.

It should be noted that use of the following method makes it possible to reduce an amount of information signaled, thus improving compression efficiency. The three-dimensional data encoding device may use cabac_init_flag as a flag that is common to encoding schemes to perform signaling before a conditional branch based on tree_mode.

The three-dimensional data encoding device may be configured to apply initialization of a context to some tree structure(s) and not to apply the initialization to the other tree structure(s). In this case, the three-dimensional data encoding device may generate a header according to a syntax that makes the header not contain the initialization information for a tree structure to which the initialization of a context is not applied, and makes the header contain the initialization information for a tree structure to which the initialization is applied. For example, in a case where initialization is performed on all divided data units, the three-dimensional data encoding device may be configured to provide the initialization information in a higher parameter set such as an SPS and a GPS in common and not to provide initialization information in each data unit.

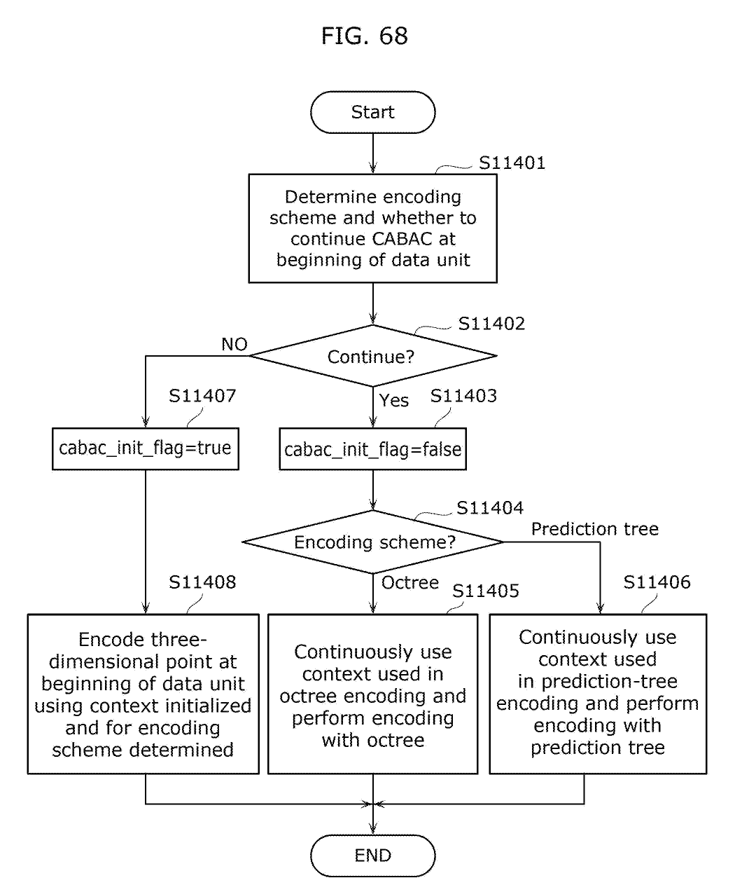

FIG. 68 is a flowchart illustrating an example of a three-dimensional data encoding method. Here, encoding of geometry information items of three-dimensional points included in a data unit will be described.

The three-dimensional data encoding device determines an encoding scheme for a data unit being a processing target and determines whether to continue CABAC in encoding of a geometry information item of a three-dimensional point at a beginning of the data unit being the processing target (S11401). In other words, the three-dimensional data encoding device determines any one of the octree encoding and the prediction-tree encoding as an encoding scheme for the data unit and determines whether to continuously use a context used for the encoding.

Next, when it is determined to continuously use the context (Yes in S11402), the three-dimensional data encoding device sets cabac_init_flag to false (S11403). That is, the three-dimensional data encoding device sets an identification information item such that the identification information item indicates that the context used for the encoding is continuously used. The three-dimensional data encoding device sets the identification information such that the identification information indicates a determination result of step S11402.

Next, when the octree encoding is determined as the encoding scheme (Octree in S11404), the three-dimensional data encoding device continuously uses a context used in the octree encoding and performs the encoding with an octree (S11405). The context used in the octree encoding is a context that is used in octree encoding of a data unit immediately before the data unit being the processing target. The context is, for example, temporarily stored in a memory of the three-dimensional data encoding device, and the three-dimensional data encoding device reads the context stored in the memory and uses the context in the encoding of the data unit being the processing target.

In contrast, when the prediction-tree encoding is determined as the encoding scheme (Prediction tree in S11404), the three-dimensional data encoding device continuously uses a context used in the prediction-tree encoding and performs the encoding with a prediction tree (S11406). The context used in the prediction-tree encoding is a context that is used in prediction-tree encoding of a data unit immediately before the data unit being the processing target. The context is, for example, temporarily stored in a memory of the three-dimensional data encoding device, and the three-dimensional data encoding device reads the context stored in the memory and uses the context in the encoding of the data unit being the processing target.

As illustrated in steps S11405 and S11406, the three-dimensional data encoding device continuously uses the context used in the encoding scheme determined from among the encoding schemes in step S11401 and executes the encoding.

It should be noted that, in a case where the context is continuously used, the three-dimensional data encoding device changes a value of the context continuously used, based on the encoding scheme (octree or prediction tree) for the geometry information item. For example, a context for the octree encoding is a context for entropy encoding of an Occupancy code, a quantized value, duplicated points in a leaf node, and the like, and a context for the prediction-tree encoding is a context for entropy encoding of the number of nodes, a prediction mode, and the like.

When it is determined not to continuously use the context (No in S11402), that is, when it is determined to initialize the context, the three-dimensional data encoding device sets cabac_init_flag to true (S11407). That is, the three-dimensional data encoding device sets an identification information item such that the identification information item indicates that the context used for the encoding is not continuously used. The three-dimensional data encoding device sets the identification information such that the identification information indicates a determination result of step S11402.

Next, the three-dimensional data encoding device encodes the geometry information item of the three-dimensional point at a beginning of the data unit using a context initialized and for the encoding scheme determined in step S11401 (S11408).

As described above, when performing the octree encoding, the three-dimensional data encoding device performs the encoding using a context for the octree encoding, and when performing the prediction-tree encoding, the three-dimensional data encoding device performs the encoding using a context for the prediction-tree encoding. That is, in the three-dimensional data encoding method, a context to be continuously used in the encoding is changed based on the encoding scheme for the geometry information item.

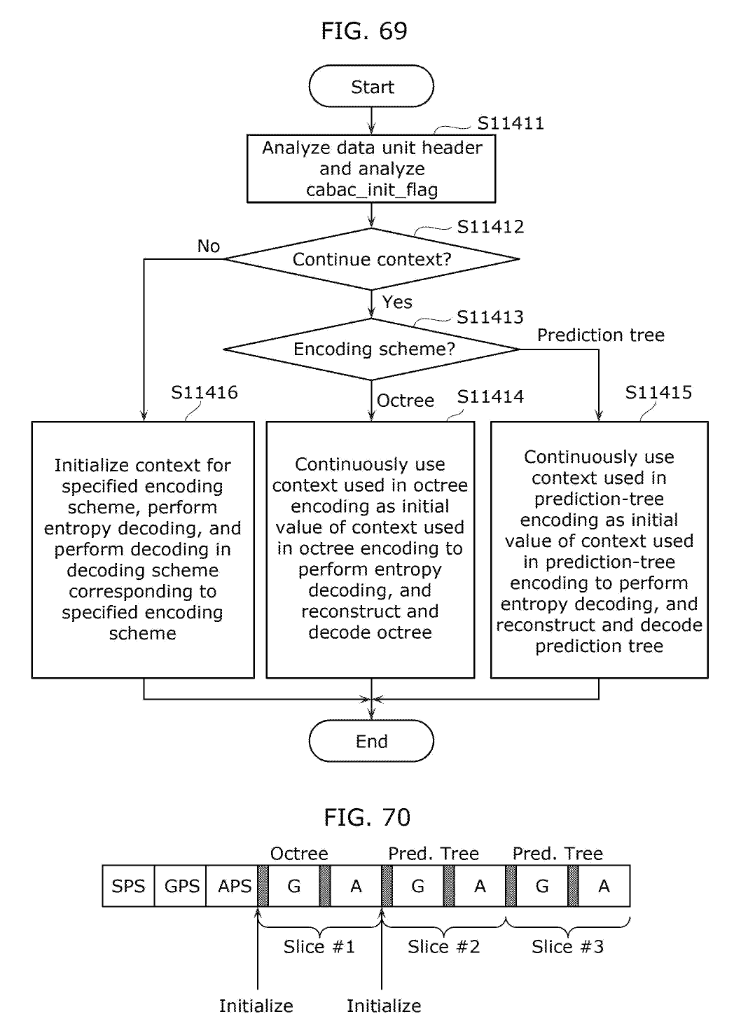

FIG. 69 is a flowchart illustrating an example of a three-dimensional data decoding method. Here, decoding of geometry information items of three-dimensional points included in a data unit will be described.

The three-dimensional data decoding device analyzes a header of an encoded data unit (encoded data) being a processing target and analyzes cabac_init_flag (S11411).

The three-dimensional data decoding device determines whether cabac_init_flag indicates that a context is continuously used (S11412).

When cabac_init_flag indicates that the context is continuously used (Yes in S11412), that is, when cabac_init_flag is set to false, the three-dimensional data decoding device determines an encoding scheme for the encoded data being the processing target (S11413).

When the encoding scheme for the encoded data being the processing target is the octree encoding (Octree in S11413), the three-dimensional data decoding device continuously uses the context used in the octree encoding as an initial value of a context used in the octree encoding to perform entropy decoding and reconstructs and decodes the octree (S11414).

When the encoding scheme for the encoded data being the processing target is the prediction-tree encoding (Prediction tree in S11413), the three-dimensional data decoding device continuously uses the context used in the prediction-tree encoding as an initial value of a context used in the prediction-tree encoding to perform entropy decoding and reconstructs and decodes the prediction tree (S11415).

As described above, when cabac_init_flag (the identification information item) indicates that the context used for the encoding is continuously used, the three-dimensional data decoding device continuously uses the context used in the encoding scheme for the encoded data to decode the encoded data.

When cabac_init_flag indicates that the context is not continuously used (No in S11412), that is, when cabac_init_flag is set to true, the three-dimensional data decoding device initializes a context for a specified encoding scheme, performs entropy decoding, and performs decoding in a decoding scheme corresponding to the specified encoding scheme (S11416).

It should be noted that, in the embodiment, the description is given of a method of changing a context continuously used, based on the encoding scheme (octree or prediction tree) for the geometry information item; however, the method can be applied to an encoding scheme for an attribute information item as well. Examples of the encoding scheme for an attribute information item include an LoD-base encoding scheme and a Transform-base encoding scheme. In this case, the three-dimensional data encoding device may change the context continuously used, based on the encoding scheme for an attribute information item. That is, when performing LoD-base encoding, the three-dimensional data encoding device performs the encoding using a context for the LoD-base encoding, and when performing the Transform-base encoding, the three-dimensional data encoding device performs the encoding using a context for the Transform-base encoding.

It should be noted that, when cabac_init_flag is signaled in encoding of attribute information items, the signaling may be performed independently for the LoD-base encoding scheme and the Transform-base encoding scheme or may be signaled in common. That is, the three-dimensional data encoding device may store cabac_init_flag for each encoding scheme in a header or may store cabac_init_flag that is common to encoding schemes in a header. When using one encoding scheme from the encoding schemes, the three-dimensional data encoding device makes cabac_init_flag sharable (i.e., unifies cabac_init_flags), by which an amount of information for the signaling can be reduced.

Further, cabac_init_flag for encoding of attribute information items and cabac_init_flag for encoding of geometry information items may be made to have the same value or different values.

In a case where cabac_init_flag for encoding of attribute information items and cabac_init_flag for encoding of geometry information items are made to have the same value, cabac_init_flag for encoding of attribute information items and cabac_init_flag for encoding of geometry information items may be made sharable and stored in metadata that is common to sequences, such as an SPS. In this case, in the encoding, when it is determined that the context used for the encoding is continuously used, the three-dimensional data encoding device (i) encodes geometry information items of three-dimensional points continuously using a context used in an encoding scheme for the three-dimensional points that is included in encoding schemes and (ii) encodes attribute information items of the three-dimensional points continuously using a context used in an encoding scheme for the attribute information items. Contrariwise, in the encoding, when it is determined that the context used for the encoding is not continuously used, the three-dimensional data encoding device (i) encodes geometry information items of three-dimensional points using a context initialized and for an encoding scheme for the three-dimensional points that is included in encoding schemes and (ii) encodes attribute information items of the three-dimensional points continuously using a context initialized and for an encoding scheme for the attribute information items.

In this case, when the identification information item indicates that the context used for the encoding is continuously used, the three-dimensional data decoding device (i) calculates encoded geometry information items of three-dimensional points by performing decoding continuously using a context used in an encoding scheme being included in the encoding schemes and used for encoding the geometry information items of the three-dimensional points and (ii) calculates attribute information items of the three-dimensional points by performing decoding continuously using a context used in an encoding scheme for the attribute information items. Contrariwise, when the identification information item indicates that the context used for the encoding is not continuously used, the three-dimensional data decoding device (i) calculates encoded geometry information items of three-dimensional points by performing decoding using a context initialized and for an encoding scheme that is included in the encoding schemes and used for encoding the geometry information items of the three-dimensional points and (ii) decodes attribute information items of the three-dimensional points by performing decoding using a context initialized and for an encoding scheme for the attribute information items.

In a case where cabac_init_flag for encoding of attribute information items and cabac_init_flag for encoding of geometry information items are made to have different values, the three-dimensional data encoding device stores cabac_init_flag for encoding of attribute information items and cabac_init_flag for encoding of geometry information items in an APS, a GPS, a data unit header, or the like.

The three-dimensional data encoding device may store cabac_init_flag for encoding of attribute information items and cabac_init_flag for encoding of geometry information items in metadata common to the geometry information items and the attribute information items, in any one of or both individual metadata items, or in the common metadata and the individual metadata items. Further, the three-dimensional data encoding device may use a flag indicating where cabac_init_flag for encoding of attribute information items and cabac_init_flag for encoding geometry information items are written.

It should be noted that, in encoding of a geometry information item, when switching of an encoding scheme is performed between data units, the three-dimensional data encoding device may determine to initialize a context for a data unit that is first encoded after the switching of the encoding scheme rather than continuously using the context.

FIG. 70 is a diagram for describing initialization of a context in a case where an encoding scheme is switched. FIG. 70 illustrates an example of a case where a data unit of slice#1 is encoded in the octree encoding (Octree), and data units of slice#2 and slice#3 are encoded in the prediction-tree encoding (predtree).

The three-dimensional data encoding device sets an initialization flag (cabac_init_flag) used for encoding a geometry information item of a data unit at a beginning of the octree encoding (slice#1) to ON (true). The three-dimensional data encoding device sets an initialization flag (cabac_init_flag) used for encoding a geometry information item of a data unit at a beginning of the prediction-tree encoding (slice#2) to ON (true). It should be noted that an initialization flag for slice#3 may be set to either ON or OFF.

As described above, in a case where an encoding scheme for a first data unit is different from an encoding scheme for a second data unit, which is encoded next to the first data unit, the three-dimensional data encoding device determines that a context used for the encoding is not continuously used and encodes three-dimensional points of the second data unit using a context initialized and for the encoding scheme for the second data unit that is included in the encoding schemes. In this case, an identification information item corresponding to the second data unit (the second identification information item) is set in such a manner as to indicate that the context used for the encoding is not continuously used.

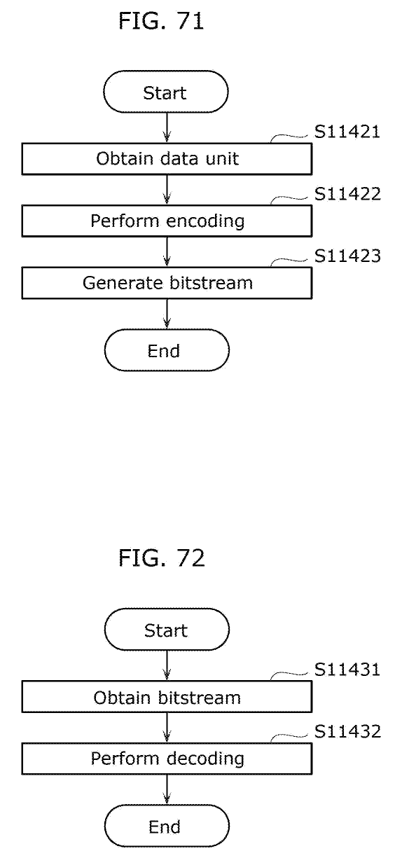

As stated above, the three-dimensional data encoding device according to one aspect of the present embodiment performs the process shown in FIG. 71. The three-dimensional data encoding device obtains a first data unit including first three-dimensional points (S11421). Next, the three-dimensional data encoding device encodes the first three-dimensional points included in the first data unit obtained, using one of encoding schemes different from each other (S11422). Then, the three-dimensional data encoding device generates a bitstream including first encoded data and a first identification information item, the first encoded data being obtained by encoding the first three-dimensional points (S11423). The encoding of the first three-dimensional points (S11422) includes: determining whether a context used for encoding is continuously used; and encoding the first three-dimensional points using a context corresponding to a determination result in the determining, the context being included in contexts used in an encoding scheme used for the encoding and included in the encoding schemes. The first identification information item includes the determination result in the determining.

According to the aspect, since whether to continue the context used for the encoding is determined, and thus encoding efficiency can be improved, and since the bitstream including the first identification information is generated, the three-dimensional data decoding device is enabled to perform decoding appropriately.

For example, in the encoding of the first three-dimensional points (S11422), when it is determined that the context used for the encoding is continuously used, the first three-dimensional points are encoded continuously using a context used in an encoding scheme for the first three-dimensional points, the encoding scheme being included in the encoding schemes, and the first identification information item indicates that the context used for the encoding is continuously used.

For example, in the encoding of the first three-dimensional points (S11422), when it is determined that the context used for the encoding is not continuously used, the first three-dimensional points are encoded using a context initialized and for an encoding scheme for the first three-dimensional points, the encoding scheme being included in the encoding schemes, and the first identification information item indicates that the context used for the encoding is not continuously used.

For example, each of the first three-dimensional points includes a geometry information item and an attribute information item. The encoding schemes are encoding schemes for geometry information. In the encoding of the first three-dimensional points (S11422), attribute information items of the first three-dimensional points are encoded using an other encoding scheme. In the encoding of the first three-dimensional points (S11422), when it is determined that the context used for the encoding is continuously used, (i) geometry information items of the first three-dimensional points are encoded continuously using a context used in an encoding scheme for the first three-dimensional points, the encoding scheme being included in the encoding schemes, and (ii) the attribute information items of the first three-dimensional points are encoded continuously using a context used in the other encoding scheme.

For example, in the encoding of the first three-dimensional points (S11422), when it is determined that the context used for the encoding is not continuously used, (i) the geometry information items of the first three-dimensional points are encoded using a context initialized and for an encoding scheme for the first three-dimensional points, the encoding scheme being included in the encoding schemes, and (ii) the attribute information items of the first three-dimensional points are encoded using a context initialized and for the other encoding scheme.

For example, the three-dimensional data encoding device includes a processor and memory, and the processor performs the above-described process using the memory.

The three-dimensional data decoding device according to one aspect of the present embodiment performs the process shown in FIG. 72. The three-dimensional data decoding device obtains a bitstream including first encoded data and a first identification information item (S11431), the first encoded data being obtained by encoding first three-dimensional points, the first identification information item indicating whether a context used for encoding is continuously used. Next, the three-dimensional data decoding device decodes the first encoded data using a decoding scheme corresponding to an encoding scheme used for encoding the first encoded data (S11432), the encoding scheme being included in encoding schemes different from each other. In the decoding of the first encoded data (S11432), the first encoded data is decoded using a context according to the first identification information item.

According to the aspect, appropriate first three-dimensional points can be calculated by decoding the first encoded data according to the first identification information included in the bitstream.

For example, in the decoding of the first encoded data (S11432), when the first identification information item indicates that the context used for the encoding is continuously used, the first encoded data is decoded continuously using a context used in the encoding scheme corresponding to the decoding scheme.

For example, in the decoding of the first encoded data (S11432), when the first identification information item indicates that the context used for the encoding is not continuously used, the first encoded data is decoded using a context initialized and for the encoding scheme used for encoding the first encoded data.

For example, the first encoded data includes geometry information items of the first three-dimensional points encoded, and attribute information items of the first three-dimensional points encoded. The encoding schemes are encoding schemes for geometry information. The attribute information items of the first three-dimensional points encoded are encoded using an other encoding scheme. In the decoding of the first encoded data (S11432), when the first identification information item indicates that the context used for the encoding is continuously used, (i) the geometry information items of the first three-dimensional points are calculated by decoding the first encoded data continuously using a context used in an encoding scheme used for encoding the geometry information items of the first three-dimensional points, the encoding scheme being included in the encoding schemes, and (ii) the attribute information items of the first three-dimensional points are calculated by decoding the first encoded data continuously using a context used in the other encoding scheme.

For example, in the decoding of the first encoded data (S11432), when the first identification information item indicates that the context used for the encoding is not continuously used, (i) the geometry information items of the first three-dimensional points are calculated by decoding the first encoded data using a context initialized and for the encoding scheme used for encoding the geometry information items of the first three-dimensional points, and (ii) the attribute information items of the first three-dimensional points are calculated by decoding the first encoded data using a context initialized and for the other encoding scheme.

For example, the bitstream further includes second encoded data and a second identification information item, the second encoded data being obtained by encoding second three-dimensional points, the second identification information item indicating whether a context used for encoding is continuously used. The second three-dimensional points are encoded next to the first three-dimensional points. The second identification information item indicates that the context used for the encoding is not continuously used.

For example, the three-dimensional data decoding device includes a processor and memory, and the processor performs the above-described process using the memory.

In entropy encoding, in the case of indicating whether to continue the context, to indicate that the context is continued, it is preferred to ensure that the corresponding context is continued in the three-dimensional data decoding device. For example, if continuing the context is indicated even though the context is not saved or not available, the three-dimensional data decoding device cannot decode the three-dimensional point cloud. To address this, the following constraints may be imposed to ensure that the three-dimensional data decoding device can decode the three-dimensional point cloud when continuing the context.

### Encoding Constraints

Examples of changing the context used in encoding include switching the encoding scheme such as prediction tree or octree, as well as switching encoding parameters.

Switching encoding parameters may include, for example, changing the number of divisions of a tree structure, such as switching octree in octree encoding to quadtree or binary tree. Switching encoding parameters may also include, for example, switching the context for occupancy codes, such as switching between bitwise encoding in which the context is assigned to each bit of an 8-bit occupancy code and bytewise encoding in which the context is assigned to the entire occupancy code. Switching encoding parameters may also include switching between referring to only the current node and referring to nodes up to adjacent nodes in octree encoding.

Flags indicating whether these encoding parameters are switched may be included in the SPS (sequence parameter set), GPS (geometry information parameter set), data unit header, and the like.

If the context used is switched as described above, the three-dimensional data encoding device may first reset the context in entropy encoding of the data unit. That is, the three-dimensional data encoding device may perform encoding using the reset (initialized) context, rather than using the saved context.

Similarly, in attribute information encoding, as in geometry information encoding, the three-dimensional data encoding device may reset the context in entropy encoding of the data unit if the context used is switched.

In encoding, a constraint may be imposed such that encoding parameters are not switched if entropy encoding is not reset.

For example, in encoding, it may be specified that encoding parameters are the same in the parameter set (e.g., GPS1) referred to by the "previous data unit DU_prev" for which the context is saved, and in the parameter set (GPS2) referred to by the "current data unit DU_cur" for which entropy encoding is started using the context of DU_prev.

Alternatively, in encoding, it may be specified that the geometry parameter sets of GPS1 and GPS2 are the same and describe identical content. That is, it may be specified that the parameter sets have the same identifier GPS_id.

APSs may be similarly specified. For example, in encoding, it may be specified that encoding parameters are the same in the parameter set (e.g., APS1) referred to by the "previous data unit DU_prev" for which the context is saved, and in the parameter set (APS2) referred to by the "current data unit DU_cur" for which entropy encoding is started using the context of DU_prev.

Alternatively, in encoding, it may be specified that the geometry parameter sets of APS1 and APS2 are the same and have identical content. That is, it may be specified that the parameter sets have the same identifier APS_id.

If the context is continued, the data unit header of DU_cur may store the ID of the slice to which DU_cur belongs and the ID of the slice to which DU_prev belongs.

### Decoding Constraints

Constraints on the three-dimensional data decoding device may be imposed as follows.

If entropy encoding of DU_cur uses the context saved for DU_prev, i.e., if cabac_init_flag = 0, the three-dimensional data decoding device determines whether the slice ID of the data unit decoded before decoding DU_cur matches the slice ID of DU_prev. If they match, the three-dimensional data decoding device may decode DU_cur. The three-dimensional data decoding device thus checks if a target slice for which the context has been saved by the three-dimensional data encoding device matches a target slice for which the context has been saved by the three-dimensional data decoding device. If the check finds that these slices do not match, the three-dimensional data decoding device may determine that conformance condition is violated (or nonconformance to specifications). The conformance specifications for bitstreams define requirements for bitstreams generated by an encoder to be correctly decoded by a decoder, and may therefore be regarded as specifications for the decoder to recognize constraints regarding the encoding method used by the encoder. Specifying an encoding method that allows the decoder to correctly decode bitstreams as the conformance specifications of the bitstream and determining whether bitstreams conform to the specifications in the decoder thus make it possible to determine whether the bitstreams can be correctly decoded.

If different contexts are used for the parameter set referred to by DU_cur and the parameter set referred to by DU_prev due to switching of an encoding parameter, the three-dimensional data decoding device may determine the occurrence of conformance-condition is violated (or nonconformance to the specifications). Upon determining the occurrence of conformance-condition is violated (or nonconformance to the specifications), the three-dimensional data decoding device may stop decoding or may perform a specific avoidance process.

If the parameter set referred to by DU_cur and the parameter set referred to by DU_prev have different GPS_id or APS_id, the three-dimensional data decoding device may determine that conformance condition is violated (or nonconformance to the specifications).

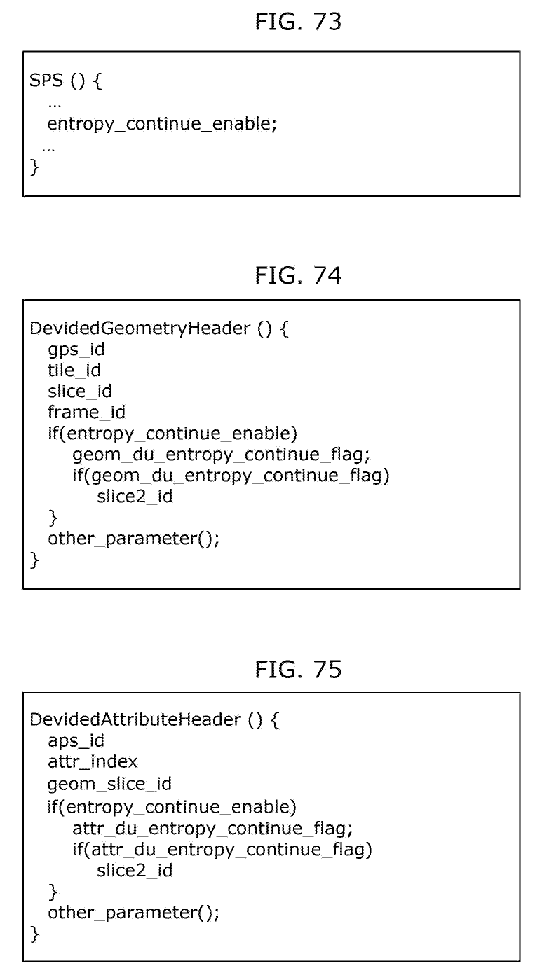

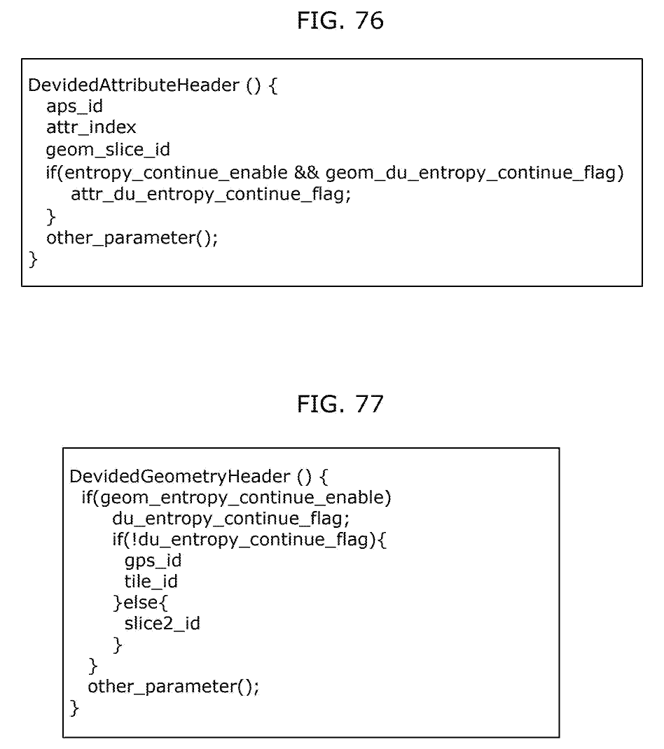

FIGS. 73 to 77 illustrate syntax examples. FIG. 73 illustrates an exemplary syntax of an SPS. FIG. 74 illustrates an exemplary syntax of the header (DevidedGeometryHeader) of divided geometry information. FIG. 75 is a diagram illustrating an exemplary syntax of the header (DevidedAttributeHeader) of divided attribute information. FIG. 76 is a diagram illustrating another exemplary syntax of the header (DevidedAttributeHeader) of the divided attribute information. FIG. 77 is a diagram illustrating another exemplary syntax of the header (DevidedGeometryHeader) of the divided geometry information.

The flag indicating whether to initialize the context for encoding has been represented above as cabac_init_flag. This flag is here represented as entropy_continue_flag. The definition of entropy_continue_flag, however, is reverse to that of cabac_init_flag. The initialization flag entropy_continue_flag indicates whether to continue entropy encoding without initialization, i.e., indicates that the context used for encoding the previous data unit is saved and applied to the next data unit.

As illustrated in FIG. 73, the SPS includes the flag entropy_continue_enable indicating whether the function of continuing the context from one data unit to another is present (used). The flag entropy_continue_enable is an example of third identification information.

As illustrated in FIG. 74, the header (DevidedGeometryHeader) of the divided geometry information includes the identifiers (gps_id), (tile_id), and (frame_id) of the GPS, tile, and frame, respectively, referred to by the data unit including this divided geometry information.

If entropy_continue_enable in the SPS is valid, (i.e., if entropy_continue_enable indicates the presence of the function of continuing the context), the header (DevidedGeometryHeader) of the divided geometry information indicates the flag geom_du_entropy_continue_flag. This flag indicates whether the data unit including this divided geometry information is encoded by continuously using the context used for encoding the previous data unit preceding that data unit. The header (DevidedGeometryHeader) of the divided geometry information thus includes the flag geom_du_entropy_continue_flag. Further, if geom_du_entropy_continue_flag is valid, the header (DevidedGeometryHeader) of the divided geometry information indicates the slice ID (slice2_id) to which the previous data unit belongs. The header (DevidedGeometryHeader) of the divided geometry information thus includes the slice ID (slice2_id). The flag geom_du_entropy_continue_flag is an example of first identification information.

As illustrated in FIG. 75, the header (DevidedAttributeHeader) of the divided attribute information includes: the identifier (aps_id) of the APS (attribute information parameter set) referred to by the data unit including this divided attribute information; the number (attr_index) of this attribute information in the order of the attribute information items described in the SPS; and the slice ID (geom_slice_id) of the geometry information corresponding to this attribute information.

If entropy_continue_enable in the SPS is valid (i.e., if entropy_continue_enable indicates the presence of the function of continuing the context), the header (DevidedAttributeHeader) of the divided attribute information shows the flag attr_du_entropy_continue_flag. This flag indicates whether the data unit including this divided attribute information is encoded by continuously using the context used for encoding the previous data unit preceding that data unit. The header (DevidedAttributeHeader) of the divided attribute information thus includes the flag attr_du_entropy_continue_flag. Further, if attr_du_entropy_continue_flag is valid, the header (DevidedAttributeHeader) of the divided attribute information shows the slice ID (slice2_id) to which the previous data unit belongs. The header (DevidedAttributeHeader) of the divided attribute information thus includes the slice ID (slice2_id). The flag geom_du_entropy_continue_flag is an example of the first identification information.

As described above, if entropy_continue_enable in the SPS is valid (i.e., if entropy_continue_enable indicates the presence of the function of continuing the context), the header (DevidedGeometryHeader) of the divided geometry information includes the flag geom_du_entropy_continue_flag, and the header (DevidedAttributeHeader) of the divided attribute information includes the flag attr_du_entropy_continue_flag. The three-dimensional data encoding device may determine whether to perform context-based encoding (second determination). If the three-dimensional data encoding device determines to perform context-based encoding, the device may determine whether to encode the current data unit by continuously using the context used to encode the previous data unit preceding the current data unit (first determination). In this case, the three-dimensional data encoding device generates a bitstream that includes entropy_continue_enable (the third identification information) indicating whether context-based encoding is performed. If entropy_continue_enable (the third identification information) indicates that context-based encoding is performed, the header of the data unit indicates geom_du_entropy_continue_flag (the first identification information) or attr_du_entropy_continue_flag (the first identification information).

As above, the header of the divided geometry information and the header of the divided attribute information include geom_du_entropy_continue_flag and attr_du_entropy_continue_flag, respectively. This enables determining whether to continue the context individually for the geometry information and the attribute information, thereby enabling flexible control.

As illustrated in FIG. 76, the flag indicating whether to continue the context used to encode the attribute information (attr_du_entropy_continue_flag) may be determined to be valid if entropy encoding of the geometry information is continued. If this flag is valid, the header (DevidedAttributeHeader) of the divided attribute information may indicate whether entropy encoding of the data unit of this attribute information is valid.

Thus, if the three-dimensional data encoding device determines to continuously use the context used to encode the previous data unit, the three-dimensional data encoding device may (i) encode the geometry information on the current data unit by continuously using the context used to encode the geometry information on the previous data unit, and (ii) encode the attribute information on the current data unit by continuously using the context used to encode the attribute information on the previous data unit. Then, in the three-dimensional data decoding device, if the first identification information indicates that the context used to encode the previous data unit is continuously used, the three-dimensional data decoding device may (i) calculate the geometry information on the three-dimensional points in the data unit by decoding the data unit while continuously using the context used to encode the geometry information on the previous data unit, and (ii) calculate the attribute information on the three-dimensional points in the data unit by decoding the data unit while continuously using the context used to encode the attribute information on the previous data unit.

Alternatively, if entropy_continue_enable is true, attr_du_entropy_continue_flag may be set in the header (DevidedAttributeHeader) of the divided attribute information. Then, if geom_du_entropy_continue_flag is false, attr_du_entropy_continue_flag may be set to false irrespective of the value of attr_du_entropy_continue_flag.

Alternatively, it may be specified that conformance condition is violated (or nonconformance to the specifications) if geom_du_entropy_continue_flag is false and if attr_du_entrpy_continue_flag is true.

Note that controlling the geometry information encoding and controlling the attribute information encoding may be integrated. That is, geom_du_entropy_continue_flag and attr_du_entropy_continue_flag may be merged. In this case, the header of the divided attribute information does not need to indicate attr_du_entropy_continue_flag. In entropy encoding of the divided attribute information, whether to continue the context used to encode the previous data unit is determined according to du_entropy_continue_flag indicated in the data unit header of the geometry information corresponding to geom_slice_id.

If DU_cur and DU_prev refer to the same parameter sets, DU_cur does not need to indicate the parameter set IDs (GPS_id and APS_id). The three-dimensional data decoding device may refer to DU_prev indicated in the header of DU_cur and then refer to the parameter sets having the parameter set IDs indicated in the header of DU_prev.

If DU_cur and DU_prev are defined to belong to the same tile, tile_id does not need to be indicated. That is, the header of the divided geometry information does not need to include tile_id. This can reduce the processing of determining whether DU_cur and DU_prev are the same. This can also prevent confusion such as indicating that entropy encoding is being continued even though the context has been switched.

It may be specified that at least one of gps_id and tile_id is indicated if du_entropy_continue_flag is false, and such that neither gps_id nor tile_id is indicated if du_entropy_continue_flag is true.

The flag geom_entropy_continue_enable_flag indicates whether to continue the context of entropy encoding. It may be specified that the following condition 1 or 2 needs to be satisfied for geom_entropy_continue_enable_flag to be set to true. Condition 1 is that mutual encoding dependence of slices (data units) is permitted. Condition 2 is that reordering of slices (data units) is not permitted.

The order of slices (data units) may be indicated by, for example, the IDs of the data units (slice IDs). The IDs of data unis may be IDs (numbers) for identifying the data units on a one-frame basis, or may be IDs (numbers) for identifying the data units on a random access unit basis. A lead data unit in a random access unit is assigned a predetermined ID (a predetermined number). Each data unit is thus assigned a sequential number of the data unit in the random access unit. If the three-dimensional data encoding device determines to continuously use the context used for encoding the previous data unit, the three-dimensional data encoding device does not need to reorder data units in order to satisfy condition 2. In this case, the three-dimensional data encoding device may further generate a bitstream that includes second identification information indicating whether to permit reordering of data units in the random access unit. If du_entropy_continue_flag (the first identification information) indicates that the context is not continuously used and if the second identification information indicates that reordering is not permitted, the three-dimensional data decoding device may determine that the bitstream obtained satisfies the conformance condition. If du_entropy_continue_flag (the first identification information) indicates that the context is not continuously used or if the second identification information indicates that reordering is permitted, the three-dimensional data decoding device may determine that the bitstream obtained does not satisfy the conformance condition.

In this case, whether geom_entropy_continue_enable_flag is valid may be indicated if condition 1 or 2 is satisfied. Alternatively, the violation of conformance condition (or nonconformance to the specifications) may be determined if geom_entropy_continue_enable_flag is true and condition 1 or 2 is not satisfied. Further, geom_entropy_continue_enable_flag and the flag indicating condition 1 or 2 may be merged and replaced with any of the flags.

It may be specified that, if the current data unit is the lead data unit in the random access unit, du_entropy_continue_flag should be set to false on a random access basis. That is, in this case, the three-dimensional data encoding device may determine not to continuously use the context used to encode the previous data unit. If the current data unit is not the lead data unit in the random access unit, the three-dimensional data encoding device may determine to continuously use the context used to encode the previous data unit.

If du_entropy_continue_flag (the first identification information) indicates that the context used to encode the previous data unit is not continuously used and if the data unit is the lead data unit in the random access unit, the three-dimensional data decoding device may determine that the bitstream satisfies the conformance condition. That is, if the data unit is the lead data unit in the random access unit, the three-dimensional data decoding device determines that the conformance condition for the bitstream is that (i.e., is satisfied if) the first identification information indicates that the context used to encode the previous data unit is not continuously used. If du_entropy_continue_flag (the first identification information) indicates that the context used to encode the previous data unit is continuously used or if the data unit is not the lead data unit in the random access unit, the three-dimensional data decoding device may determine that the bitstream does not satisfy the conformance condition.

For example, the random access unit may be on a one-frame basis. In this case, the three-dimensional data encoding device may determine to encode a lead slice (data unit) in a frame without continuously using the context used to encode the previous data unit. If du_entropy_continue_flag (the first identification information) indicates that the context used to encode the previous data unit is not continuously used and if the data unit is the lead data unit in the frame, the three-dimensional data decoding device may determine that the bitstream satisfies the conformance condition.

As another example, the random access unit may be on a multi-frame basis, or a GOF (Group Of Frames). In this case, the three-dimensional data encoding device may determine to encode the lead slice (data unit) in the GOF without continuously using the context used to encode the previous data unit. If du_entropy_continue_flag (the first identification information) indicates that the context used to encode the previous data unit is not continuously used and if the data unit is the lead data unit in the GOF, the three-dimensional data decoding device may determine that the bitstream satisfies the conformance condition.

The random access unit may also be on a one-tile basis. In this case, the three-dimensional data encoding device may determine to encode the lead slice (data unit) in a tile without continuously using the context used to encode the previous data unit. If du_entropy_continue_flag (the first identification information) indicates that the context used to encode the previous data unit is not continuously used and if the data unit is the lead data unit in the tile, the three-dimensional data decoding device may determine that the bitstream satisfies the conformance condition.

A parameter set or a header referred to by a data unit may include a random access point flag indicating whether the data unit is the lead data unit (a random access point). If the random access point flag indicates that the data unit is the lead data unit, du_entropy_continue_flag may be valid in the header (i.e., may be included in the header). Further, du_entropy_continue_flag and the random access point flag may be merged.

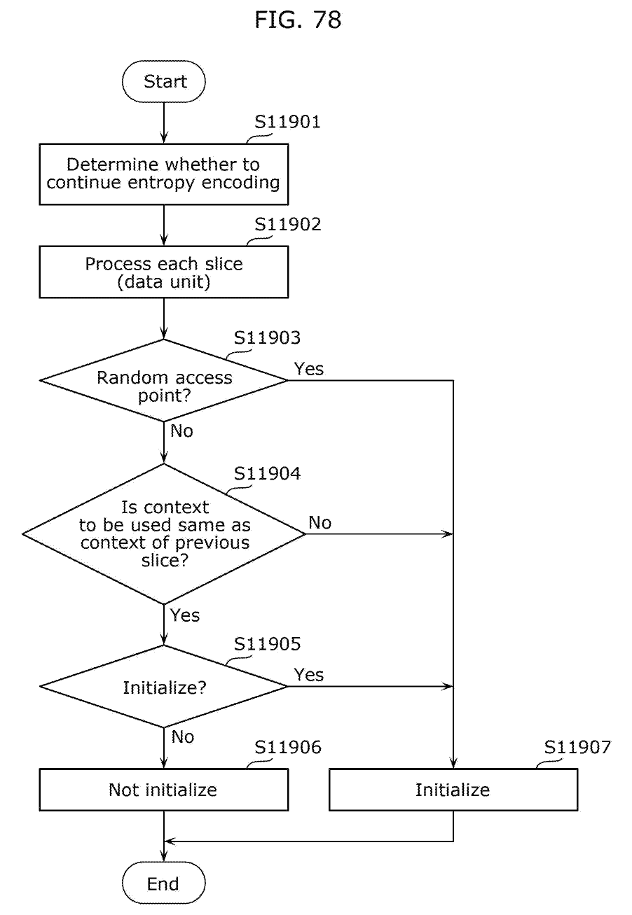

FIG. 78 is a flowchart illustrating an example of first determination for determining whether to initialize entropy encoding in the three-dimensional data encoding device.

The three-dimensional data encoding device determines whether to continue entropy encoding (S11901).

The three-dimensional data encoding device processes each slice (data unit) (S11902).

The three-dimensional data encoding device determines whether the current slice is the random access point (S11903). The random access point is the lead slice in a frame if random access on a one-frame basis is possible, or is the lead slice in a GOF if random access on a multi-frame (GOF) basis is possible, or is the lead slice in a tile if random access on a tile basis is possible.

If the three-dimensional data encoding device determines that the current slice is not the random access point (No at S11903), the three-dimensional data encoding device determines whether the context to be used to encode the current slice is the same as the context used to encode the previous slice (S11904). The three-dimensional data encoding device may determine whether to use a different context (i.e., the context is not the same) based on, for example, a flag indicating whether the tree structure is octree or prediction tree, a flag indicating whether binary tree or quadtree is used, or a flag indicating whether a bitwise context is used.

If the three-dimensional data encoding device determines that the context to be used to encode the current slice is the same as the context used to encode the previous slice (Yes at S11904), the three-dimensional data encoding device determines whether to initialize the context (S11905).

If the three-dimensional data encoding device determines not to initialize the context (No at S11905), the three-dimensional data encoding device determines to continuously use the context without initializing the context (S11906).

If the three-dimensional data encoding device determines that the current slice is the random access point (Yes at S11903), or determines that the context to be used to encode the current slice is not the same as the context used to encode the previous slice (No at S11904), or determines to initialize the context (Yes at S11905), the three-dimensional data encoding device determines to initialize (i.e., not to continue) the context (S11907).

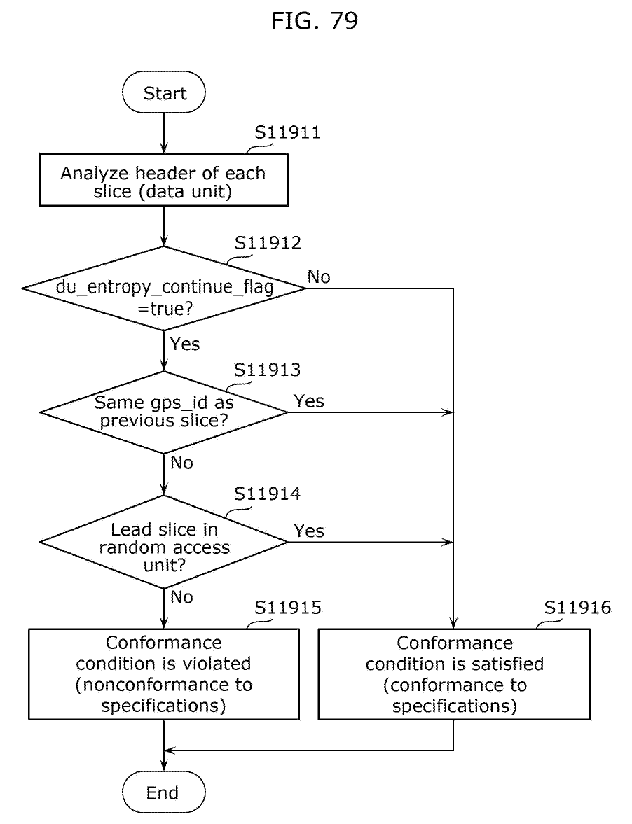

FIG. 79 is a flowchart illustrating an exemplary process of determining whether a flag of entropy encoding satisfies the conformance condition (conforms to the specifications) in the three-dimensional data decoding device.

The three-dimensional data decoding device analyzes the header of each slice (data unit) (S11911).

The three-dimensional data decoding device determines whether du_entropy_continue_flag (the first identification information) is true (S11912).

If the three-dimensional data decoding device determines that du_entropy_continue_flag (the first identification information) is true (Yes at S11912), the three-dimensional data encoding device determines whether the identifier (gps_id) of the GPS referred to by the current slice is the same as the identifier (gps_id) of the GPS referred to by the previous slice (S11913).

If the three-dimensional data decoding device determines that the identifier (gps_id) of the GPS referred to by the current slice is not the same as the identifier (gps_id) of the GPS referred to by the previous slice (No at S11913), the three-dimensional data decoding device determines whether the current slice is the lead slice in the random access unit (S11914). For frame-based random access, the three-dimensional data decoding device may determine a frame boundary based on detection of a data unit indicating a frame boundary, or on detection of a change in frame index.

If the three-dimensional data decoding device determines that the current slice is not the lead slice in the random access unit (No at S11914), the three-dimensional data decoding device determines that the conformance condition is violated (nonconformance to the specifications) (S11915).

If the three-dimensional data decoding device determines that du_entropy_continue_flag (the first identification information) is not true (i.e., is false) (No at S11912), or determines that the identifier (gps_id) of the GPS referred to by the current slice is the same as the identifier (gps_id) of the GPS referred to by the previous slice (Yes at S11913), or determines that the current slice is the lead slice in the random access unit (Yes at S11914), the three-dimensional data decoding device determines that the conformance condition is satisfied (conformance to the specifications) (S11916).

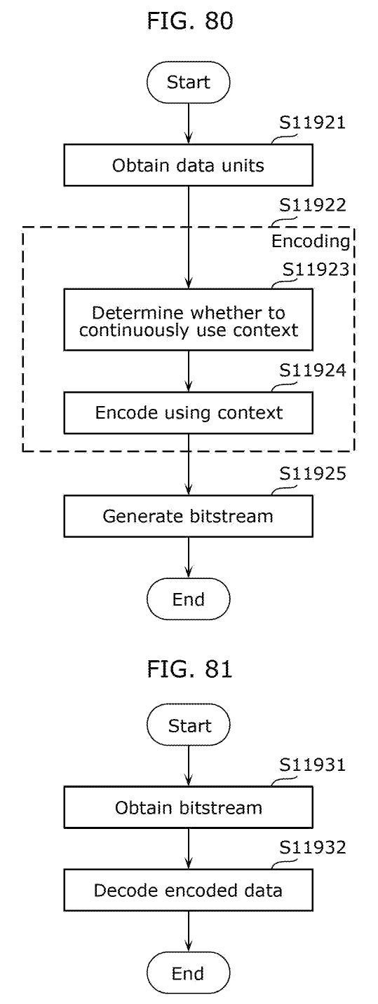

As stated above, the three-dimensional data encoding device according to one aspect of the present embodiment performs the process shown in FIG. 80. The three-dimensional data encoding device obtains a data unit including three-dimensional points (S11921). Next, the three-dimensional data encoding device encodes the three-dimensional points included in the data unit (S11922). The three-dimensional data encoding device generates a bitstream including encoded data obtained by encoding the data unit (S11925). In the encoding (S11922), the three-dimensional data encoding device makes a first determination for determining whether to continuously use a context to encode the data unit (S11923), the context being used in encoding a previous data unit preceding the data unit. Then, the three-dimensional data encoding device encodes the data unit using a context according to a result of the first determination after S11923 (S11924). In n the first determination (S11923), when the data unit is a lead data unit in a random access unit, the three-dimensional data encoding device determines not to continuously use the context used in encoding the previous data unit.

Accordingly, if the current data unit is the lead data unit in the random access unit, determination is made not to continuously use the context used in encoding the previous data unit. This enables a three-dimensional data decoding device to appropriately decode the bitstream.

For example, the random access unit is one frame unit.

For example, the random access unit is frame units.

For example, the random access unit is one tile unit.

For example, the data unit is assigned a sequential number in the random access unit. When it is determined to continuously use the context used in encoding the previous data unit in the first determination (S11923), the three-dimensional data encoding device does not reorder sequential numbers of data units in the random access unit.

For example, in the encoding, the three-dimensional data encoding device further makes a second determination for determining whether to perform encoding continuously using the context used in encoding the previous data unit. When it is determined to perform the encoding using the context used in encoding the previous data unit in the second determination, the three-dimensional data encoding device makes the first determination (S11923).

For example, each of the three-dimensional points includes geometry information and attribute information. In the encoding (S11922), when it is determined to continuously use the context used in encoding the previous data unit in the first determination (S11923), the three-dimensional data encoding device (i) encodes geometry information of the data unit continuously using a context used in encoding geometry information of the previous data unit, and (ii) encodes attribute information of the data unit continuously using a context used in encoding attribute information of the previous data unit.

For example, the three-dimensional data encoding device includes a processor and memory, and the processor performs the above process using the memory.

The three-dimensional data decoding device according to one aspect of the present embodiment performs the process shown in FIG. 81. The three-dimensional data decoding device obtains a bitstream including encoded data and first identification information (S11931), the encoded data being obtained by encoding a data unit including three-dimensional points, the first identification information indicating whether a context is to be continuously used to encode the data unit, the context being used in encoding a previous data unit preceding the data unit. The three-dimensional data decoding device decodes the encoded data using a context according to the first identification information (S11932). In the decoding (S11932), when the data unit is a lead data unit in a random access unit, the three-dimensional data decoding device determines that the first identification information indicating that the context used in encoding the previous data unit is not to be continuously used is a conformance condition for the bitstream (i.e., satisfies a conformance condition for the bitstream).

Thus, if the three-dimensional data decoding device determines that the conformance condition is satisfied, the three-dimensional data decoding device can appropriately decode the bitstream, for example by continuing the decoding. If the three-dimensional data decoding device determines that the conformance condition is not satisfied, the three-dimensional data decoding device can prevent inappropriate decoding of the bitstream, for example by stopping the decoding or performing a specific avoidance process.

For example, the random access unit is one frame unit.

For example, the random access unit is frame units.

For example, the random access unit is one tile unit.

For example, the data unit is assigned a sequential number in the random access unit. For example, the bitstream further includes second identification information indicating whether reordering of sequential numbers of data units in the random access unit is to be permitted. In the decoding (S11932), when the first identification information indicates that the context is not to be continuously used, and the second identification information indicates that the reordering of the sequential numbers is not to be permitted, the three-dimensional data decoding device determines that the bitstream satisfies the conformance condition.

For example, the bitstream further includes third identification information indicating whether encoding is to be performed using the context. When the third identification information indicates that the encoding is to be performed using the context, the first identification information is indicated by a header of the data unit.

For example, the encoded data includes geometry information and attribute information of the three-dimensional points encoded. In the decoding (S11932), when the first identification information indicates that the context used in encoding the previous data unit is to be continuously used, the three-dimensional data decoding device (i) calculates the geometry information of the three-dimensional points included in the data unit by performing decoding continuously using a context used in encoding geometry information of the previous data unit, and (ii) calculates the attribute information of the three-dimensional points included in the data unit by performing decoding continuously using a context used in encoding attribute information of the previous data unit.

For example, the three-dimensional data decoding device includes a processor and memory, and the processor performs the above process using the memory.

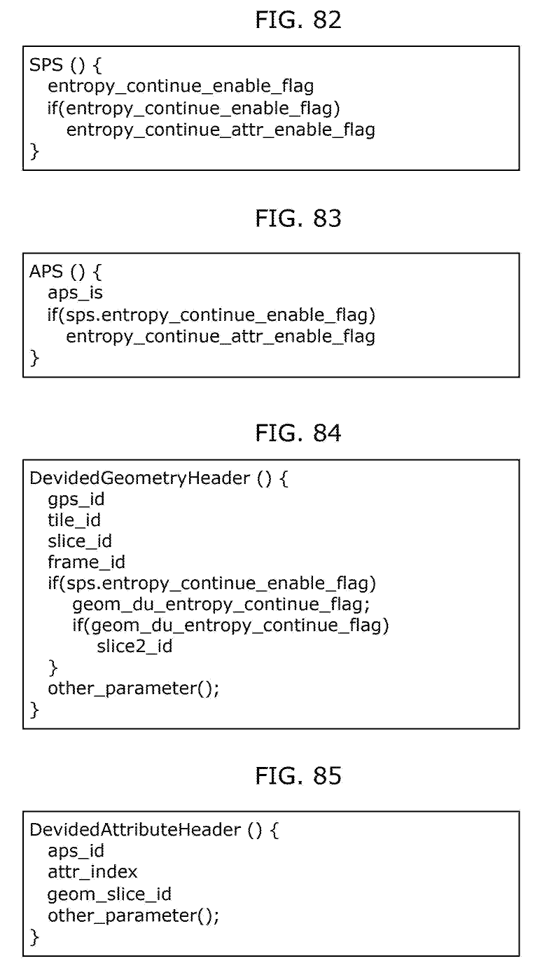

In the present embodiment, another example of the entropy encoding will be described. FIG. 82 is a diagram illustrating an example syntax of an SPS. FIG. 83 is a diagram illustrating an example syntax of an APS. FIG. 84 is a diagram illustrating an example syntax of a header of divided geometry information (DevidedGeometryHeader). FIG. 85 is a diagram illustrating an example syntax of a header of divided attribute information (DevidedAttributeHeader).

In the entropy encoding, a switching flag (identification information) for switching whether to enable a function of continuing context used for the entropy encoding for each data unit of attribute information may be provided.

The switching flag may be provided in a parameter set (SPS or APS) referred to by attribute information. Specifically, the switching flag (entropy_continue_attr_enable_flag) may be provided in an SPS as illustrated in FIG. 82 or may be provided in an APS as illustrated in FIG. 83. The entropy_continue_attr_enable_flag is a flag indicating whether to enable the function of continuing context used for encoding attribute information. The entropy_continue_attr_enable_flag may be provided in a case where an entropy_continue_enable_flag provided in an SPS is true. The entropy_continue_enable_flag is a flag indicating whether to enable a function of continuing context. An Sps.entropy_continue_enable_flag illustrated in FIG. 83 means entropy_continue_enable_flag that is signaled in an SPS.

Further, as illustrated in FIG. 84, a flag (geom_du_entropy_continue_flag) indicating whether to continue context for each data unit may be provided in a header of divided geometry information (DevidedGeometryHeader). Further, as illustrated in FIG. 85, information regarding continuation of context in a header of divided attribute information (DevidedAttributeHeader) need not be provided.

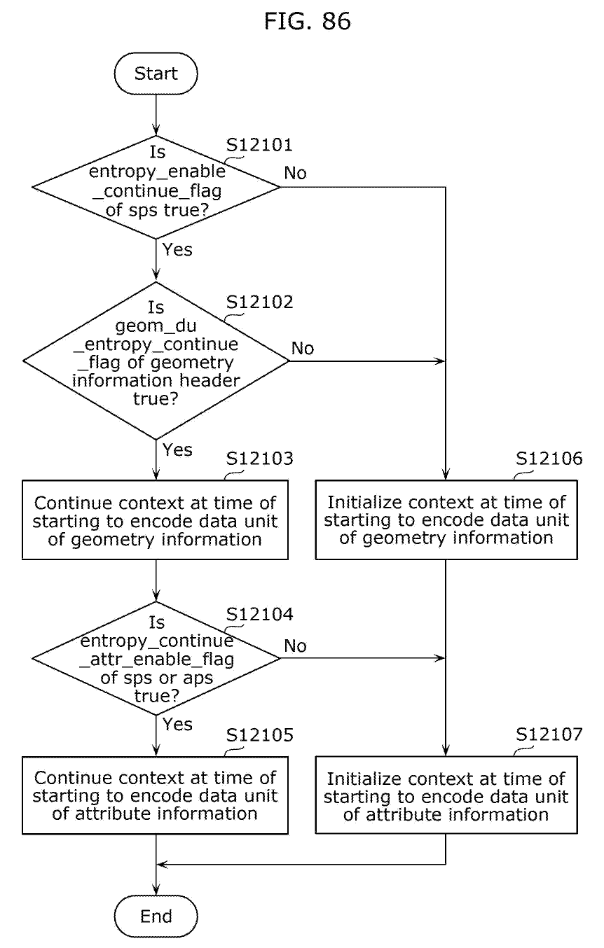

Using the syntax illustrated in FIG. 82 to FIG. 85, a continuous flag for each data unit (geometry information and attribute information) may be calculated as illustrated in a flowchart in FIG. 86. FIG. 86 is a flowchart illustrating an example of a process of determining whether to continue context used for entropy encoding in a three-dimensional data encoding device.

First, the three-dimensional data encoding device determines whether an entropy_continue_enable_flag of an SPS indicates true (S12101).

When the entropy_continue_enable_flag of the SPS indicates true (Yes in S12101), the three-dimensional data encoding device determines whether a geom_du_entropy_continue_flag in a header of divided geometry information (DevidedGeometryHeader) is true (S12102).

In a case where the geom_du_entropy_continue_flag in the header of the divided geometry information (DevidedGeometryHeader) indicates true (Yes in S12102), the three-dimensional data encoding device determines to use, at the time of starting to encode a data unit of geometry information, context that is saved (retained or stored) in a storage device (memory) for a data unit of previous geometry information (S12103). That is, the three-dimensional data encoding device determines in this case to use the context used for encoding the data unit of the previous geometry information continuously.

Next, the three-dimensional data encoding device determines whether an entropy_continue_attr_enable_flag in the SPS or an APS is true (S12104).

In the case where the entropy_continue_attr_enable_flag in the SPS or the APS indicates true (Yes in S12104), the three-dimensional data encoding device determines to use, at the time of starting to encode a data unit of attribute information, context that is saved in the storage device (memory) for a data unit of previous attribute information (S12105). That is, the three-dimensional data encoding device determines in this case to use the context used for encoding the data unit of the previous attribute information continuously.

When the entropy_continue_enable_flag of the SPS indicates false (No in S12101) or when the geom_du_entropy_continue_flag in the header of the divided geometry information (DevidedGeometryHeader) indicates false (No in S12102), the three-dimensional data encoding device determines to initialize the context at the time of starting to encode the data unit of geometry information (S12106). That is, the three-dimensional data encoding device determines in this case not to use the context used for encoding the data unit of the previous geometry information continuously but initialize the context.

When the entropy_continue_attr_enable_flag of the SPS or the APS indicates false (No in S12104) or after step S12106, the three-dimensional data encoding device determines to initialize the context at the time of starting to encode the data unit of the attribute information (S12107). That is, the three-dimensional data encoding device determines in this case not to use the context used for encoding the data unit of the previous attribute information continuously but initialize the context.

Providing an entropy_continue_attr_enable_flag in an SPS enables the three-dimensional data encoding device to perform control on all attribute components in common such as all colors and reflectivities. Providing an entropy_cotinue_attr_enable_flag in an APS enables the three-dimensional data encoding device to perform control on all attribute components in common such as color and reflectivity.

The determination of whether to continue context for a data unit of attribute information may depend on a result of the determination of whether to continue context for each data unit of geometry information. In this case, a possible combination (Gometry DU, Attribute DU) of whether to continue context for a data unit of geometry information (ON/OFF) and whether to continue context for a data unit of attribute information (ON/OFF) may be any one of (ON, ON), (ON, OFF), and (OFF, OFF).

In the entropy encoding, coding performance can be improved by saving context used for encoding a previous data unit or a data unit in the storage device (memory) and applying the context saved in the storage device (memory) to the encoding of the next data unit. In a case where the entropy encoding is performed bitwise, and bitwise context is used, there is entropy context to be continued in the bitwise entropy encoding. However, in a case where the entropy encoding is performed bytewise, there is no entropy context to be continued in the bytewise entropy encoding because there is no bytewise context. Thus, the methods described above do not include a method for continuing bytewise entropy encoding.

In the present embodiment, a method for continuing entropy encoding in a case where an occupancy code is encoded bytewise in the encoding of geometry information using an N-ary tree (N is an integer greater than or equal to two; e.g., octree) will be described. Further, a method for switching between methods for continuing the entropy encoding based on an encoding scheme (bitwise encoding or bytewise encoding) will be described.

In the bytewise encoding, the three-dimensional data encoding device uses a lookup table to convert an occupancy code into index information in the table and encodes the converted index information. Here, as described in the above embodiment, the occupancy code is 8-bit information that indicates at which position in octree representation of a three-dimensional point cloud after the division one node has the next node or leaf. Hereafter, the occupancy code may be also called an occupancy map. Hereinafter, the occupancy code will be referred to as an occupancy map.

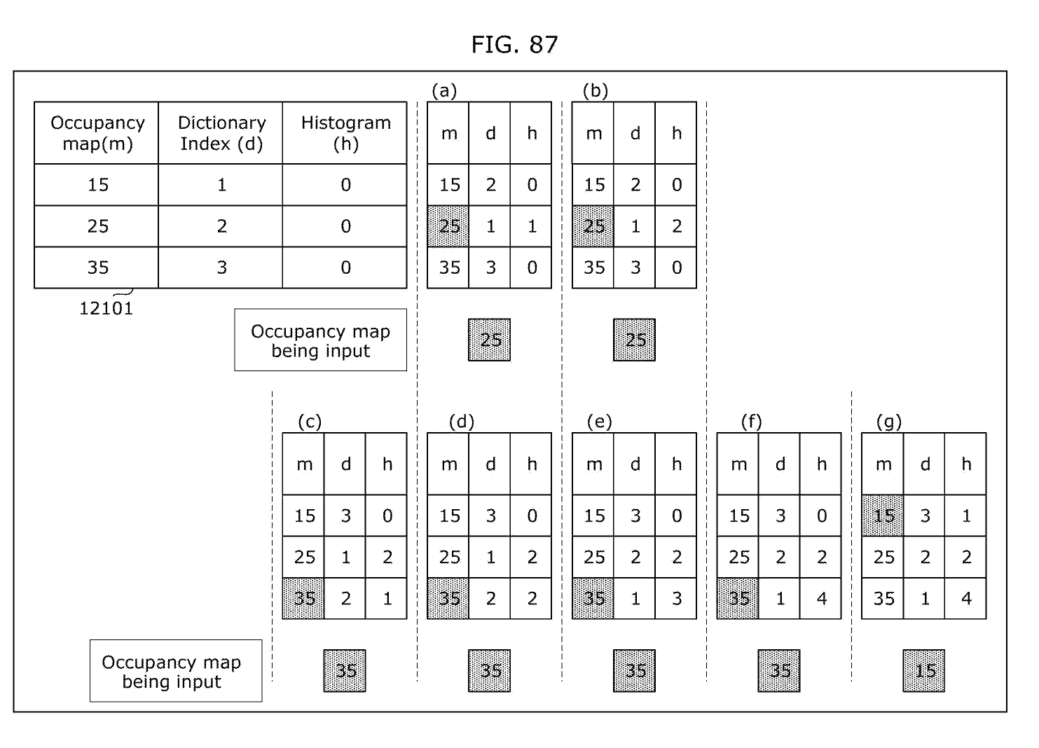

FIG. 87 is a diagram for describing how to update the table.

Using table 12101 illustrated in FIG. 87, the three-dimensional data encoding device converts the occupancy map into a table indicating a relation between a histogram that shows total numbers of occurrences of occupancy maps and a dictionary index that shows an order of the total numbers of occurrences. In FIG. 87, the occupancy map is denoted as m, the dictionary index is denoted as d, and the histogram is denoted as h. Although FIG. 87 illustrates an example of the table of three occupancy maps: 15, 25, or 35. However, the table is not limited to this and may be of four or more occupancy maps.

The three-dimensional data encoding device updates the table every time an occupancy map is encoded. When encoding an occupancy map, the three-dimensional data encoding device adds one to a value corresponding to the occupancy map in the histogram. For example, as illustrated in (a) of FIG. 87, when an input occupancy map indicates 25, the three-dimensional data encoding device adds one to a value corresponding to an occupancy map of 25 in the histogram.

Next, based on the updated histogram, the three-dimensional data encoding device updates the dictionary index. That is, based on the updated total numbers of occurrences of occupancy maps, the three-dimensional data encoding device gives (sets) the order of the total numbers of occurrences in the form of the dictionary index. Note that the dictionary index is only required to indicate a total number of occurrences of an occupancy map or an occurrence frequency of an occupancy map.

For example, as illustrated in (a) of FIG. 87, after updating a value in the histogram, the three-dimensional data encoding device sets 2 to an index corresponding to an occupancy map of 15, sets 1 to an index corresponding to an occupancy map of 25, and sets 3 to an index corresponding to an occupancy map of 35 so as to give indexes in descending order of values in the updated histogram. Note that the value of an occupancy map of 15 in the histogram and the value of an occupancy map of 35 in the histogram are the same, and in this case, a smaller value may be set to an index of a smaller occupancy map. This is not limitative; a larger value may be set to the index of a smaller occupancy map.

In (b) of FIG. 87, an occupancy map of 25 is input, in each of (c) to (f) of FIG. 87, an occupancy map of 35 is input, and in (g) of FIG. 87, an occupancy map of 15 is input. When each of the occupancy maps is input, the three-dimensional data encoding device adds one to a value corresponding to the input occupancy map in the histogram and gives the dictionary index in descending order of calculated values in the histogram. Therefore, a smaller value of an occupancy map in the dictionary index means that the occupancy map has a higher occurrence frequency (input frequency).

Next, the three-dimensional data encoding device encodes index information indicating the dictionary index being set. In the bytewise encoding, the three-dimensional data encoding device can reduce code amount by converting occupancy maps into index information.

In this manner, the three-dimensional data encoding device derives index information for occupancy maps using the table and encodes the derived index information. The three-dimensional data encoding device then updates the table saved in the storage device (memory) to a table indicating a relation between the updated histogram and the index being set.

From an encoded bitstream, the three-dimensional data decoding device decodes index information included in the encoded bitstream and derives occupancy maps using a table saved in a storage device (memory) by the same method as used by the three-dimensional data encoding device. The three-dimensional data decoding device then updates the table by the same method as used by the three-dimensional data encoding device.

The histogram and the index information in the table may be updated until the encoding of occupancy maps in a slice (data unit) is completed and may be initialized at the beginning of the next slice. Further, the table used at the end of a slice may be stored, and the stored table may be continuously used in the encoding of the next slice. In the bytewise entropy encoding, a table that is learned for a previous slice is continuously used in the encoding of the next slice, from which the improvement in the encoding can be expected. As seen from the above, the bitwise encoding and the bytewise encoding are different from each other in that context is continuously used in the bitwise encoding, while a table is continuously used in the bytewise encoding.

Although the description is given with the bytewise encoding taken as an example, this is not limitative. The technique is also applicable to a case where a table is used for a histogram (occupancy map, etc.) for counting occurrences of values, rather than using context, and applicable to another type of additional information that is used for the encoding, such as learning parameters. Further, the technique is applicable not only to the encoding of geometry information but also to the encoding of attribute information. Even in a case where additional information is saved in a storage device (memory), and the saved additional information is applied to the next data unit, the improvement in coding efficiency can be expected.

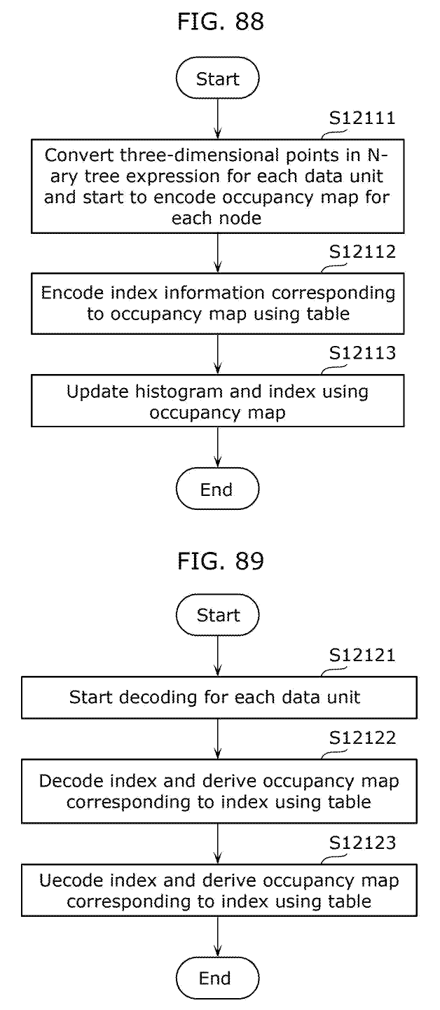

FIG. 88 is a flowchart of encoding an occupancy map by the three-dimensional data encoding device.

For each data unit, the three-dimensional data encoding device converts three-dimensional points into N-ary tree expression and starts the encoding of an occupancy map for each node (S12111). For each of three-dimensional points included in a data unit to be processed, the three-dimensional data encoding device generates occupancy maps by converting geometry information of the three-dimensional point into N-ary tree expression (e.g., octree representation). That is, the three-dimensional data encoding device uses an octree to convert geometry information items on the three-dimensional points in the data unit to be encoded into a plurality of occupancy maps.

Next, the three-dimensional data encoding device uses the table to generate index information items corresponding to occupancy maps and encodes the generated index information items (S12112). The three-dimensional data encoding device converts each of the occupancy maps into an index using a table that indicates a correspondence relation between occupancy maps and indexes and encodes the indexes to generate encoded data.

Next, the three-dimensional data encoding device updates the histogram and the indexes using the occupancy maps, thus updating a table saved in a storage device (memory) (S12113). The three-dimensional data encoding device updates the table based on the converted index and stores the table in the memory.

FIG. 89 is a flowchart of decoding an occupancy map by the three-dimensional data decoding device.

For each data unit in a bitstream, the three-dimensional data decoding device starts a decoding process (S12121). The bitstream includes, for example, encoded data obtained by encoding a data unit including three-dimensional points and first identification information indicating whether a table used in encoding a data unit preceding the data unit is to be initialized and used to encode the data unit.

Next, the three-dimensional data decoding device decodes encoded index information items included in a bitstream and uses the decoded index information items and a table saved in a storage device (memory) to derive occupancy maps corresponding to indexes indicated by the index information items (S12122). That is, the three-dimensional data decoding device calculates the geometry information of the three-dimensional points by deriving an occupancy map corresponding to, in the table, the index obtained by decoding the encoded data.

Next, the three-dimensional data decoding device updates the histogram and the indexes using the occupancy maps, thus updating the table saved in the storage device (memory) (S12123).

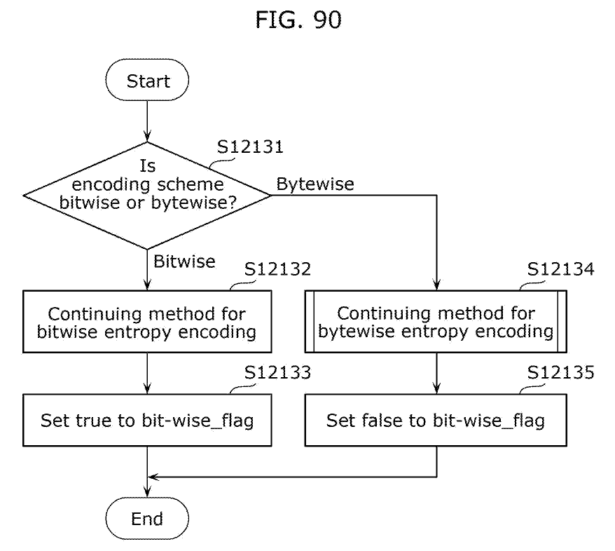

FIG. 90 is a flowchart of a process of switching between entropy encoding schemes in the three-dimensional data encoding device.

The three-dimensional data encoding device determines the encoding scheme is bitwise or bytewise (S12131).

When determining the encoding scheme is bitwise ("bitwise" in S12131), the three-dimensional data encoding device performs the encoding by a continuing method for the bitwise entropy encoding (S12132).

The three-dimensional data encoding device sets true to a flag (bit-wise_flag) indicating whether the encoding scheme is bitwise or not (bytewise) (S12133). The three-dimensional data encoding device generates a bitstream including the flag and transmits the bitstream to the three-dimensional data decoding device.

When determining the encoding scheme is bytewise ("bytewise" in S12131), the three-dimensional data encoding device performs the encoding by a continuing method for the bytewise entropy encoding (S12134).

The three-dimensional data encoding device sets false to a flag (bit-wise_flag) indicating whether the encoding scheme is bitwise or not (bytewise) (S12133). The three-dimensional data encoding device generates a bitstream including the flag and transmits the bitstream to the three-dimensional data decoding device.

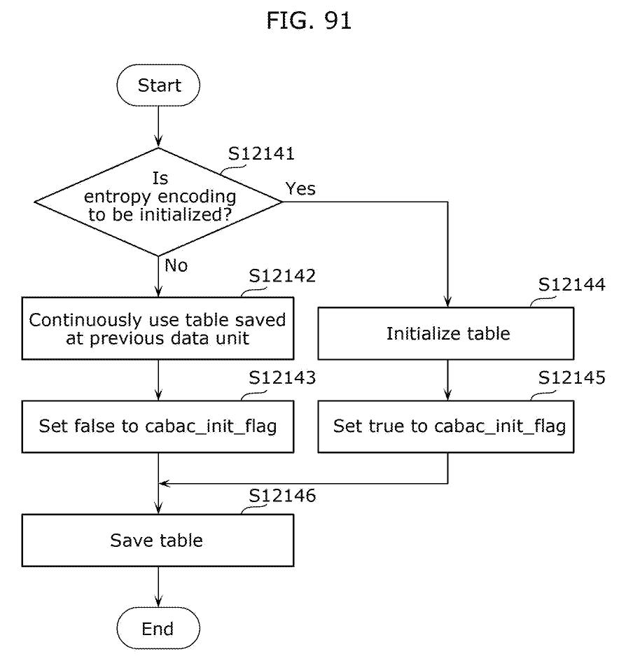

FIG. 91 is a flowchart of the continuing method for the bytewise entropy encoding in the three-dimensional data encoding device.

The three-dimensional data encoding device determines whether to initialize the entropy encoding (S12141). The three-dimensional data encoding device determines whether to initialize a table used for the bytewise entropy encoding, that is, whether to use the table continuously.

When determining not to initialize the entropy encoding (No in S12142), that is, when determining to use the table continuously, the three-dimensional data encoding device performs the encoding continuously using a table that is saved in a storage device (memory) in the encoding of a previous data unit (S12142).

Next, the three-dimensional data encoding device sets false to cabac_init_flag (S12143). That is, the three-dimensional data encoding device sets a value indicating that the table is used continuously to a flag (identification information) indicating whether the table is to be used continuously.

When determining to initialize the entropy encoding (Yes in S12142), that is, when determining not to use the table continuously, the three-dimensional data encoding device initializes the table saved in the storage device (memory) in the encoding of the previous data unit and performs the encoding (S12144).

Next, the three-dimensional data encoding device sets true to cabac_init_flag (S12145). That is, the three-dimensional data encoding device sets a value indicating that the table is not used continuously to a flag (identification information) indicating whether the table is to be used continuously.

The three-dimensional data encoding device updates the table based on the entropy encoding and saves the updated table in the storage device (memory) (S12146).

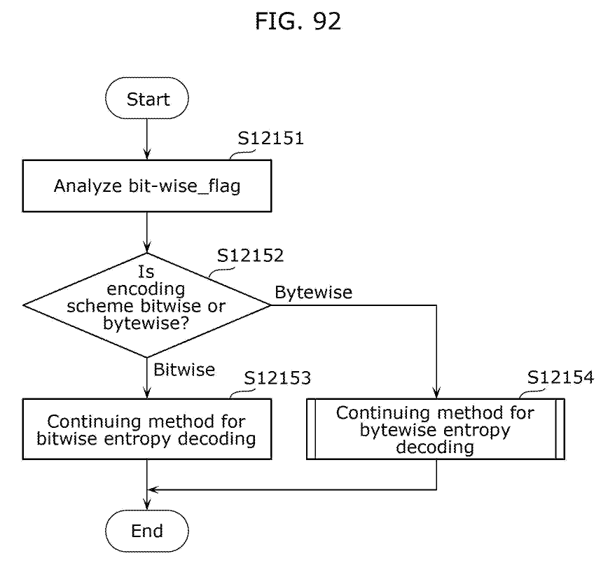

FIG. 92 is a flowchart of a process of switching between entropy decoding schemes in the three-dimensional data decoding device.

The three-dimensional data decoding device analyzes bit-wise_flag corresponding to a data unit to be decoded included in a bitstream (S12151).

Next, the three-dimensional data decoding device determines, as a result of the analysis, whether the encoding scheme of the data unit to be decoded is bitwise or bytewise (S12152). That is, the three-dimensional data decoding device determines whether bit-wise_flag corresponding to the data unit to be decoded indicates true.

When the encoding scheme of the data unit to be decoded is bitwise, that is, when bit-wise_flag indicates true, the three-dimensional data decoding device performs the decoding by the continuing method for bitwise entropy encoding (S12153).

When the encoding scheme of the data unit to be decoded is bytewise, that is, when bit-wise_flag indicates false, the three-dimensional data decoding device performs the decoding by the continuing method for bytewise entropy encoding (S12154).

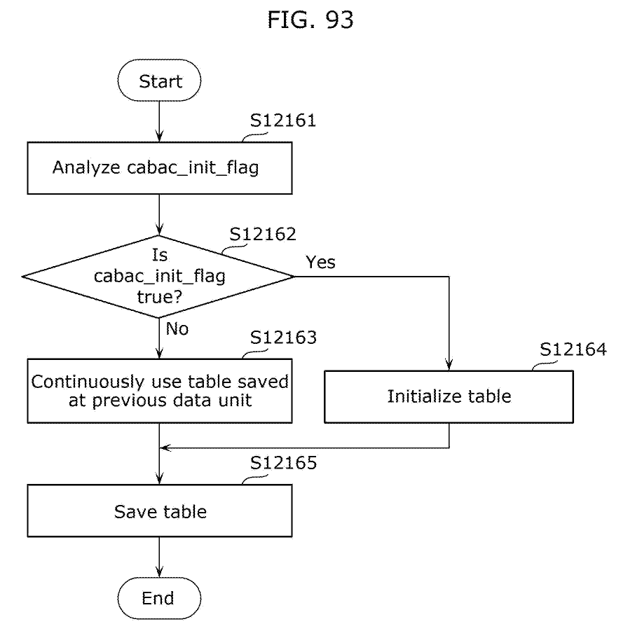

FIG. 93 is a flowchart of the continuing method for the bytewise entropy decoding in the three-dimensional data decoding device.

The three-dimensional data decoding device analyzes cabac_init_flag included in a bitstream (S12161).

Next, the three-dimensional data decoding device determines whether cabac_init_flag indicates true (S12162).

When cabac_init_flag indicates false (No in S12162), the three-dimensional data decoding device performs the decoding continuously using a table that is saved in a storage device (memory) in the decoding of a previous data unit (S12163).

When cabac_init_flag indicates true (Yes in S12162), the three-dimensional data decoding device initializes the table saved in the storage device (memory) in the decoding of the previous data unit and performs the decoding (S12164).

The three-dimensional data decoding device updates the table based on the entropy decoding and saves the updated table in the storage device (memory) (S12165).

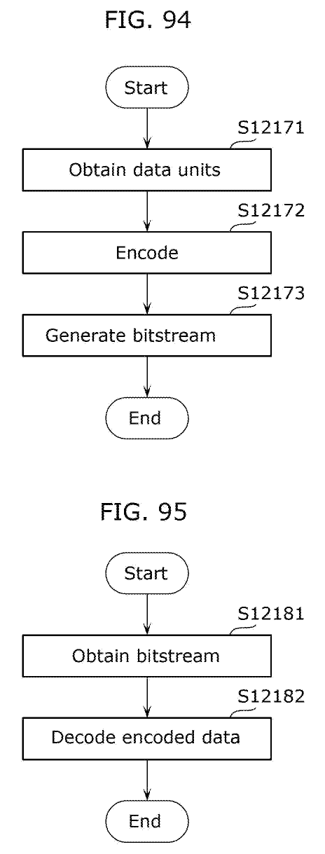

As stated above, the three-dimensional data encoding device according to one aspect of the present embodiment performs the process shown in FIG. 94. The three-dimensional data encoding device obtains data units each including three-dimensional points (S12171). Next, the three-dimensional data encoding device encodes the three-dimensional points included in each of the data units (S12172). Then, the three-dimensional data encoding device generates a bitstream including encoded data obtained by encoding the three-dimensional points (S12173). In the encoding (S12172), the three-dimensional data encoding device converts geometry information of three-dimensional points included in a data unit to be encoded into occupancy maps using an N-ary tree, N being an integer greater than or equal to 2; converts each of the occupancy maps into an index using a table indicating a correspondence relation between occupancy maps and indexes, and generates the encoded data by encoding the index; updates the table according to the index resulting from the conversion, and stores the table into memory; determines whether the table stored in the memory is to be initialized, when a lead three-dimensional point included in a next data unit following the data unit to be encoded is encoded; and when it is determined that the table stored in the memory is not to be initialized, starts encoding of the next data unit using the table stored in the memory. The bitstream further includes first identification information indicating a result of the determination.

Accordingly, since the index obtained using the table is encoded in the encoding of an occupancy map into which geometry information is converted, and a bitstream including the first identification information indicating whether the table used for the encoding is to be initialized is generated, the three-dimensional data decoding device is thus enabled to decode the bitstream appropriately.

For example, the index indicates a total number of occurrences of an occupancy map or an occurrence frequency of an occupancy map. Accordingly, coding efficiency can be improved by, for example, setting a smaller value to the index as the total number of occurrences or the occurrence frequency increases.

For example, when indicating that the table is to be initialized, the first identification information indicates that context of a preceding data unit is to be initialized, and attribute information of the three-dimensional points is to be encoded; and when indicating that the table is not to be initialized, the first identification information indicates that the attribute information is to be encoded continuously using the context of the preceding data unit.

For example, the bitstream further includes second identification information indicating whether a function of continuing entropy between the data units is to be used. When the second identification information indicates that the function of continuing the entropy between the data units is to be used, the first identification information is shown.

For example, the three-dimensional data encoding device includes a processor and memory. Using the memory, the processor performs the above process.

The three-dimensional data decoding device according to one aspect of the present embodiment performs the process shown in FIG. 95. The three-dimensional data decoding device obtains a bitstream including encoded data and first identification information, the encoded data being obtained by encoding a data unit including three-dimensional points, the first identification information indicating whether a table is to be initialized and used to encode the data unit, the table being used in encoding a preceding data unit preceding the data unit (S12181). The three-dimensional data decoding device decodes the encoded data using the table according to the first identification information (S12182). The table indicates a correspondence relation between occupancy maps and indexes, the occupancy map representing geometry information of the three-dimensional points using an N-ary tree, N being an integer greater than or equal to 2. The encoded data includes the index encoded. In the decoding (S12182), the three-dimensional data decoding device calculates the geometry information of the three-dimensional points by deriving an occupancy map corresponding to, in the table, the index obtained by decoding the encoded data.

Accordingly, since the occupancy map can be derived using the index obtained by decoding the encoded data and the table corresponding to the first identification information, it is possible to cause the three-dimensional data decoding device to decode the bitstream appropriately.

For example, the index indicates a total number of occurrences of an occupancy map or an occurrence frequency of an occupancy map.

For example, when indicating that the table is to be initialized, the first identification information indicates that context of a preceding data unit is to be initialized, and attribute information of the three-dimensional points is to be encoded; and when indicating that the table is not to be initialized, the first identification information indicates that the attribute information is to be encoded continuously using the context of the preceding data unit.

For example, the bitstream further includes second identification information indicating whether a function of continuing entropy between the data units is to be used. When the second identification information indicates that the function of continuing the entropy between the data units is to be used, the first identification information is shown.

For example, the three-dimensional data decoding device includes a processor and memory. Using the memory, the processor performs the above process.

In a case where point cloud data items are divided into data units (slices), when CABAC has been initialized, the data units have no dependences on one another and can be encoded or decoded independently. However, the current data structure of a data unit (slice) does not support a function of parallel processing on data.

Therefore, in the prediction-tree encoding, a function that is capable of parallel processing on data blocks in a data unit (slice) is provided by adding a function of initializing a context on a prediction tree basis in a data item in each data unit (slice) and adding an information item for accessing a block of one or more prediction trees.

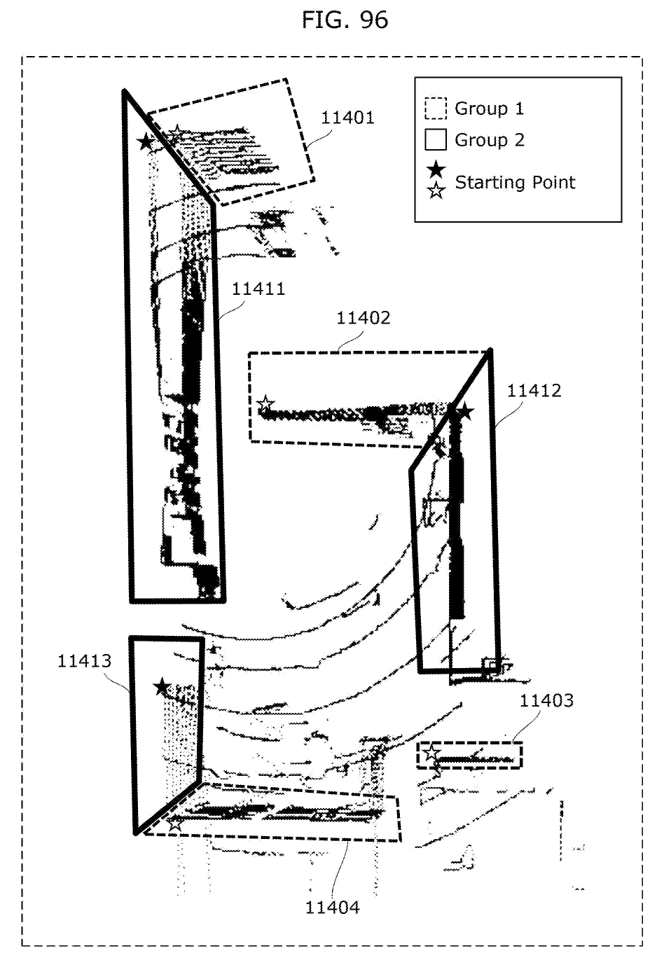

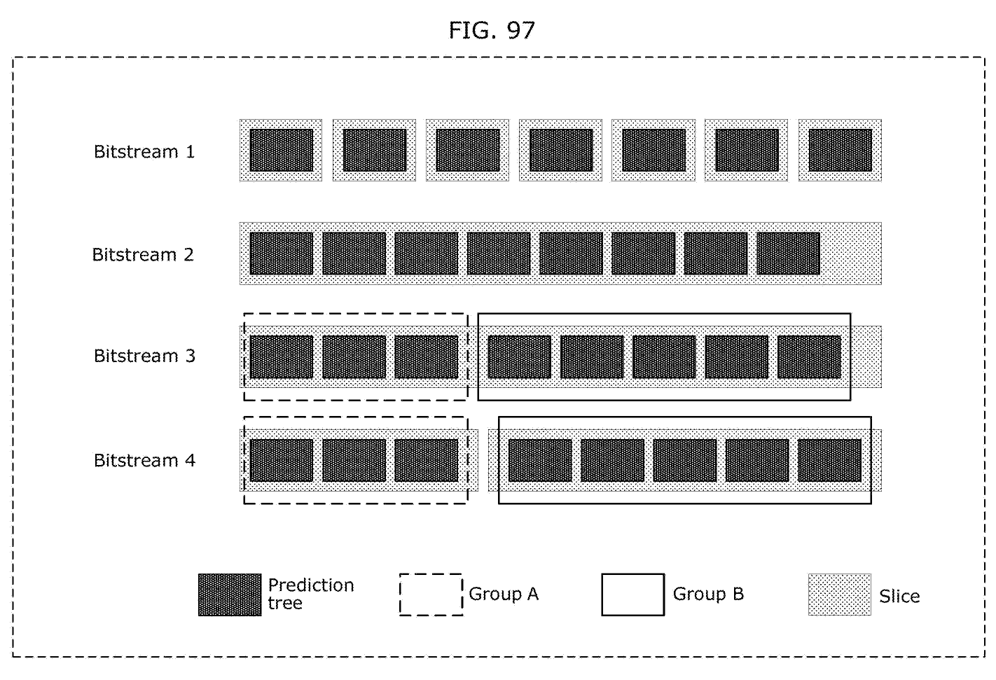

FIG. 96 is a diagram illustrating an example of a three-dimensional point cloud in a case where encoding is performed with the three-dimensional point cloud divided into slices for groups. FIG. 97 is a diagram illustrating various configuration examples of a bitstream.

As illustrated in FIG. 96, the three-dimensional point cloud may be divided into data units 11401 to 11404 and 11411 to 11413. Further, of data units 11401 to 11404 and 11411 to 11413, data units 11401 to 11404 may be grouped into group 1, and data units 11411 to 11413 may be grouped into group 2.

Next, a relation between slices and prediction trees will be described with reference to FIG. 97.

The three-dimensional data encoding device may encode a data unit of one slice with one prediction tree as in bitstream 1 or may encode a data unit of one slice with prediction trees as in bitstream 2. Alternatively, in a case where a point cloud can be clustered or grouped based on properties of the point cloud, the three-dimensional data encoding device may perform encoding with slices divided into by groups as in bitstream 4 or may perform encoding without the division into slices as in bitstream 3. In a case where a bitstream is not divided into slices for encoding, the three-dimensional data encoding device may arrange the point cloud in such a manner that the point cloud is in order of groups and may perform the encoding using a prediction tree for each group.

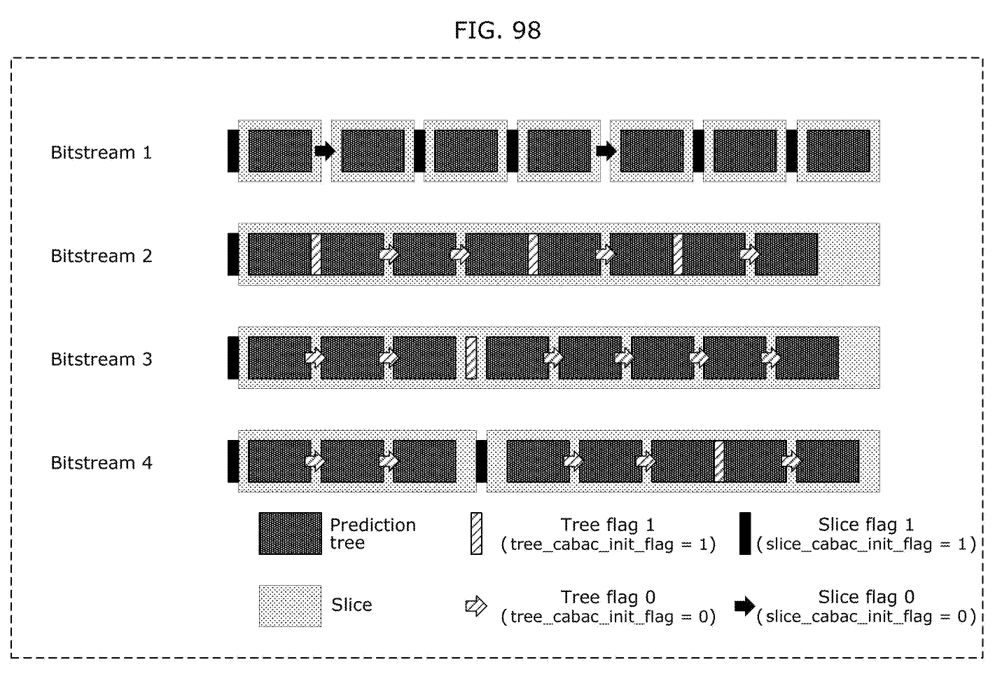

FIG. 98 illustrates an example in which whether to initialize slice-based CABAC is indicated by a slice flag (slice_cabac_init_flag), and whether to initialize tree-based CABAC in a slice is indicated by a tree flag (tree_cabac_init_flag). Bitstream 1 to 4 in FIG. 98 are the same as bitstream 1 to 4 in FIG. 97.

When initializing CABAC at a beginning of each processing block, the three-dimensional data encoding device sets slice_cabac_init_flag or tree_cabac_init_flag to one and transmits slice_cabac_init_flag or tree_cabac_init_flag set to one as metadata. It should be noted that slice_cabac_init_flag or tree_cabac_init_flag set to one indicates that CABAC is to be initialized at a beginning of each processing block. Slice_cabac_init_flag is an initialization flag for controlling the initialization of CABAC on a slice basis. Tree_cabac_init_flag is an initialization flag for controlling the initialization of CABAC on a tree structure basis.

The three-dimensional data decoding device analyzes the metadata, and when slice_cabac_init_flag or tree_cabac_init_flag is one, the three-dimensional data decoding device initializes CABAC. FIG. 98 illustrates that CABAC has been initialized when tree_cabac_init_flag indicates one or slice_cabac_init_flag indicates one, and illustrates that CABAC has not been initialized and a context is continued (i.e., the context is continuously used) when tree_cabac_init_flag indicates zero or slice_cabac_init_flag indicates zero.

Setting tree_cabac_init_flag enables CABAC to be initialized on a prediction tree basis. Setting tree_cabac_init_flag enables reset at a beginning of a given prediction tree; for example, tree_cabac_init_flag may be set such that, for example, CABAC is initialized at a beginning of each group. Alternatively, tree_cabac_init_flag may be set such that CABAC is initialized at a boundary at which encoding parameters for a prediction tree are changed. It should be noted that, in a case where an initialization flag is provided for each slice, a tree-structure-based initialization flag at a beginning of the slice need not be provided.

Prediction tables for specific groups have properties that are similar to each other between the groups, and thus continuing CABAC increases the possibility of improving encoding efficiency. Therefore, in bitstream 3, the initialization flag may be set such that CABAC is initialized at a beginning of each group so that CABAC is continued in the same group.

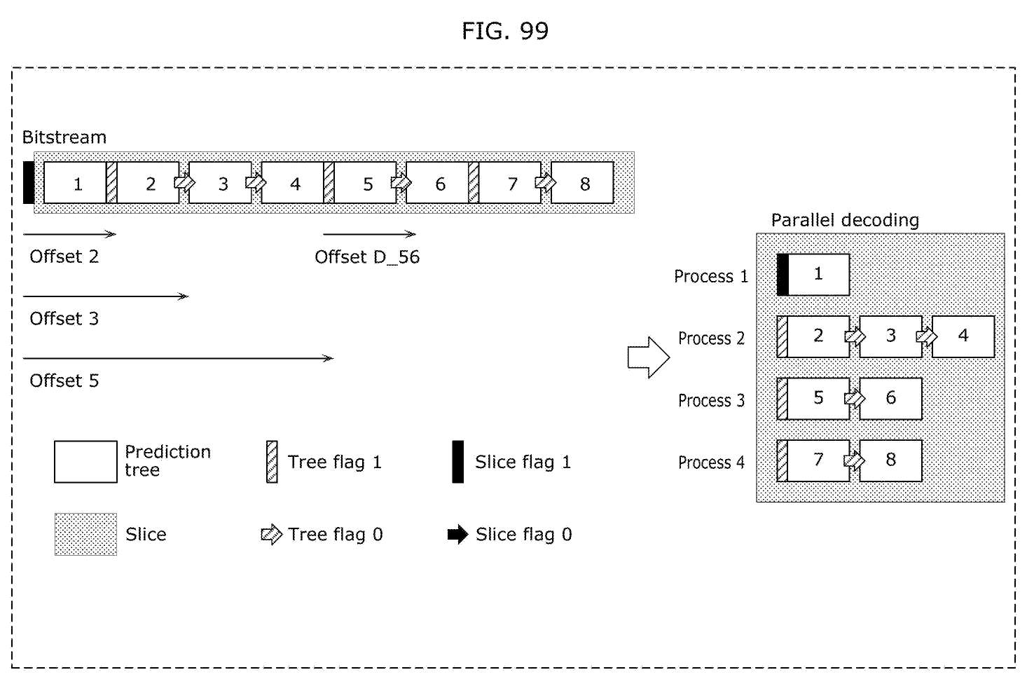

FIG. 99 is a diagram for describing a method of decoding prediction trees by parallel processing.

FIG. 99 illustrates a bitstream in which CABAC is initialized at a beginnings of prediction trees 1, 2, 5, and 7 in one slice. In such a bitstream, the three-dimensional data decoding device can handle a decoding process on prediction tree 1, a decoding process on prediction trees 2 to 4, a decoding process on prediction trees 5 and 6, and a decoding process on prediction trees 7 and 8, independently. In order for the three-dimensional data decoding device to perform the parallel processing, the three-dimensional data decoding device needs to directly access storage locations of data units in a memory that allow the data units to be decoded independently. Thus, the three-dimensional data encoding device includes an offset information item of a beginning of an encoded data (an information item indicating a storage location) in the encoded data item. The offset information item is, for example, an information item of bytes from a beginning of a slice. In FIG. 99, an offset information item indicated by offset 2 is the number of bytes from a beginning of the slice to an encoded data item of prediction tree 2. The offset information item may be provided for each prediction tree or may be provided for each block of one or more prediction trees that are processed independently. Further, as with offset D_56, the offset information item may be provided in terms of the number of bytes of a difference of prediction tree 6 from a beginning of prediction tree 5, which is immediately before prediction tree 6.

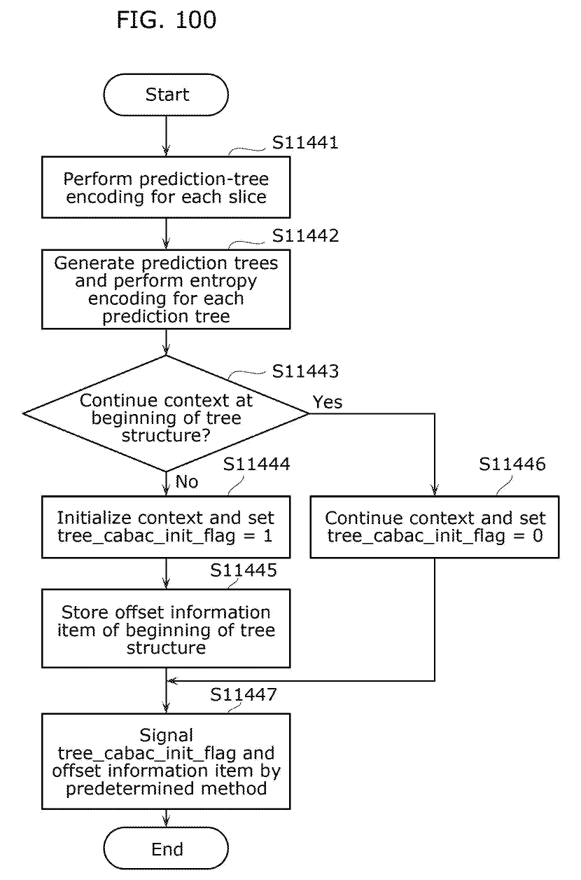

FIG. 100 is a diagram illustrating an example of a three-dimensional data encoding method.

The three-dimensional data encoding device executes the prediction-tree encoding for each slice (S11441).

Next, the three-dimensional data encoding device generates prediction trees and executes entropy encoding for each prediction tree (S11442).

Next, the three-dimensional data encoding device determines whether to continue a context at a beginning of a tree structure (prediction tree) (S11443).

When it is determined not to continue the context at the beginning of the tree structure (prediction tree) (No in S11443), the three-dimensional data encoding device initializes the context and sets tree_cabac_init_flag to one (S11444).

Next, the three-dimensional data encoding device stores an offset information item of the beginning of the tree structure (an information item indicating a storage location) (S11445).

In contrast, when it is determined to continue the context at the beginning of the tree structure (prediction tree) (Yes in S11443), the three-dimensional data encoding device continues the context and sets tree_cabac_init_flag to zero (S11446).

Next, the three-dimensional data encoding device signals at least tree_cabac_init_flag, out of tree_cabac_init_flag and the offset information item, by a predetermined method (S11447).

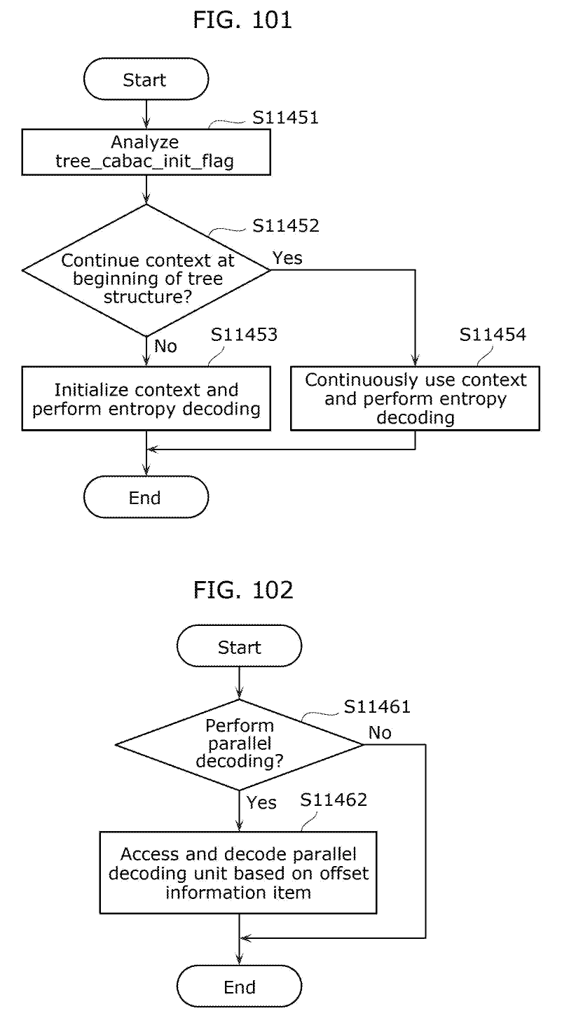

FIG. 101 is a diagram illustrating an example of a three-dimensional data decoding method.

The three-dimensional data decoding device analyzes tree_cabac_init_flag (S11451).

Next, the three-dimensional data decoding device determines whether tree_cabac_init_flag indicates that a context is continued at a beginning of a tree structure (prediction tree) (S11452).

When tree_cabac_init_flag indicates that the context is not continued at the beginning of the tree structure (prediction tree) (No in S11452), the three-dimensional data decoding device initializes the context and executes entropy decoding (S11453).

When tree_cabac_init_flag indicates that the context is continued at the beginning of the tree structure (prediction tree) (Yes in S11452), the three-dimensional data decoding device continuously uses the context and executes the entropy decoding (S11454).

FIG. 102 is a diagram illustrating an example of parallel decoding in a three-dimensional data decoding method.

The three-dimensional data decoding device determines whether to perform the parallel decoding (S11461).

When it is determined to perform the parallel decoding (Yes in S11461), the three-dimensional data decoding device accesses a parallel decoding unit based on an offset information item and decodes encoded units in parallel (S11462).

In such a manner, the three-dimensional data encoding device is capable of independent processing by eliminating dependences on tree structures by initializing CABAC. Further, since an offset information item of a beginning of a tree structure is provided, the three-dimensional data decoding device can randomly access encoded data items that are encoded with prediction trees, thus can perform decoding processes independently, and thus can perform the decoding processes in parallel. Further, the three-dimensional data encoding device and the three-dimensional data decoding device can make timings for initialization the same between the encoding and the decoding since CABAC is initialized based on tree_cabac_init_flag.

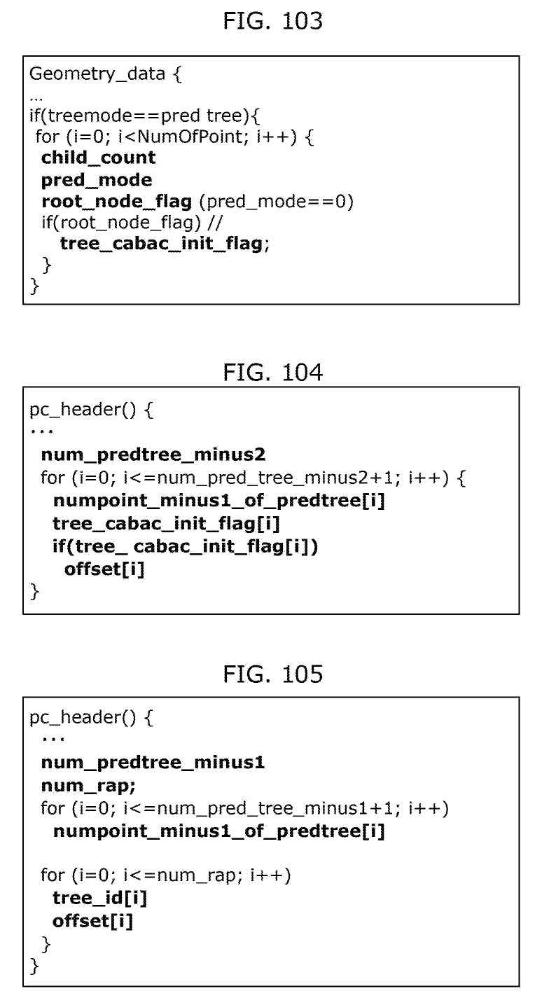

FIG. 103 is a diagram illustrating an example of a syntax of a data unit of a geometry information item in a case where an initialization flag is stored in a data item of the geometry information item.

In the data unit of the geometry information item, an encoded data item encoded by the prediction-tree encoding may be provided with a node information item, for example a prediction mode (pred_mode), in a loop for three-dimensional points. In a case where pred_mode = 0 (direct mode), pred_mode indicates that the node is a root node. The root node is a node (three-dimensional point) at a beginning of a prediction tree; in a case where a processing target is the root node, an initialization flag indicating whether CABAC is initialized at the root node (tree_cabac_init_flag) may be provided. It should be noted that, in place of the initialization flag, whether CABAC is initialized may be indicated by a random access flag. For example, when the random access flag is ON, it may be considered that CABAC is necessarily initialized.

FIG. 104 is a diagram illustrating an example of a syntax of a header of a geometry information item in a case where an initialization flag and an offset information item are stored in the header.

The initialization flag and the offset information may be collectively provided in a data unit header of the geometry information item. In the data unit header of the geometry information item, the number of prediction trees included in a data unit of the geometry information item (num_predtree_minus2) may be provided, or tree_cabac_init_flag for each prediction tree may be provided. When tree_cabac_init_flag is set to one, the data unit header is provided with the offset information item. The offset information item may be an offset (difference information item) from a beginning of the data unit or may be an offset (difference information item) from a beginning of a previous prediction tree. It should be noted that an information item of a prediction tree at a beginning may be set in such a manner as not to be included in the header as num_predtree_minus2, and the information item of the prediction tree at the beginning may be set in such a manner as to be included in the header as num_predtree_minus1.

FIG. 105 is a diagram illustrating an example of a syntax of a header of a geometry information item in a case where an initialization flag and an offset information item are stored in the header on a random access basis.

num_rap indicates the number of units that can be subjected to the parallel decoding (random access). The offset information item may be provided in each of the units on which the parallel decoding can be performed. It should be noted that tree_cabac_init_flag need not be provided, and CABAC may be initialized at a beginning of a prediction tree indicated by the offset information item.

Further, an identifier (tree_id) may be provided for each prediction tree in a data item of a geometry information item, and an identifier (tree_id) of a prediction tree that can be randomly accessed may be provided in the header. In such a manner, an order of a prediction tree can be determined (identified) by clearly specifying a number of the prediction tree.

The offset information item needs to be provided in the header, and tree_cabac_init_flag may be provided in either the data item or the header. The offset information item may be provided in the header, and tree_cabac_init_flag may be provided in the data item.

It should be noted that, when CABAC is initialized, an initial value for CABAC may be set to a predetermined value or may be signaled as with cabac_init_flag or offset.

Further, attribute information items are enabled to be subjected to the parallel processing by using the same method as that for the geometry information items. The initialization flag or the offset information item may be provided by the same signaling method. The initialization flag may be included in a header or a data item of an attribute information item.

It should be noted that units on which the parallel decoding can be performed may be made common to geometry information items and attribute information items. In this case, an information item of the units of attribute information items on which the parallel decoding can be performed, and the initialization flag may be provided in a header of a geometry information item because they are shared with geometry information items, and the offset information items of attribute information items may be provided in headers of the attribute information items.

The foregoing illustrates an example in which the initialization flag (entropy_continue_flag) is applied to the slice and the tile of a three-dimensional point, but the example in which the initialization flag is applied is not necessarily limited to the foregoing. For example, the initialization flag may be applied to the three-dimensional mesh and the submesh.

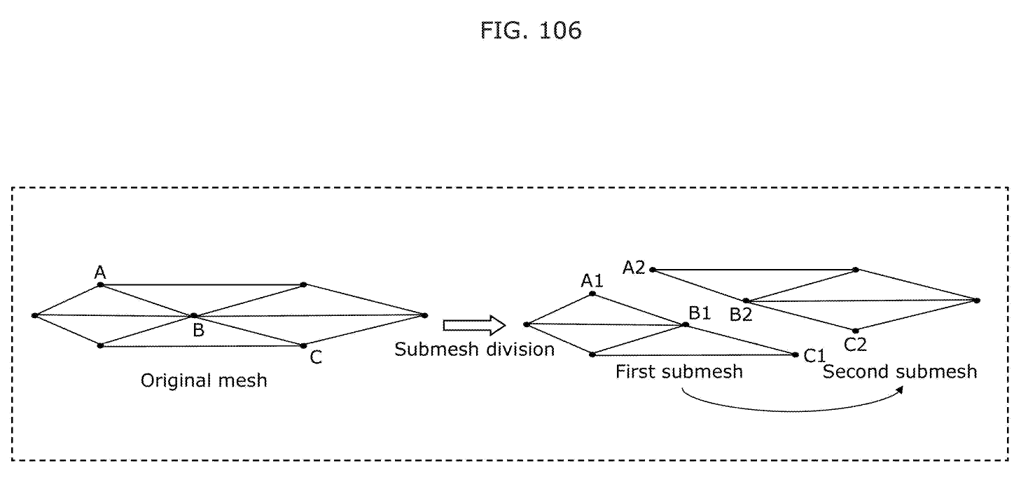

FIG. 106 is a diagram for illustrating a relationship between an original mesh and a submesh according to the embodiment. Specifically, FIG. 106 illustrates an original mesh and two submeshes (the first submesh and the second submesh) generated by dividing the original mesh into submeshes.

For example, in sequentially encoding and decoding submesh A and submesh B generated in advance by dividing the original mesh as illustrated in FIG. 106, when entropy_continue_flag is equal to 1, encoding device 100 or decoding device 200 may set context information for use in entropy encoding or entropy decoding (also referred to as just entropy-encoding context information) after encoding or decoding of submesh A as an initial value of context information at the start of encoding or decoding of the next submesh B, and encode or decode submesh B.

With this, for example, when the appearance pattern or the like of data to be encoded is similar between submesh A and submesh B, encoding device 100 can improve the coding efficiency in entropy encoding of data to be encoded of submesh B by using context information after entropy encoding of submesh A as an initial value of context information (also referred to as a context initial value) for use in encoding of submesh B. Moreover, for example, when decoding device 200 decodes (e.g., entropy decodes) submesh B, decoding device 200 can appropriately decode data to be decoded of submesh B by using context information after entropy decoding of submesh A as an initial value of context information for use in decoding of submesh B.

Note that, for example, encoding of a submesh means encoding of information regarding the submesh such as geometry information of vertices of the submesh and attribute information. Moreover, for example, decoding of a submesh means decoding of the encoded information regarding the submesh such as the encoded geometry information of vertices of the submesh and the encoded attribute information. The same is applied to encoding and decoding of anything other than the submesh.

Moreover, when entropy_continue_flag is equal to 0, encoding device 100 or decoding device 200 may initialize the context information at the start of encoding or decoding of submesh B.

With this, encoding device 100 or decoding device 200 can encode or decode submesh B independently from submesh A. Accordingly, the processing speed can be improved by applying parallel processing, for example.

Here, the initialization flag (entropy_continue_flag) is a flag indicating whether to continue the entropy encoding or the entropy decoding without initializing the context information. In other words, the initialization flag is a flag indicating whether to store the context of the preceding data unit and apply its context to the next data unit.

For example, entropy_continue_flag = 1 indicates that the entropy encoding or the entropy decoding continues without initializing the context information between the submeshes. Moreover, for example, entropy_continue_flag = 0 indicates that the context information is initialized between the submeshes and the entropy encoding or the entropy decoding is performed.

Note that, instead of entropy_continue_flag, the expression of cabac_init_flag described above may be used. In this case, the definition of the flag is opposite to that of entropy_continue_flag. In other words, for example, cabac_init_flag = 0 indicates that the entropy encoding or the entropy decoding continues without initializing the context information between the submeshes. Moreover, for example, cabac_init_flag = 1 indicates that the context information is initialized between the submeshes and the entropy encoding or the entropy decoding is performed.

Note that when entropy_continue_flag is equal to 1, encoding device 100 may set the context information at the end of encoding of submesh A as an initial value of the context in encoding of submesh B, for example.

With this, the coding efficiency in entropy encoding of submesh B can be improved.

Moreover, the context information may be communicated via a memory. For example, encoding device 100 may store the context information after encoding of submesh A in a memory, and read the context information from the memory at the start of encoding of submesh B to set as an initial value of context information.

With this, the context information can be appropriately passed between the submeshes. In other words, encoding device 100 can appropriately continue to use the context information. As with the case of encoding device 100, decoding device 200 may also store the context information after decoding of submesh A in a memory, and read the context information from the memory at the start of decoding of submesh B to set as an initial value of context information.

Moreover, for example, when entropy_continue_flag is equal to 0, after encoding submesh A, encoding device 100 may initialize the context information at the start of encoding of submesh B. Likewise, for example, when entropy_continue_flag is equal to 0, after decoding submesh A, decoding device 200 may initialize the context information at the start of decoding of submesh B.

With this, encoding device 100 or decoding device 200 can encode or decode submesh B independently from submesh A. Accordingly, the processing speed can be improved by applying parallel processing, for example.

For example, the submesh (submesh information) includes multiple components such as a base mesh (base mesh information), displacement vector information (displacement vector), and attribute information (attribute) including texture information and the like of a three-dimensional mesh. For example, the base mesh includes information such as geometry coordinate information (geometry coordinates), texture coordinate information (texture coordinates), and/or connectivity information (connectivity data). In this case, entropy_continue_flag may be set for each of the components.

Moreover, for example, entropy_continue_flag of a base mesh (for a base mesh) may be prepared. For example, when entropy_continue_flag is equal to 1, encoding device 100 or decoding device 200 may set the entropy-encoding context information after encoding of the base mesh of submesh A (after base-mesh encoding) or after decoding of the encoded base mesh (after base-mesh decoding) as an initial value of context information in entropy encoding at the start of base-mesh encoding or base-mesh decoding of submesh B following submesh A, to encode or decode the base mesh of submesh B.

With this, for example, when the appearance pattern or the like of data to be encoded is similar between the base mesh of submesh A and the base mesh of submesh B, encoding device 100 can improve the coding efficiency in entropy encoding of data to be base-mesh encoded of submesh B by using context information after base-mesh encoding of submesh A as an initial value in base-mesh encoding of submesh B. Moreover, in decoding, for example, decoding device 200 can appropriately decode the data to be base-mesh decoded of submesh B by using context information after base-mesh decoding of submesh A as an initial value in base-mesh decoding of submesh B.

Note that a mechanism similar to the base-mesh encoding and the base-mesh decoding described above may be applied to encoding or decoding of the displacement vector or the attribute information.

With this, by providing entropy_continue_flag for each of the components constituting the submesh, it can be selected, for each of the components, whether to pass the context information between submeshes to improve the coding efficiency, whether to initialize context information between submeshes to allow the parallel processing, or the like. Accordingly, it is possible to balance the coding efficiency and the processing amount.

Note that, for example, encoding device 100 may define, in the upper syntax such as a SPS, sps_entropy_continue_flag effective for all the components constituting the submesh. Moreover, for example, when sps_entropy_continue_flag is equal to 1, encoding device 100 may estimate the value of entropy_continue_flag for each of the components as 1 without assigning to the header of each component. Moreover, for example, when sps_entropy_continue_flag is equal to 0, encoding device 100 may assign entropy_continue_flag for each of the components to the header of each component to control the passing of context information between submeshes.

With this, it is possible to reduce information included in the header (header information).

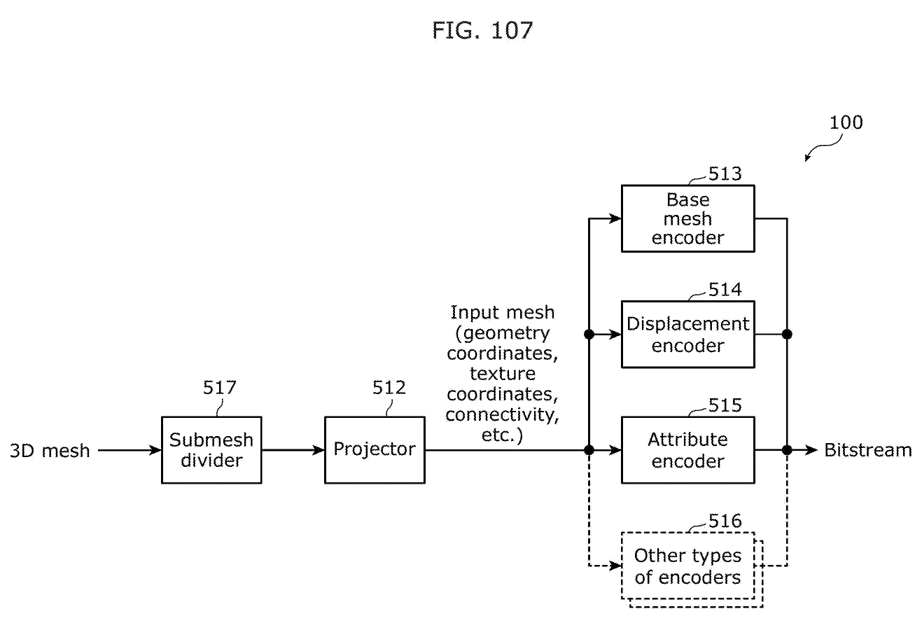

FIG. 107 is a block diagram illustrating another configuration example of encoding device 100 according to the embodiment.

In the present example, encoding device 100 includes submesh divider 517, projector 512, base mesh encoder 513, displacement encoder 514, attribute encoder 515, and optionally one or more other types of encoders 516.

Submesh divider 517 obtains a three-dimensional mesh, divides the obtained three-dimensional mesh into submeshes, and outputs submeshes generated by the submesh division to projector 512.

Projector 512 projects a content onto an input mesh (a three-dimensional mesh frame) including geometry coordinates (vertex coordinates indicating the positions of vertices), texture coordinates, connectivity (connectivity information), and the like. The resultant data is outputted to base mesh encoder 513, displacement encoder 514, and attribute encoder 515, and optionally to one or more other types of encoders 516. Each of the encoders compresses data into a bitstream.

For example, submesh divider 517 determines whether entropy_continue_flag is set (whether to be zero) for the input three-dimensional mesh.

Moreover, for example, each encoder determines, according to entropy_continue_flag, whether to initialize and use the context of entropy encoding (for entropy encoding) or continue to use the context without initialization.

Note that when a video codec is used to encode or decode the displacement vector or the attribute information such as the texture information of the three-dimensional mesh, the control such as entropy_continue_flag may be implemented by a function of the video codec.

For example, when encoding device 100 encodes the displacement vector of the submesh or the texture information of the submesh using a video codec, encoding device 100 may map each component of the submesh to a slice of the image. For example, when entropy_continue_flag is equal to 1, encoding device 100 may continue to use the context information between slices by using the dependent slice mechanism which is the function of the video codec.

With this, it is possible to improve the coding efficiency of the image to which each component of the submesh is mapped. More specifically, for example, when information regarding submesh A is mapped to an image as slice A and information regarding submesh B is mapped to the image as slice B, the coding efficiency can be improved by encoding device 100 encoding slice A and slice B using the dependent slice mechanism.

As described above, according to the value of entropy_continue_flag, the method of mapping, to an image, the texture information and/or the displacement vector to be input to the video codec may be switched, or the setting of the video codec may be switched.

With this, according to the value of entropy_continue_flag, it is possible to improve the coding efficiency of the video codec and also improve the coding efficiency of the entire process according to the encoding.

Note that when the profile or the like of the low latency mode (low latency transmission mode) is defined in the international standard such as MPEG and when the profile of the low latency mode is used, entropy_continue_flag may be restricted to 1 and the dependent slice mechanism may be restricted to ON in the video codec.

With this, when the low latency mode is set by the standard, the context information continues between the submeshes in encoding of each component, and thus the coding efficiency can be improved.

Moreover, when the profile of the low latency mode is used and when the dependent slice mechanism of the video codec is OFF under the condition of entropy_continue_flag = 1, decoding device 200 may output information indicating the violation of standard conformance condition or the like.

With this, a user can determine whether the bitstream conforms to the standard.

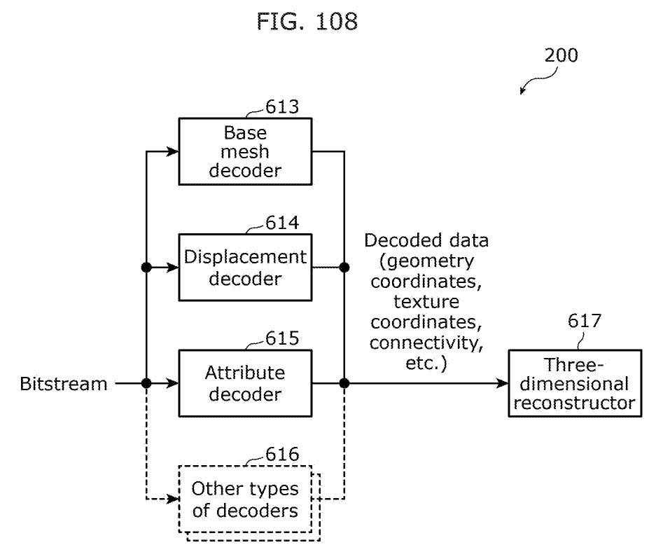

FIG. 108 is a block diagram illustrating another configuration example of decoding device 200 according to the embodiment.

In the present example, decoding device 200 includes base mesh decoder 613, displacement decoder 614, attribute decoder 615, one or more other types of decoders 616, and three-dimensional reconstructor 617.

A bitstream is transmitted to base mesh decoder 613, displacement decoder 614, and attribute decoder 615, and optionally to one or more other types of decoders 616. These decoders generate data (decoded data) including geometry coordinates, texture coordinates, connectivity, and the like by decoding the bitstream. The decoded data is then transmitted to three-dimensional reconstructor 617, and an output mesh (three-dimensional mesh frame) is reconstructed. For example, three-dimensional reconstructor 617 reconstructs a three-dimensional mesh by merging submeshes.

For example, each decoder initializes the entropy-encoding context information according to entropy_continue_flag.

Next, initialization of the entropy-encoding context information and a method of determining the context initial value will be described.

### Method of Determining entropy_continue_flag

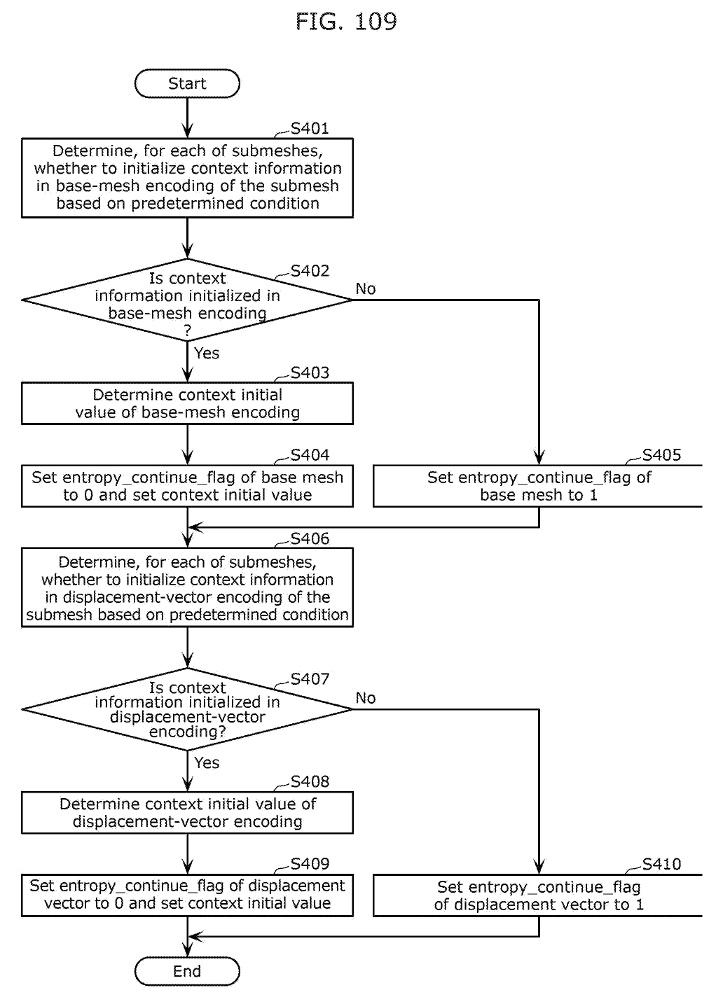

FIG. 109 is a flowchart illustrating an initialization process of context information according to the embodiment. Specifically, FIG. 109 is a flowchart illustrating a process regarding initialization of context information in base-mesh encoding or displacement-vector encoding (encoding of a displacement vector to be applied to a base mesh).

First, for each of submeshes, encoding device 100 determines, based on a predetermined condition, whether to initialize context information (context information of the base mesh) in base-mesh encoding of the submesh (S401).

Next, when it is determined to initialize context information in base-mesh encoding (Yes in S402), encoding device 100 determines a context initial value for use in base-mesh encoding (S403). For example, the context initial value is set to an initial value considering the encoding characteristics. The context initial value may be a predetermined value, or may be adaptively determined according to the characteristics of data included in the submesh.

Next, encoding device 100 sets entropy_continue_flag for the base mesh to 0 and also sets the context initial value (S404). For example, encoding device 100 signals, into a bitstream, information indicating that entropy_continue_flag for the base mesh is equal to 0 and information indicating the context initial value.

On the other hand, for example, when it is determined not to initialize context information in base-mesh encoding (No in S402), encoding device 100 sets entropy_continue_flag for the base mesh to 1 (S405). For example, encoding device 100 signals, into the bitstream, information indicating that entropy_continue_flag for the base mesh is equal to 1.

Subsequent to Step S404 or Step S405, for each of submeshes, encoding device 100 determines, based on a predetermined condition, whether to initialize context information (context information of the displacement vector) in displacement-vector encoding of the submesh (S406).

When it is determined to initialize context information in displacement-vector encoding (Yes in S407), encoding device 100 determines a context initial value for use in displacement-vector encoding (S408). For example, the context initial value is set to an initial value considering the encoding characteristics. The context initial value may be a predetermined value, or may be adaptively determined according to the characteristics of data included in the submesh.

Next, encoding device 100 sets entropy_continue_flag of the displacement vector (for the displacement vector) to 0 and also sets the context initial value (S409). For example, encoding device 100 signals, into the bitstream, information indicating that entropy_continue_flag for the displacement vector is equal to 0 and information indicating the context initial value.

On the other hand, for example, when it is determined not to initialize context information in displacement-vector encoding (No in S407), encoding device 100 sets entropy_continue_flag for the displacement vector to 1 (S410). For example, encoding device 100 signals, into the bitstream, information indicating that entropy_continue_flag for the displacement vector is equal to 1.

For example, when encoding device 100 initializes the context information, in Step S404, encoding device 100 uses the context initial value to perform the initialization process in base-mesh encoding. Moreover, for example, when encoding device 100 initializes the context information, in Step S409, encoding device 100 uses the context initial value to perform the initialization process in displacement-vector encoding.

Note that the process related to the base mesh and the process related to the displacement vector may be performed in the switched order of the above, or may be performed in parallel.

Moreover, the foregoing describes a process on a submesh basis as an example, but the same is applied to a process on a tile basis, on a slice basis, or on a different data unit basis.

Moreover, the predetermined condition may be the same or different between the process related to the base mesh and the process related to the displacement vector.

Moreover, the foregoing illustrates an example in which the base mesh and the displacement vector constituting the submesh are used for the initialization process of the context information, but the present disclosure is not necessarily limited to this combination. This process may be applied to a combination of other components. For example, the process may be applied to the base mesh and the attribute information. Alternatively, for example, the process may be applied to the base mesh, the displacement vector, and the attribute information.

With this, it is possible to ensure the balance of the coding efficiency and the processing amount by switching whether to initialize the context information for each component.

Moreover, for example, decoding device 200 determines whether to initialize the context information based on entropy_continue_flag included in the bitstream, and when it is determined to initialize the context information, decoding device 200 initializes the context information based on information indicating the context initial value included in the bitstream.

Next, a syntax will be described.

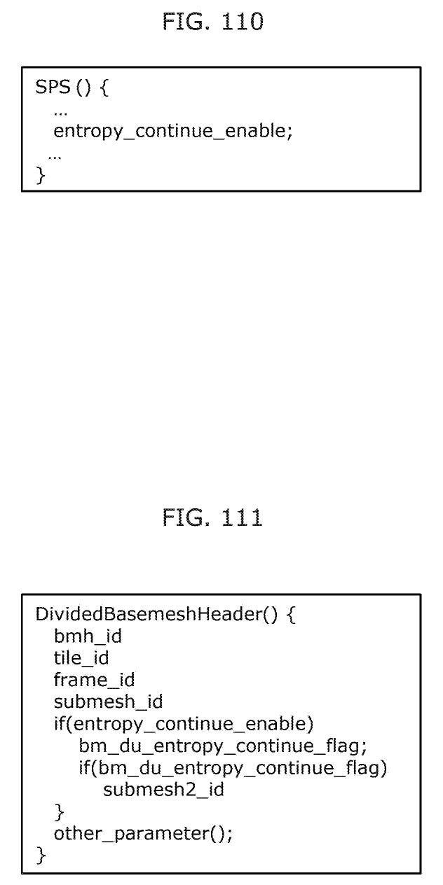

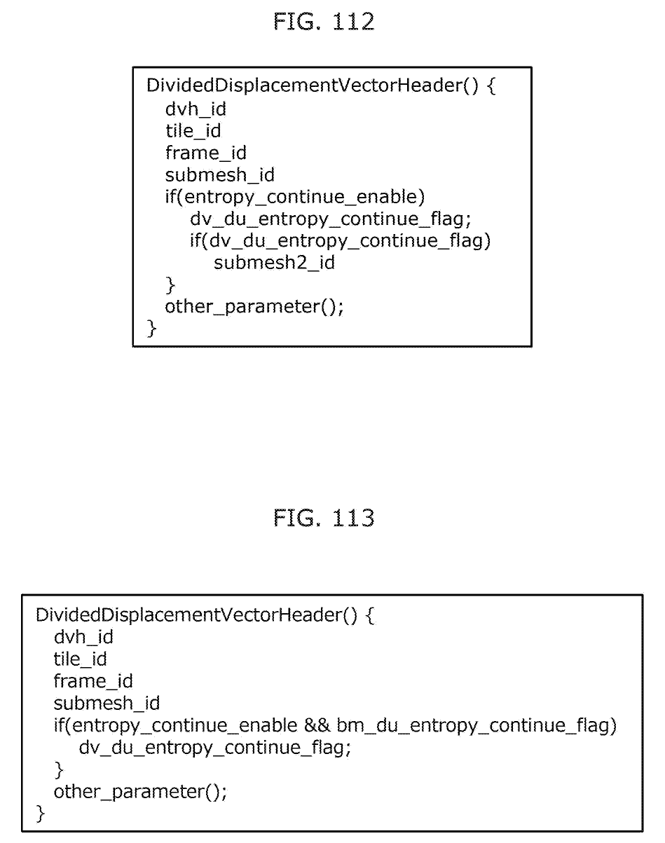

FIG. 110 is a diagram illustrating another exemplary syntax of an SPS according to the embodiment. FIG. 111 is a diagram illustrating an exemplary syntax of a header (DividedBasemeshHeader) of a divided base mesh according to the embodiment. FIG. 112 is a diagram illustrating an exemplary syntax of a header (DividedDisplacementVectorHeader) of a divided displacement vector according to the embodiment. FIG. 113 is a diagram illustrating another exemplary syntax of a header (DividedDisplacementVectorHeader) of a divided displacement vector according to the embodiment.

For example, the SPS includes a flag (entropy_continue_enable) indicating whether to have a function of continuing the context information between data units such as submeshes.

The header of the divided geometry information (in the present example, DividedBasemeshHeader) includes the identifier of the header of the base mesh referred to by a current data unit (bmh_id), the identifier of the tile (tile_id), the identifier of the frame (frame_id), and the identifier of the submesh to which the current data unit belongs (submesh_id).

Moreover, when entropy_continue_enable indicated in the SPS is enabled, the header of the divided base mesh includes a flag (bm_du_entropy_continue_flag) indicating whether the current data unit uses the context information of the preceding data unit as a context initial value. For example, when bm_du_entropy_continue_flag is enabled, the header of the divided base mesh includes the identifier (e.g., submesh2_id) of the submesh to which the preceding data unit belongs. On the other hand, for example, when bm_du_entropy_continue_flag is not enabled, the header of the divided base mesh does not include the identifier of the submesh to which the preceding data unit belongs.

The header of the divided attribute information (in the present example, DividedDisplacementVectorHeader) includes the identifier of the header of the displacement vector referred to by a current data unit (dvh_id), the identifier of the tile (tile_id), the identifier of the frame (frame_id), and the identifier of the submesh to which the current data unit belongs (submesh_id).

Moreover, when entropy_continue_enable indicated in the SPS is enabled, the header of the displacement vector includes a flag (dv_du_entropy_continue_flag) indicating whether the current data unit uses the context information of the preceding data unit as a context initial value. For example, when dv_du_entropy_continue_flag is enabled, the identifier (e.g., submesh2_id) of the submesh to which the preceding data unit belongs is indicated. On the other hand, for example, when dv_du_entropy_continue_flag is not enabled, the identifier of the submesh to which the preceding data unit belongs is not indicated.

bm_du_entropy_continue_flag and dv_du_entropy_continue_flag are provided, and thus flexible control is possible through individual control of the flags.

Moreover, regarding whether to continue to use the context information of the displacement vector (displacement vector information), it may be determined to be enabled when entropy encoding of the base mesh is continuing. Moreover, when determined to be enabled, whether the entropy encoding of the data unit of the current displacement vector is enabled may be indicated.

Moreover, when entropy_continue_enable is true, dv_du_entropy_continue_flag may be set, and when bm_du_entropy_continue_flag is false, dv_du_entropy_continue_flag is set to false regardless of the value of dv_du_entropy_continue_flag.

Moreover, when bm_du_entropy_continue_flag is false and when dv_du_entropy_continue_flag is true, it may be determined that conformance condition is violated (or nonconformance to specifications).

As described above, for example, encoding device 100 encodes (stores), into the bitstream, the identifier uniquely indicating a displacement vector such as dvh_id and the identifier uniquely indicating a submesh such as submesh_id. For example, encoding device 100 encodes both the identifiers into any header in the bitstream. Moreover, for example, encoding device 100 encodes (stores), into the bitstream, the identifier uniquely indicating a base mesh such as bmh_id. For example, encoding device 100 encodes both the identifier uniquely indicating a base mesh such as bmh_id and the identifier uniquely indicating a submesh such as submesh_id into the header of the base mesh in the bitstream. For example, when decoding device 200 obtains the bitstream, decoding device 200 identifies, based on the identifiers, the correspondence relationship between the base mesh, the submesh and the displacement vector.

Next, a low latency encoding scheme and a low latency decoding scheme will be described.

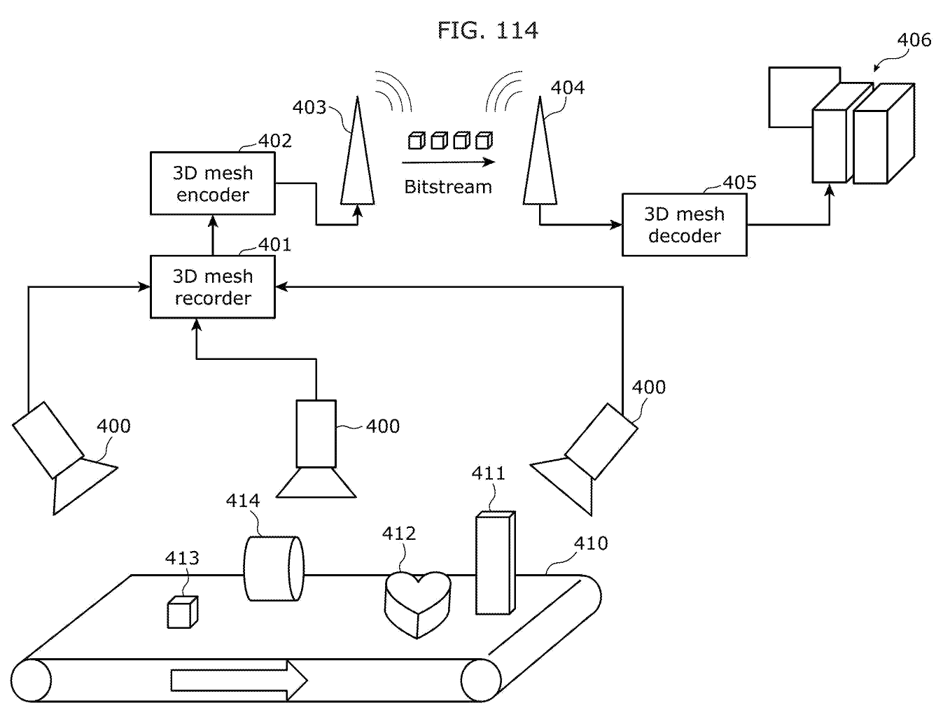

FIG. 114 is a diagram for illustrating low latency encoding according to the embodiment.

Three-dimensional mesh recorder 401 is a computer for storing a three-dimensional mesh. For example, three-dimensional mesh recorder 401 generates and stores a three-dimensional mesh from cameras 400 based on images generated by capturing objects 411, 412, 413, and 414 disposed on conveyor belt 410 with cameras 400.

Three-dimensional mesh encoder 402 is a computer for encoding the three-dimensional mesh. For example, three-dimensional mesh encoder 402 obtains the three-dimensional mesh stored in three-dimensional mesh recorder 401, encodes the obtained three-dimensional mesh, generates a bitstream including the encoded three-dimensional mesh, and outputs the generated bitstream to transmitter 403.

Transmitter 403 is a communication device for transmitting the bitstream output from three-dimensional mesh encoder 402 to receiver 404.

Receiver 404 is a communication device for outputting the bitstream transmitted from transmitter 403 to three-dimensional mesh decoder 405.

Three-dimensional mesh decoder 405 is a computer for decoding the three-dimensional mesh. For example, three-dimensional mesh decoder 405 obtains the encoded three-dimensional mesh included in the bitstream, decodes the encoded three-dimensional mesh obtained, and outputs the decoded three-dimensional mesh to server 406.

Server 406 is a computer for managing the three-dimensional mesh.

With such a configuration, the three-dimensional mesh encoded by three-dimensional mesh encoder 402 is decoded by three-dimensional mesh decoder 405 and then stored in server 406. For example, encoding device 100 is implemented as three-dimensional mesh encoder 402, and decoding device 200 is implemented as three-dimensional mesh decoder 405. Encoding device 100 may include the functionality of three-dimensional mesh recorder 401 and/or transmitter 403. Decoding device 200 may include the functionality of receiver 404.

Here, low latency encoding of a three-dimensional mesh (low-latency three-dimensional mesh encoding) means that encoding device 100 encodes a three-dimensional mesh and almost immediately outputs (streams out) a bitstream including the encoded three-dimensional mesh.

For example, encoding device 100 (three-dimensional mesh encoder 402) starts encoding at a predetermined interval from a given submesh to a particular submesh.

For example, it is assumed that a three-dimensional mesh including all the three-dimensional models corresponding to objects 411, 412, 413, and 414 disposed on conveyor belt 410 is a complete three-dimensional mesh. It is also assumed that this complete three-dimensional mesh is made up from multiple submeshes. For example, it is assumed that the submeshes are the three-dimensional models corresponding to objects 411, 412, 413, and 414. For example, it is assumed that there are a submesh including the three-dimensional model corresponding to object 411, a submesh including the three-dimensional model corresponding to object 412, a submesh including the three-dimensional model corresponding to object 413, and a submesh including the three-dimensional model corresponding to object 414.

The submeshes are sequentially encoded and immediately transmitted to receiver 404 as data packets. Receiver 404 can access each of the submeshes individually with very low latency. Such encoding scheme/decoding scheme has a possibility of decrease in compression performance, whereas the performance may be improved if the continuation of the context information (i.e., continuing to use the context information without initialization) is allowed.

It is proposed that a flag for indicating the continuation of context information is placed in a high level syntax, e.g., in the header for the mesh coding. This flag can signal parameters for encoding mesh geometry information and/or parameters for encoding mesh attribute information to have their context information continue. For example, a flag for indicating continuation of the context information of each of the geometry information and the attribute information may be signaled discretely.

When the header for mesh_context_continuation_flag is set, mesh_position_context continuation flag may be signaled in mesh_position_encoding_parameters.

The same is applied to parameters for encoding mesh attribute information. Whether to continue the context information of each of the geometry information and the attribute information, more specifically, whether to continue to use the context information or initialize the context information, may be set individually as needed. The flag indicating whether to continue the context information may be output according to another related encoder 100 for use in mesh encoding, e.g., a video encoder such as HEVC.

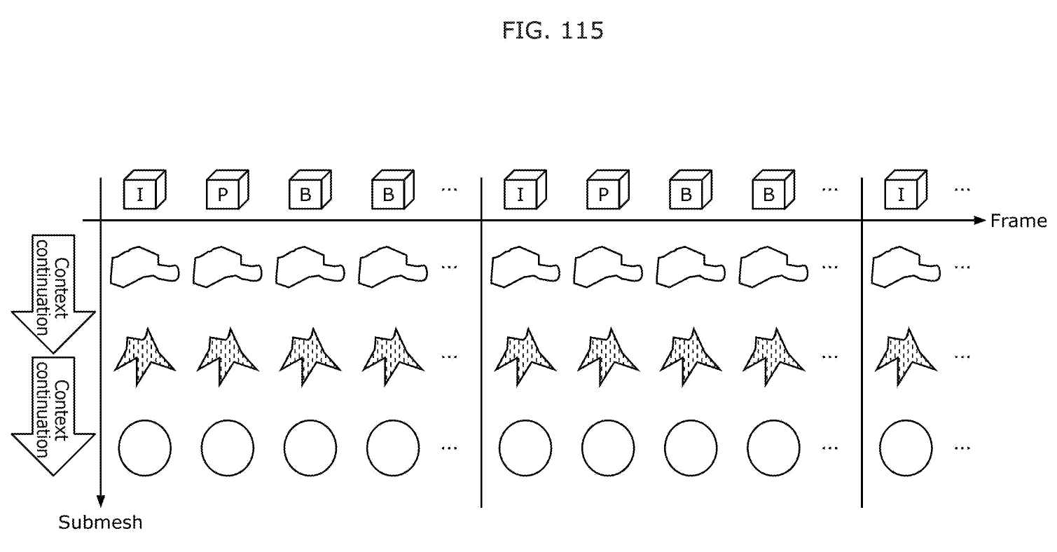

FIG. 115 is a diagram for illustrating continuation of context information according to the embodiment. Note that the I, P, or B block illustrated in FIG. 115 schematically represents the type of frame (three-dimensional mesh frame). Specifically, I represents the I frame, P represents the P frame, and B represents the B frame.

Moreover, each of the three meshes below each frame represents a submesh generated from the three-dimensional mesh included in the frame.

In the three-dimensional mesh, by continuing to use the context information, we can continue to use the probability information of the context information from one submesh to another submesh. For example, as default, the context information continues from one frame to another frame based on the frame dependency.

In this way, the compression performance can be improved since the probability information can be used for the subsequent submesh.

In order to match with three-dimensional mesh encoding/decoding characteristics, the context information to be used for the next submesh may be set to be identified as being the same context information as intended. For example, the context information may be used by another process invoking a similar function. A mechanism to distinguish each calling function may be set.

Note that the foregoing describes the mechanism for passing the context information using entropy_continue_flag between submeshes in a frame, but the mechanism for passing the context information is not necessarily limited to this. For example, the mechanism for passing the context information may be applied between frames. For example, frame_entropy_continue_flag may be prepared. For example, when frame_entropy_continue_flag is equal to 1, encoding device 100 may pass the context information between frames. Moreover, for example, when frame_entropy_continue_flag is equal to 0, encoding device 100 may initialize the context information at the start of encoding each of the frames. As a more specific example, when frame_entropy_continue_flag is equal to 1, encoding device 100 may pass the context information after encoding of submesh 0 in frame 0 as an initial value in encoding of submesh 0 in frame 1 which is the next frame in the encoding order. The same is applied to decoding device 200.

With this, when the change in submesh shape or the like is little between frame 0 and frame 1, the entropy encoding efficiency of submesh 1 can be improved.

Note that, for the top frame of a sequence or a random access frame, frame_entropy_continue_flag may be restricted to 0.

With this, the top frame or the frame at the random access point can be encoded or decoded independently.

Note that the foregoing describes the example in which entropy_continue_flag is provided for each submesh as an exemplary data unit of three-dimensional mesh division, but the data unit of three-dimensional mesh division is not necessarily limited to this unit. For example, a data unit for low latency transmission is defined, and entropy_continue_flag may be provided for each data unit for low latency transmission.

With this, the context information is passed between data units by setting entropy_continue_flag of the data unit for low latency transmission to 1 in low latency transmission, and thus the coding efficiency can be improved.

Moreover, the value of entropy_continue_flag may be determined case by case. For example, in transmitting and receiving three-dimensional mesh information with low latency in a network, it is conceivable that the three-dimensional mesh information is divided into data units, e.g., submeshes, and data is transmitted and received for each of the submeshes. In general, for example, when encoding device 100 divides the three-dimensional mesh into data units such as submeshes and performs encoding, the entropy encoding efficiency is less likely to increase, and thus the coding efficiency is not good.

Accordingly, the coding efficiency can be improved by setting entropy_continue_flag=1 and passing (continuing to use) the entropy-encoding context information between the data units such as submeshes. In other words, in the case of the low latency mode, by setting entropy_continue_flag=1, low latency transmission can be achieved while reducing the decrease in coding efficiency.

Note that when the low latency profile is defined in the international standard such as MPEG, entropy_continue_flag may be restricted to 1.

With this, the coding efficiency in the low latency transmission can be kept.

Moreover, when the data unit is encoded or decoded at high speed through parallel processing, entropy_continue_flag may be set to 0.

With this, encoding device 100 or decoding device 200 can encode or decode each data unit independently. Accordingly, speedup through parallel processing is possible.

Moreover, for example, the foregoing describes the method of switching, according to the value of entropy_continue_flag, whether to continue to use the context information between submeshes in entropy encoding or entropy decoding of the base mesh, the displacement vector, or the attribute information such as texture information, which constitute a submesh of the three-dimensional mesh.

Here, for example, in the case of the context information of the base mesh, the context information includes context information for entropy encoding or entropy decoding of vertex position information (vertex position), face information, connectivity information, attribute information such as texture coordinate information, motion vector information, and the like. Moreover, for example, in the case of the context information of the displacement vector, the context information includes context information for entropy encoding or entropy decoding of the displacement vector, or context information for mapping the displacement vector to an image and performing encoding or decoding using a video codec. Moreover, for example, in the case of the context information of the attribute information such as texture information, the context information includes context information for mapping the texture information to an image and performing encoding or decoding using a video codec.

### Outline of Present Disclosure

For example, the present disclosure includes aspects as described below.

An encoding method according to Aspect 1 includes: performing arithmetic encoding on data included in a first submesh; and performing arithmetic encoding on data included in a second submesh, in which the arithmetic encoding of the data included in the second submesh further includes: determining whether to initialize context information used in the arithmetic encoding of the data included in the first submesh; when it is determined to initialize the context information, initializing the context information and performing arithmetic encoding on the data included in the second submesh; and when it is determined not to initialize the context information, performing arithmetic encoding on the data included in the second submesh without initializing the context information, and the encoded data includes first identification information indicating a determination result of whether to initialize the context information.

For example, the encoded data is encoded data included in a bitstream. For example, the first identification information is an initialization flag (entropy_continue_flag).

Note that the encoded data included in the bitstream may be multiple data items.

An encoding method according to Aspect 2 is the encoding method according to Aspect 1, in which the first submesh and the second submesh include first data and second data, respectively, the first identification information indicates the determination result for arithmetic encoding of the first data, and the encoded data includes the second identification information indicating the determination result for arithmetic encoding of the second data.

The first data and the second data may be any data, and are not particularly limited. For example, the first data is a base mesh. For example, the second data is a displacement vector. For example, the second data may be attribute information, texture information, or the like.

For example, the first identification information described here is bm_du_entropy_continue_flag. Moreover, for example, the second identification information described here is dv_du_entropy_continue_flag.

An encoding method according to Aspect 3 is the encoding method according to Aspect 1, in which the first submesh and the second submesh include first data and second data, respectively, and the first identification information indicates the determination result common to arithmetic encoding of the first data and arithmetic encoding of the second data.

An encoding method according to Aspect 4 is the encoding method according to Aspect 1, in which the first submesh and the second submesh include first data and second data, respectively, and the encoded data includes third identification information indicating whether the first identification information is used for both arithmetic encoding of the first data and arithmetic encoding of the second data.

For example, the third identification information is sps_entropy_continue_flag.

Note that, when image encoding is performed, the first identification information may be shared.

An encoding method according to Aspect 5 is the encoding method according to Aspect 1, in which the first submesh and the second submesh include first data to be encoded using the first encoding method and second data to be encoded using the image encoding method, respectively, and the first identification information indicates the determination result common to arithmetic encoding of the first data and image encoding of the second data.

For example, the encoding using the first encoding method is base-mesh encoding.

An encoding device according to Aspect 6 includes memory and a circuitry, in which using the memory, the circuitry: performs arithmetic encoding on data included in a first submesh; and performs arithmetic encoding on data included in a second submesh, in the arithmetic encoding of the data included in the second submesh, the circuitry: determines whether to initialize context information used in the arithmetic encoding of the data included in the first submesh; when it is determined to initialize the context information, initializes the context information and performs arithmetic encoding on the data included in the second submesh; and when it is determined not to initialize the context information, performs arithmetic encoding on the data included in the second submesh without initializing the context information, and the encoded data includes first identification information indicating a determination result of whether to initialize the context information.

A decoding method according to Aspect 7 includes: performing arithmetic decoding on data included in a first submesh; and performing arithmetic decoding on data included in a second submesh, in which the arithmetic decoding of the data included in the second submesh further includes: obtaining first identification information indicating whether to initialize context information used in the arithmetic decoding of the data included in the first submesh; when the first identification information indicates to initialize the context information, initializing the context information and performing arithmetic decoding on the data included in the second submesh; and when the first identification information indicates not to initialize the context information, performing arithmetic decoding on the data included in the second submesh without initializing the context information.

A decoding device according to Aspect 8 includes memory and a circuitry, in which using the memory, the circuitry: performs arithmetic decoding on data included in a first submesh; and performs arithmetic decoding on data included in a second submesh, in the arithmetic decoding of the data included in the second submesh, the circuitry: obtains first identification information indicating whether to initialize context information used in the arithmetic decoding of the data included in the first submesh; when the first identification information indicates to initialize the context information, initializes the context information and performs arithmetic decoding on the data included in the second submesh; and when the first identification information indicates not to initialize the context information, performs arithmetic decoding on the data included in the second submesh without initializing the context information.

### Representative Example

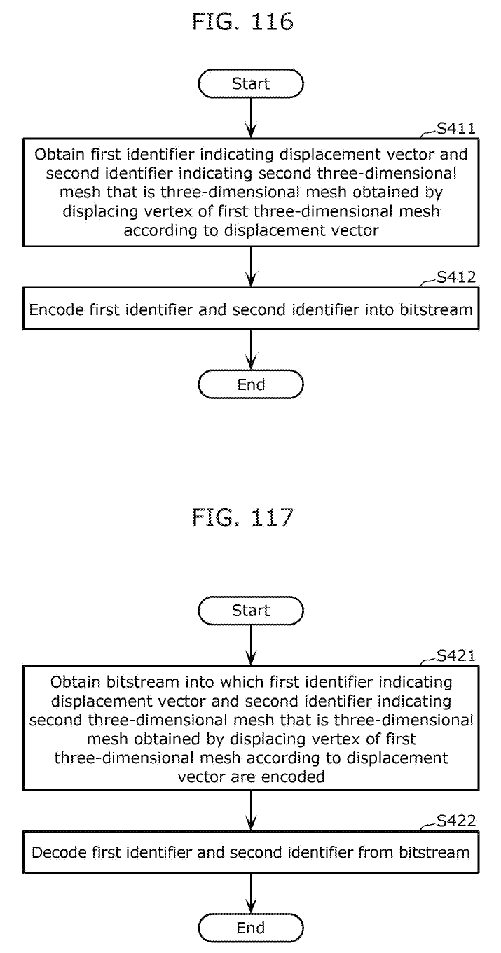

FIG. 116 is a flowchart illustrating an example of a basic encoding process according to the embodiment. For example, encoding device 100 illustrated in FIG. 24 includes circuit 151 and memory 152 connected to circuit 151. In encoding device 100, circuit 151 performs the following processes in operation.

First, encoding device 100 obtains a first identifier indicating a displacement vector and a second identifier indicating a second three-dimensional mesh that is a three-dimensional mesh obtained by displacing a vertex of a first three-dimensional mesh according to the displacement vector (S411). For example, when encoding device 100 obtains a plurality of displacement vectors, encoding device 100 obtains the first identifier for each of the displacement vectors. Moreover, for example, when encoding device 100 obtains a plurality of second three-dimensional meshes, encoding device 100 obtains the second identifier for each of the second three-dimensional meshes.

For example, the first identifier is dvh_id. For example, the first three-dimensional mesh is a subdivided base mesh. For example, the second three-dimensional mesh is a submesh. For example, the second identifier is submesh_id. For example, encoding device 100 may obtain the first identifier and the second identifier which are set freely by a user. Moreover, for example, encoding device 100 may obtain the first identifier by assigning an identifier to each of the displacement vectors in order so as to have a unique value. Moreover, for example, encoding device 100 may obtain the first identifier by assigning an identifier to each of the second three-dimensional meshes in order so as to have a unique value.

Next, encoding device 100 encodes the first identifier and the second identifier into a bitstream (S412). More specifically, encoding device 100 generates a bitstream including the first identifier and the second identifier. For example, encoding device 100 encodes the first identifier and the second identifier into a bitstream, and outputs the bitstream. In encoding the identifiers, variable length encoding or fixed length encoding may be used. For example, encoding device 100 transmits the generated bitstream to decoding device 200.

With this, decoding device 200 can identify the displacement vector and the second three-dimensional mesh by only checking the identifiers. Accordingly, it is possible to reduce the processing amount.

Moreover, for example, the bitstream includes the first identifier and the second identifier in a first header.

For example, the first header is DividedDisplacementVectorHeader, but may be any header of the bitstream. For example, encoding device 100 encodes (stores) both the first identifier and the second identifier into the same header.

With this, decoding device 200 can identify the displacement vector and the second three-dimensional mesh related to information included in a payload corresponding to the first header, by only checking the identifiers included in the first header. Accordingly, it is possible to reduce the processing amount.

Moreover, for example, the bitstream additionally includes the second identifier in a second header different from the first header.

For example, the second header is DividedBasemeshHeader, but any header of the bitstream is possible as long as the second header is different from the first header.

With this, decoding device 200 can identify the second three-dimensional mesh related to each of information included in a payload corresponding to the first header and information included in a payload corresponding to the second header, by only checking the identifier included in the first header and the second header. Accordingly, it is possible to reduce the processing amount.

Moreover, for example, the first three-dimensional mesh is a three-dimensional mesh obtained by subdividing a base mesh to add a vertex to the base mesh, and the second header is a header of the base mesh.

As described above, the second three-dimensional mesh (i.e., the submesh) is generated by displacing a vertex included in the first three-dimensional mesh (i.e., the subdivided base mesh) according to the displacement vector. The header of the base mesh refers to a header including information regarding the base mesh, such as vertex information of the base mesh, in the corresponding payload, and is DividedBasemeshHeader.

With this, decoding device 200 can identify the second three-dimensional mesh related to the base mesh by only checking the identifier included in the header of the base mesh. Accordingly, it is possible to reduce the processing amount.

Moreover, for example, the bitstream further includes, in the second header, a third identifier indicating the base mesh.

For example, the third identifier is bmh_id.

With this, decoding device 200 can identify the base mesh by only checking the identifier included in the header of the base mesh. Accordingly, it is possible to reduce the processing amount.

FIG. 117 is a flowchart illustrating an example of a basic decoding process according to the present embodiment. For example, decoding device 200 illustrated in FIG. 25 includes circuit 251 and memory 252 connected to circuit 251. In decoding device 200, circuit 251 performs the following processes in operation.

First, decoding device 200 obtains a bitstream into which a first identifier indicating a displacement vector and a second identifier indicating a second three-dimensional mesh that is a three-dimensional mesh obtained by displacing a vertex of a first three-dimensional mesh according to the displacement vector are encoded (S421). For example, decoding device 200 obtains the bitstream by receiving the bitstream from encoding device 100.

Next, decoding device 200 decodes the first identifier and the second identifier from the bitstream (S422). In other words, decoding device 200 obtains the first identifier and the second identifier included in the bitstream. For example, decoding device 200 decodes the encoded base mesh included in the bitstream, subdivides the base mesh based on the first identifier and the second identifier, and generates a submesh indicated by the second identifier by displacing a vertex included in the subdivided base mesh according to the displacement vector indicated by the first identifier.

With this, decoding device 200 can identify the displacement vector and the second three-dimensional mesh by only checking the identifiers. Accordingly, it is possible to reduce the processing amount.

Moreover, for example, the bitstream includes the first identifier and the second identifier in a first header.

With this, decoding device 200 can identify the displacement vector and the second three-dimensional mesh related to information included in a payload corresponding to the first header, by only checking the identifiers included in the first header. Accordingly, it is possible to reduce the processing amount.

Moreover, for example, the bitstream additionally includes the second identifier in a second header different from the first header.

With this, decoding device 200 can identify the second three-dimensional mesh related to each of information included in a payload corresponding to the first header and information included in a payload corresponding to the second header, by only checking the identifier included in the first header and the second header. Accordingly, it is possible to reduce the processing amount.

Moreover, for example, the first three-dimensional mesh is a three-dimensional mesh obtained by subdividing a base mesh to add a vertex to the base mesh, and the second header is a header of the base mesh.

With this, decoding device 200 can identify the second three-dimensional mesh related to the base mesh by only checking the identifier included in the header of the base mesh. Accordingly, it is possible to reduce the processing amount.

Moreover, for example, the bitstream further includes, in the second header, a third identifier indicating the base mesh.

With this, decoding device 200 can identify the base mesh by only checking the identifier included in the header of the base mesh. Accordingly, it is possible to reduce the processing amount.

### Other examples

Although the aspects of encoding device 100 and decoding device 200 have thus far been described according to the embodiment, the aspects of encoding device 100 and decoding device 200 are not limited to the embodiment. Modifications that may be conceived by a person skilled in the art may be applied to the embodiment, and a plurality of constituent elements in the embodiment may be combined in any manner.

For example, processing performed by a specific constituent element in the embodiment may be performed by a different constituent element instead of the specific constituent element. Moreover, the order of processes may be changed or processes may be performed in parallel.

Moreover, as stated above, it is possible to implement, as an integrated circuit, at least part of the plurality of constituent elements in the present disclosure. At least part of the processes in the present disclosure may be used as an encoding method or a decoding method. A program for causing a computer to execute the encoding method or the decoding method may be used. Furthermore, a non-transitory computer-readable recording medium on which the program is recorded may be used. In addition, a bitstream for causing decoding device 200 to perform decoding may be used.

Moreover, at least part of the plurality of constituent elements and the processes in the present disclosure may be used as a transmitting device, a receiving device, a transmitting method, and a receiving method. A program for causing a computer to execute the transmitting method or the receiving method may be used. Furthermore, a non-transitory computer-readable recording medium on which the program is recorded may be used.

### INDUSTRIAL APPLICABILITY

The present disclosure is useful in, for example, an encoding device, a decoding device, a transmitting device, a receiving device, and the like related to a three-dimensional mesh and can be applied to a computer graphics system, a three-dimensional data display system, and the like.

1. An encoding method comprising:
obtaining a first identifier indicating a displacement vector and a second identifier indicating a second three-dimensional mesh that is a three-dimensional mesh obtained by displacing a vertex of a first three-dimensional mesh according to the displacement vector; and
encoding the first identifier and the second identifier into a bitstream.

2. The encoding method according to claim 1, wherein
the bitstream includes the first identifier and the second identifier in a first header.

3. The encoding method according to claim 1, wherein
the first three-dimensional mesh is a three-dimensional mesh obtained by subdividing a base mesh to add a vertex to the base mesh.

4. The encoding method according to claim 2, wherein
the bitstream additionally includes the second identifier in a second header different from the first header.

5. The encoding method according to claim 4, wherein
the first three-dimensional mesh is a three-dimensional mesh obtained by subdividing a base mesh to add a vertex to the base mesh, and
the second header is a header of the base mesh.

6. The encoding method according to claim 5, wherein
the bitstream further includes, in the second header, a third identifier indicating the base mesh.

7. A decoding method comprising:
obtaining a bitstream into which a first identifier indicating a displacement vector and a second identifier indicating a second three-dimensional mesh that is a three-dimensional mesh obtained by displacing a vertex of a first three-dimensional mesh according to the displacement vector are encoded; and
decoding the first identifier and the second identifier from the bitstream.

8. The decoding method according to claim 7, wherein
the bitstream includes the first identifier and the second identifier in a first header.

9. The decoding method according to claim 7, wherein
the first three-dimensional mesh is a three-dimensional mesh obtained by subdividing a base mesh to add a vertex to the base mesh.

10. The decoding method according to claim 8, wherein
the bitstream additionally includes the second identifier in a second header different from the first header.

11. The decoding method according to claim 10, wherein
the first three-dimensional mesh is a three-dimensional mesh obtained by subdividing a base mesh to add a vertex to the base mesh, and
the second header is a header of the base mesh.

12. The decoding method according to claim 11, wherein
the bitstream further includes, in the second header, a third identifier indicating the base mesh.

13. An encoding device comprising:
a circuit; and
memory connected to the circuit, wherein
in operation, the circuit:
obtains a first identifier indicating a displacement vector and a second identifier indicating a second three-dimensional mesh that is a three-dimensional mesh obtained by displacing a vertex of a first three-dimensional mesh according to the displacement vector; and
encodes the first identifier and the second identifier into a bitstream.

14. A decoding device comprising:
a circuit; and
memory connected to the circuit, wherein
in operation, the circuit:
obtains a bitstream into which a first identifier indicating a displacement vector and a second identifier indicating a second three-dimensional mesh that is a three-dimensional mesh obtained by displacing a vertex of a first three-dimensional mesh according to the displacement vector are encoded; and
decodes the first identifier and the second identifier from the bitstream.
